(19) United States
(12) Patent Application Publication
(10) Pub. No.: US 2020/0068890 A1
(43) Pub. Date: Mar. 5, 2020

(54) HETEROCYCLIC INHIBITORS OF LYSINE BIOSYNTHESIS VIA THE DIAMINOPIMELATE PATHWAY

(71) Applicant: Person to Whom the Inventor is Obligated to Assign, Victoria (AU)

(72) Inventors: Matthew A. Perugini, Victoria (AU); Belinda Abbott, Victoria (AU); Taitiana Soares Da Costa, Victoria (AU)

(73) Assignee: La Trobe University, Victoria (AU)

(21) Appl. No.: 16/604,667

(22) PCT Filed: Apr. 12, 2018
(86) PCT No.: PCT/AU2018/050333

§ 371 Date: Oct. 11, 2019

(30) Foreign Application Priority Data
Apr. 12, 2017 (AU) 2017901336

(51) Int. Cl. A01N 43/78; A01N 43/50

(52) U.S. Cl. CPC A01N 43/78; A01N 43/50

(57) ABSTRACT

The present invention relates to certain heterocyclic compounds of formula (1) that have the ability to inhibit lysine biosynthesis via the diaminopimelate biosynthesis pathway in certain organisms. As a result of this activity these compounds can be used in applications where inhibition of lysine biosynthesis is useful. Applications of this type include the use of the compounds as herbicides.

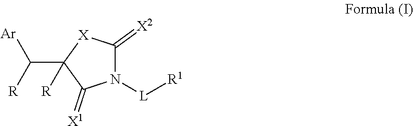

### TECHNICAL FIELD

The present invention relates to substituted heterocyclic compounds that have the ability to inhibit lysine biosynthesis via the diaminopimelate pathway in certain organisms. As a result of this activity these compounds can be used in applications where inhibition of lysine biosynthesis is useful. Applications of this type include the use of the compounds as herbicides.

### BACKGROUND OF INVENTION

In the 20^{th} century there has been widespread use by man of chemical agents for a number of applications including as pharmaceutical agents, herbicides, pesticides and the like. Unfortunately due to the widespread use of these agents many compounds that demonstrated useful activities no longer work as the target species has developed some form of resistance to the active agent.

The development and use of herbicides has had a significant impact on the ability to feed the ever growing world population. Herbicides have assisted farmers with weed management in crops and have also facilitated no-till crop production to conserve soil and moisture. Their use has therefore had a significant positive impact on crop yields and productivity per hectare.

Unfortunately, the repeated application of herbicides with the same mechanism of action to a crop or field has resulted in the development of herbicide-resistant weeds. It is thought that weeds develop herbicide resistance as a result of herbicide selection pressure whereby those weeds that have some form of resistance are favoured once the herbicide has been applied leading to a selection advantage for the resistant weed.

As will be appreciated due to the development of herbicide resistance, there is a continual need to develop new agents that can be used as replacement active agents for those agents that no longer work in the field due to the development of resistance. Accordingly, there is an ongoing need to develop new compounds or identify existing compounds that can be used as herbicides.

One challenge in the development of active agents as herbicides is to ensure that the agent developed has an acceptable safety profile upon exposure to humans as ideally the agent would be either non-toxic or minimally toxic to humans and preferably mammals as a whole.

With this in mind one attractive target for the development of agents of this type is the biosynthesis of the amino acid lysine and its immediate precursor meso-diaminopimelate (meso-DAP). This is an attractive pathway for study as whilst the lysine biosynthetic pathway occurs in plants and bacteria it does not occur in mammals. Mammals lack the ability to produce lysine biosynthetically and it is therefore one of the 9 essential amino acids that must be provided from a dietary source. The occurrence of the lysine biosynthetic pathway in plants but not in mammals suggest that specific inhibitors of this biosynthetic pathway would display novel activity and low mammalian toxicity.

Accordingly, it would be desirable to develop inhibitors of the lysine biosynthetic pathway as it would be anticipated that these would potentially have interesting herbicidal activity.

### SUMMARY OF THE INVENTION

The present applicants have therefore studied the diaminopimelate pathway pathway in order to identify inhibitors of lysine biosynthesis that could potentially find application as herbicidal agents.

As a result of these studies the applicants have identified compounds that have the ability to inhibit lysine biosynthesis.

Accordingly, in one embodiment the present invention provides a method of inhibiting lysine biosynthesis in an organism in which the diaminopimelate biosynthesis pathway occurs, the method comprising contacting the organism with an effective amount of a compound of the Formula (1):

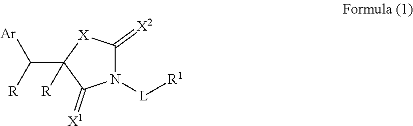

wherein

X, X¹ and X² are each independently selected from the group consisting of O, NH and S;

Ar is an optionally substituted C₆-C₁₈aryl or an optionally substituted C₁-C₁₈heteroaryl group;

each R is H, or when taken together two R form a double bond between the carbon atoms to which they are attached;

L is selected from the group consisting of a bond, C₁-C₆alkyl, C₂-C₆alkenyl, C₁-C₆alkoxy, C₁-C₆alkoxyC₁-C₆ alkyl, and C₁-C₆heteroalkyl;

R¹ is selected from the group consisting of H, OH, CN, tetrazole, CO₂H, and COR²;

R² is selected from the group consisting of H, Cl, NR³R⁴, O—C₁-C₆alkyl, and O—C₁-C₆heteroalkyl;

each R³ and R⁴ is independently selected from H and C₁-C₆alkyl;

or a salt or N-oxide thereof.

Without wishing to be bound by theory it is felt that the compounds are active in inhibiting lysine biosynthesis by inhibiting the diaminopimelate (DAP) pathway in the organism. In particular it is thought that the compounds inhibit this pathway by inhibiting dihydrodipicolinate synthase (DHDPS) activity in the organism.

As a result of the ability of the compounds to inhibit the lysine biosynthetic pathway the applicants have also found that the compounds can be used as herbicides as the lysine biosynthetic pathway is an essential pathway in plants.

Accordingly in yet an even further aspect the present invention provides a method for controlling undesired plant growth the method comprising contacting the plant with a herbicidal effective amount of a compound of the formula (1):

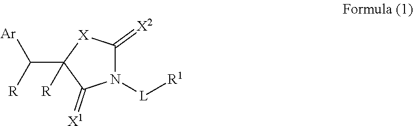

wherein

X, X¹ and X² are each independently selected from the group consisting of O, NH and S;

Ar is an optionally substituted C₆-C₁₈aryl or an optionally substituted C₁-C₁₈heteroaryl group;

each R is H, or when taken together two R form a double bond between the carbon atoms to which they are attached;

L is selected from the group consisting of a bond, C₁-C₆alkyl, C₂-C₆alkenyl, C₁-C₆alkoxy, C₁-C₆alkoxyC₁-C₆ alkyl, and C₁-C₆heteroalkyl;

R¹ is selected from the group consisting of H, OH, CN, tetrazole, CO₂H, and COR²;

R² is selected from the group consisting of H, Cl, NR³R⁴, O—C₁-C₆alkyl, and O—C₁-C₆heteroalkyl;

each R³ and R⁴ is independently selected from H and C₁-C₆alkyl,

or a salt or N-oxide thereof.

### BRIEF DESCRIPTION OF DRAWINGS

FIG. 1 shows the diaminopimelate biosynthetic pathway in bacteria and plants.

FIG. 2 shows the structures of meso-DAP (A) and lysine (B).

FIG. 3 shows the first step in diaminopimelate biosynthesis pathway catalysed by DHDPS.

FIG. 4 shows DHDPS enzyme structures of the head-to-head dimer-of-dimers observed for most bacterial species (A), back-to-back dimer-of-dimers observed for plant species (B), and dimeric form observed for some bacterial species (C), where a, b, c and d refers to monomeric units of the protein.

FIG. 5 shows graphs of root length versus concentration for plants treated with (a) compound 3 and (b) compound 5.

### DETAILED DESCRIPTION

In this specification a number of terms are used that are well known to a skilled addressee. Nevertheless for the purposes of clarity a number of terms will be defined.

Throughout the description and the claims of this specification the word “comprise” and variations of the word, such as “comprising” and “comprises” is not intended to exclude other additives, components, integers or steps.

The term “effective amount” means an amount sufficient to achieve a desired beneficial result. In relation to a herbicide, an effective amount is an amount sufficient to control undesired plant growth.

The term ‘inhibit” and variations thereof such as “inhibiting” means to prevent, block or reduce the function of the thing being inhibited. The term does not require complete inhibition with a reduction of activity at least 50% being considered inhibition.

The term “controlling” in relation to plant growth means to reduce or eliminate growth of the plant. This may involve killing the plant but also includes within its scope stunting or reducing plant growth.

The term “or a salt thereof” refers to salts that retain the desired biological activity of the above-identified compounds, and include acid addition salts and base addition salts. Suitable acceptable acid addition salts of compounds of Formula (1) may be prepared from an inorganic acid or from an organic acid. Examples of such inorganic acids are hydrochloric, sulfuric, and phosphoric acid. Appropriate organic acids may be selected from aliphatic, cycloaliphatic, aromatic, heterocyclic, carboxylic and sulfonic classes of organic acids, examples of which are formic, acetic, propanoic, pyruvic, succinic, glycolic, gluconic, lactic, malic, tartaric, citric, fumaric, maleic, alkyl sulfonic and arylsulfonic. Additional information on pharmaceutically acceptable salts can be found in P. H. Stahl and C. G. Wermuth Handbook of Pharmaceutical Salts, Properties, Selection, and Use, 2^{nd} Revised Edition, Wiley-VCH 2011. In the case of agents that are solids, it is understood by those skilled in the art that the compounds, agents and salts may exist in different crystalline or polymorphic forms, all of which are intended to be within the scope of the present invention and specified formulae.

The term “optionally substituted” as used throughout the specification denotes that the group may or may not be further substituted or fused (so as to form a condensed polycyclic system), with one or more non-hydrogen substituent groups. In certain embodiments the substituent groups are one or more groups independently selected from the group consisting of halogen, ═O, ═S, —CN, —NO₂, —CF₃, —OCF₃, alkyl, alkenyl, alkynyl, haloalkyl, haloalkenyl, haloalkynyl, heteroalkyl, cycloalkyl, cycloalkenyl, heterocycloalkyl, heterocycloalkenyl, aryl, heteroaryl, cycloalkylalkyl, heterocycloalkylalkyl, heteroarylalkyl, arylalkyl, cycloalkylalkenyl, heterocycloalkylalkenyl, arylalkenyl, heteroarylalkenyl, cycloalkylheteroalkyl, heterocycloalkylheteroalkyl, arylheteroalkyl, heteroarylheteroalkyl, hydroxy, hydroxyalkyl, alkyloxy, alkyloxyalkyl, alkyloxycycloalkyl, alkyloxyheterocycloalkyl, alkyloxyaryl, alkyloxyheteroaryl, alkyloxycarbonyl, alkylaminocarbonyl, alkenyloxy, alkynyloxy, cycloalkyloxy, cycloalkenyloxy, heterocycloalkyloxy, heterocycloalkenyloxy, aryloxy, phenoxy, benzyloxy, heteroaryloxy, arylalkyloxy, amino, alkylamino, acylamino, aminoalkyl, arylamino, sulfonylamino, sulfinylamino, sulfonyl, alkylsulfonyl, arylsulfonyl, aminosulfonyl, sulfinyl, alkylsulfinyl, arylsulfinyl, aminosulfinylaminoalkyl, C(═O)OH, —C(═O)R^{e}, C(═O)OR^{e}, C(═O)NR^{e}R^{f}, C(═NOH)R^{e}, C(═NR^{e})NR^{f}R^{g}, NR^{e}R^{f}, NR^{e}C(═O)R^{f}, NR^{e}C(═O)OR^{f}, NR^{e}C(═O)NR^{f}R^{g}, NR^{e}C(═NR^{f})NR^{g}R^{h}, NR^{e}SO₂R^{f}, —SR^{e}, SO₂NR^{e}R^{f}, —OR^{e}, OC(═O)NR^{e}R^{f}, OC(═O)R^{e} and acyl, wherein R^{e}, R^{f}, R^{g} and R^{h} are each independently selected from the group consisting of H, C₁-C₁₂alkyl, C₁-C₁₂haloalkyl, C₂-C₁₂alkenyl, C₂-C₁₂alkynyl, C₁-C₁₀heteroalkyl, C₃-C₁₂cycloalkyl, C₃-C₁₂cycloalkenyl, C₁-C₁₂heterocycloalkyl, C₁-C₁₂heterocycloalkenyl, C₆-C₁₈aryl, C₁-C₁₈heteroaryl, and acyl, or any two or more of R^{e}, R^{f}, R^{g} and R^{h}, when taken together with the atoms to which they are attached form a heterocyclic ring system with 3 to 12 ring atoms.

Examples of particularly suitable optional substituents include F, Cl, Br, I, CH₃, CH₂CH₃, CH₂NH₂, OH, OCH₃, SH, SCH₃, CO₂H, CONH₂, CF₃, OCF₃, NO₂, NH₂, and CN.

In the definitions of a number of substituents below it is stated that “the group may be a terminal group or a bridging group”. This is intended to signify that the use of the term is intended to encompass the situation where the group is a linker between two other portions of the molecule as well as where it is a terminal moiety. Using the term alkyl as an example, some publications would use the term “alkylene” for a bridging group and hence in these other publications there is a distinction between the terms “alkyl” (terminal group) and “alkylene” (bridging group). In the present application no such distinction is made and most groups may be either a bridging group or a terminal group.

“Alkenyl” as a group or part of a group denotes an aliphatic hydrocarbon group containing at least one carbon-carbon double bond and which may be straight or branched preferably having 2-12 carbon atoms, more preferably 2-10 carbon atoms, most preferably 2-6 carbon atoms, in the normal chain. The group may contain a plurality of double bonds in the normal chain and the orientation about each is independently E or Z. The alkenyl group is preferably a 1-alkenyl group. Exemplary alkenyl groups include, but are not limited to ethenyl, propenyl, butenyl, pentenyl, hexenyl, heptenyl, octenyl and nonenyl. The group may be a terminal group or a bridging group.

“Alkyl” as a group or part of a group refers to a straight or branched aliphatic hydrocarbon group, preferably a C₁-C₁₂alkyl, more preferably a C₁-C₁₀alkyl, most preferably C₁-C₆ unless otherwise noted. Examples of suitable straight and branched C₁-C₆alkyl substituents include methyl, ethyl, n-propyl, 2-propyl, n-butyl, sec-butyl, t-butyl, hexyl, and the like. The group may be a terminal group or a bridging group.

“Alkoxy” refers to an alkyl-O— group in which alkyl is as defined herein. Preferably the alkyoxy is a C₁-C₆alkyoxy. Examples include, but are not limited to, methoxy and ethoxy. The group may be a terminal group or a bridging group.

“Alkoxyalkyl” refers to an alkoxy-alkyl-group in which the alkoxy and alkyl moieties are as defined herein. The group may be a terminal group or a bridging group. If the group is a terminal group it is bonded to the remainder of the molecule through the alkyl group.

“Aryl” as a group or part of a group denotes (i) an optionally substituted monocyclic, or fused polycyclic, aromatic carbocycle (ring structure having ring atoms that are all carbon) preferably having from 5 to 12 atoms per ring. Examples of aryl groups include phenyl, naphthyl, and the like; (ii) an optionally substituted partially saturated bicyclic aromatic carbocyclic moiety in which a phenyl and a C₅₋₇cycloalkyl or C₅₋₇cycloalkenyl group are fused together to form a cyclic structure, such as tetrahydronaphthyl, indenyl or indanyl. The group may be a terminal group or a bridging group. Typically an aryl group is a C₆-C₁₈ aryl group.

“Heteroalkyl” refers to a straight- or branched-chain alkyl group preferably having from 2 to 12 carbons, more preferably 2 to 6 carbons in the chain, in which one or more of the carbon atoms (and any associated hydrogen atoms) are each independently replaced by a heteroatomic group selected from S, O, P and NR′ where R′ is selected from the group consisting of H, optionally substituted C₁-C₁₂alkyl, optionally substituted C₃-C₁₂cycloalkyl, optionally substituted C₆-C₁₈aryl, and optionally substituted C₁-C₁₈heteroaryl. Exemplary heteroalkyls include alkyl ethers, secondary and tertiary alkyl amines, amides, alkyl sulfides, and the like. Examples of heteroalkyl also include hydroxyC₁-C₆alkyl, C₁-C₆alkyloxyC₁-C₆alkyl, aminoC₁-C₆alkyl, C₁-C₆alkylaminoC₁-C₆alkyl, and di(C₁-C₆alkyl)aminoC₁-C₆alkyl. The group may be a terminal group or a bridging group.

“Heteroaryl” either alone or part of a group refers to groups containing an aromatic ring (preferably a 5 or 6 membered aromatic ring) having one or more heteroatoms as ring atoms in the aromatic ring with the remainder of the ring atoms being carbon atoms. Suitable heteroatoms include nitrogen, oxygen and sulphur. Examples of heteroaryl include thiophene, benzothiophene, benzofuran, benzimidazole, benzoxazole, benzothiazole, benzisothiazole, naphtho[2,3-b]thiophene, furan, isoindolizine, xantholene, phenoxatine, pyrrole, imidazole, pyrazole, pyridine, pyrazine, pyrimidine, pyridazine, tetrazole, indole, isoindole, 1H-indazole, purine, quinoline, isoquinoline, phthalazine, naphthyridine, quinoxaline, cinnoline, carbazole, phenanthridine, acridine, phenazine, thiazole, isothiazole, phenothiazine, oxazole, isooxazole, furazane, phenoxazine, 2-, 3- or 4-pyridyl, 2-, 3-, 4-, 5-, or 8-quinolyl, 1-, 3-, 4-, or 5-isoquinolinyl 1-, 2-, or 3-indolyl, and 2-, or 3 thienyl. A heteroaryl group is typically a C₁-C₁₈ heteroaryl group. The group may be a terminal group or a bridging group.

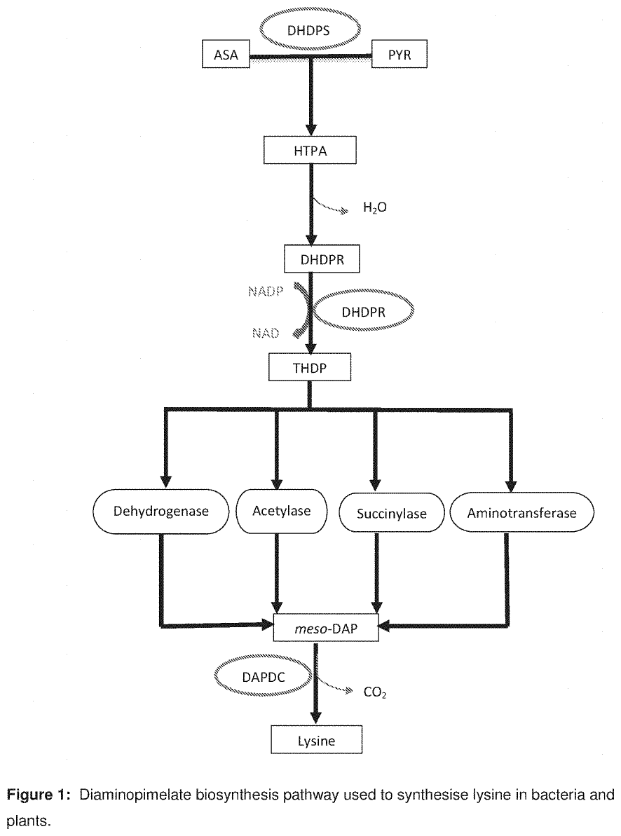

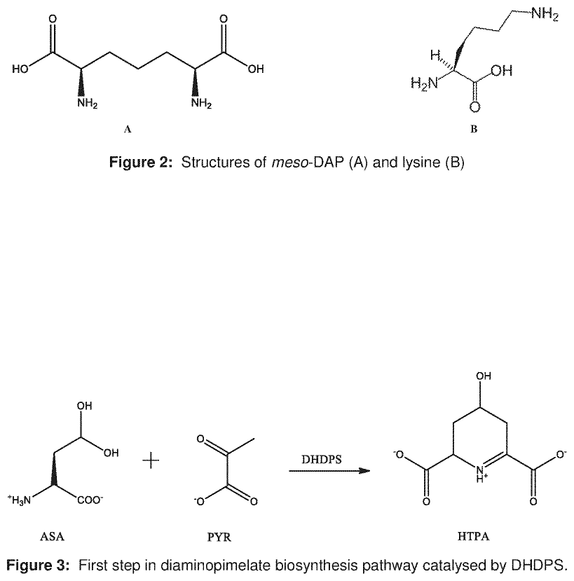

As shown in FIG. 1 the synthesis of lysine in bacteria via the diaminopimelate pathway starts from the combination of pyruvate (PYR) and L-aspartate semialdehyde (ASA) to synthesise 2,3,4,5-tetrahydro-L,L-dipicolinic acid (HTPA) in the presence of dihydrodipicolinate synthase (DHDPS). HTPA will dehydrate and dihydrodipicolinate (DHDP) will generate via a non-enzymatic step. DHDP will be reduced by the enzyme dihydrodipicolinate reductase (DHDPR), which is a NAD(P)H dependent enzyme, to form 2,3,4,5-tetrahydrodipicolinate (THDP). THDP will then undergo one of the four pathways; succinylase, acetylase, dehydrogenase or aminotransferase, which depends upon the species of bacteria and plants. All pathways lead to the synthesis of a common, biologically important compound meso-L,L′-2,6-diaminopimalate (meso-DAP). meso-DAP is then decarboxylated by the enzyme diaminopimelate decarboxylase (DAPDC) leading to the formation of lysine. Generated meso-DAP is used as a cross linking moiety in the peptidoglycan layer of the cell wall of Gram-negative bacteria and also in Gram-positive bacteria such as Bacillus sp Lysine also forms peptidoglycan cross-links in the bacterial cell wall of most Gram-positive bacteria and is used in the synthesis of proteins in both bacteria and plants. Accordingly, lysine is essential for cell function and viability of both bacteria and plants.

With reference to FIG. 1 the first step of the diaminopimelate biosynthesis pathway requires the enzyme dihydrodipicolinate synthase (DHDPS). An expanded view of this first step is shown in FIG. 3. As can be seen the step involves the combination of pyruvate (PYR) and L-aspartate semialdehyde (ASA) in the presence of dihydrodipicolinate synthase (DHDPS) to form 2,3,4,5-tetrahydro-L,L-dipicolinic acid (HTPA). As this step in the diaminopimelate biosynthetic pathway is common to all bacteria and plants it was felt that it presented an attractive target in the development of inhibitors of lysine biosynthesis.

The enzyme dihydrodipicolinate synthase (DHDPS) was characterised in 1965, after purification from Escherichia coli (E. coli). Following characterisation of the enzyme it has been extensively studied with crystal structure work of the enzyme having been carried out.

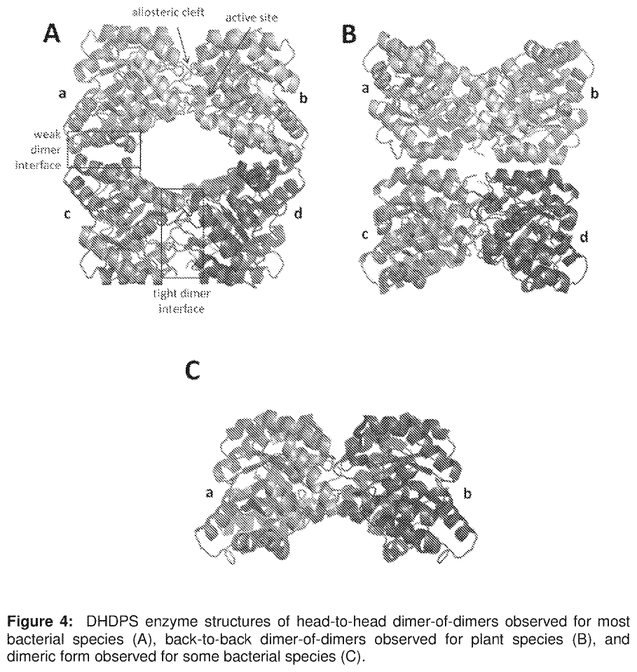

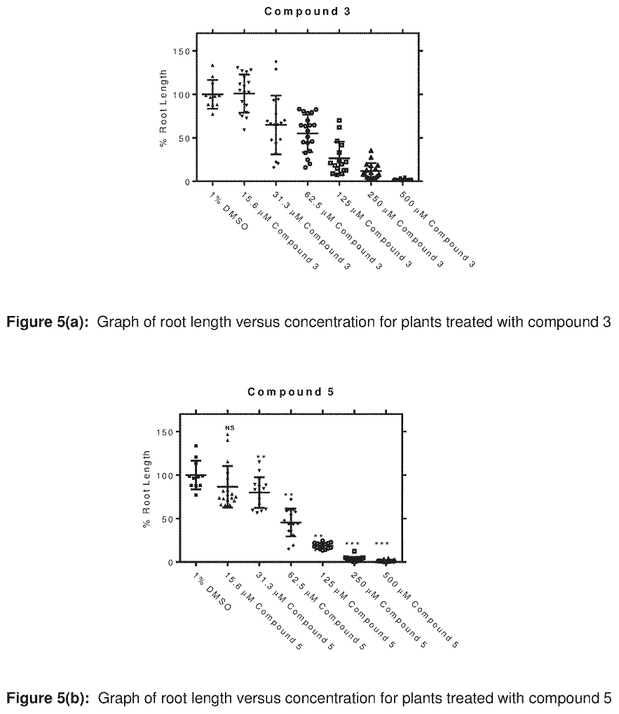

As can be seen from FIG. 4 the quaternary structure of DHDPS in Gram-negative bacteria consists of four monomer units joining together in a manner that only one monomer interacts with two other monomers (FIG. 4A). The tetramer structure, which is also known as a “head-to-head” dimer-of-dimers, has a large cavity filled with water. Two monomer interactions are tighter than the other two monomer interactions therefore they are known as a tight dimer interface and a weak dimer interface respectively, as shown in FIG. 4A. The active site of the enzyme is located at the tight dimer interface. In the active site of E. coli, Threonine 44 and Tyrosine 133 are present, Tyrosine 107 interdigitates across the two monomers at the tight dimer interface giving rise to two active sites per dimer.

The structure of DHDPS in plants also consists of a tetramer, but the conformation is a “back-to-back” dimer-of-dimers (FIG. 4B). DHDPS in some bacterial species, such as Staphylococcus aureus and Pseudomonas aeruginosa, exist as only a dimer consisting of a tightly bound dimer interface (FIG. 4C).

As can be seen as the first step in the diaminopimelate biosynthesis pathway is common in plants thus represents an attractive target for compound development in the herbicide space.

As discussed above the applicants of the present invention have identified compounds that have the ability to inhibit lysine biosynthesis via the diaminopimelate pathway. Accordingly, in one embodiment the present invention provides a method of inhibiting lysine biosynthesis in an organism in which the diaminopimelate biosynthesis pathway occurs, the method comprising contacting the organism with an effective amount of a compound of the Formula (I). A skilled worker in the field would readily understand the organisms in which the diaminopimelate biosynthesis pathway occurs. Nevertheless for the avoidance of doubt we note that all species in the kingdoms of Archaea, Eubacteria (both Gram-negative and Gram-positive species) and Plants (from moss species through to higher plants) utilise the diaminopimelate pathway and therefore would be considered organisms in which the diaminopimelate pathway occurs.

The compounds that are used in the methods of the present invention are compounds of Formula (1):

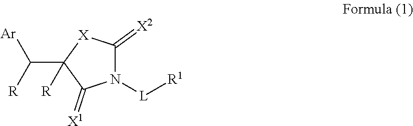

wherein

X, X¹ and X² are each independently selected from the group consisting of O, NH and S;

Ar is an optionally substituted C₆-C₁₈aryl or an optionally substituted C₁-C₁₈heteroaryl group;

each R is H or when taken together two R form a double bond between the carbon atoms to which they are attached;

L is selected from the group consisting of a bond, C₁-C₆alkyl, C₂-C₆alkenyl, C₁-C₆alkoxy, C₁-C₆alkoxyC₁-C₆ alkyl, and C₁-C₆heteroalkyl;

R¹ is selected from the group consisting of H, OH, CN, tetrazole, CO₂H, and COR²;

R² is selected from the group consisting of H, Cl, NR³R⁴, O—C₁-C₆alkyl, and O—C₁-C₆heteroalkyl;

each R⁴ and R⁵ is independently selected from H and C₁-C₆alkyl,

or a salt or N-oxide thereof.

In the compounds that are used in the methods of the present invention each R is H; or when taken together two R form a double bond between the carbon atoms to which they are attached. In one embodiment each R is H. In one embodiment two R when taken together form a double bond between the carbon atoms to which they are attached. This provides compounds of Formula (2).

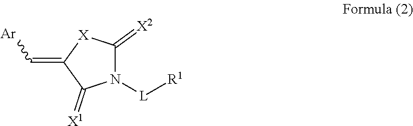

wherein Ar, X, X¹, X², L and R¹ are as defined above.

In theory the geometry around the double bond in compounds of Formula (2) can be either E or Z. In one embodiment the compound is the E isomer. In one embodiment the geometry is the Z isomer. In one embodiment the geometry is such that the compounds are compounds of Formula (3)

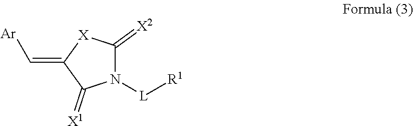

where Ar, X, X¹, X², L and R¹ are as defined above.

In the compounds that are used in the methods of the present invention X, X¹ and X² are each independently selected from the group consisting of O, NH and S.

In one embodiment X is S. In one embodiment X is O. In one embodiment X is NH. In one embodiment X¹ is S. in one embodiment X¹ is O. In one embodiment X¹ is NH. In one embodiment X² is S. In one embodiment X² is O. In one embodiment X² is NH. As will be appreciated by a skilled worker in the field as there are three potential values for each variable there are 27 possible combinations all of which are intended to be covered by the present application.

In one embodiment of the compounds of Formula (3) that are used in the methods of the present invention X is S providing compounds of Formula (3a):

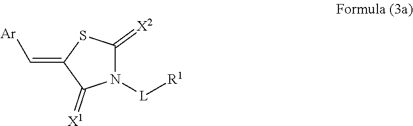

where Ar, X¹, X², L and R¹ are as defined above.

In one embodiment of the compounds of Formula (3) that are used in the methods of the present invention X is O providing compounds of Formula (3b):

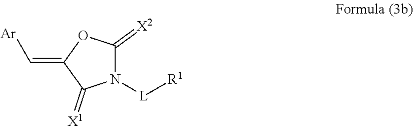

where Ar, X¹, X², L and R¹ are as defined above.

In one embodiment of the compounds of Formula (3) that are used in the methods of the present invention X is NH providing compounds of Formula (3c):

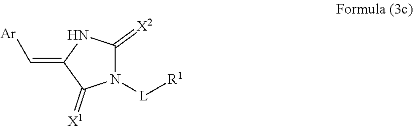

where Ar, X¹, X², L and R¹ are as defined above.

In one embodiment of the compounds of Formula (3a) that are used in the methods of the present invention X¹ is O providing compounds of Formula (3aa):

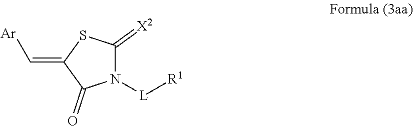

where Ar, X², L and R¹ are as defined above.

In one embodiment of the compounds of Formula (3b) that are used in the methods of the present invention X¹ is O providing compounds of Formula (3ba):

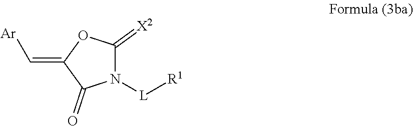

where Ar, X², L and R¹ are as defined above.

In one embodiment of the compounds of Formula (3c) that are used in the methods of the present invention X¹ is O providing compounds of Formula (3ca)

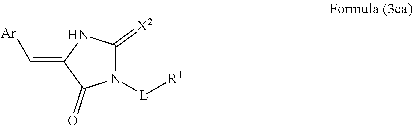

where Ar, X², L and R¹ are as defined above.

In one embodiment of the compounds of formula (3aa) that are used in the methods of the present invention X² is O providing compounds of formula (3aaa):

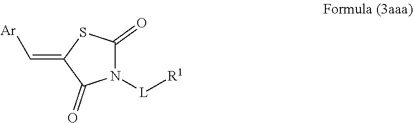

where Ar, L and R¹ are as defined above.

In one embodiment of the compounds of Formula (3ba) that are used in the methods of the present invention X² is O providing compounds of Formula (3baa):

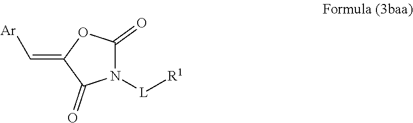

where Ar, L and R¹ are as defined above.

In one embodiment of the compounds of Formula (3ca) that are used in the methods of the present invention X² is O providing compounds of formula (3caa):

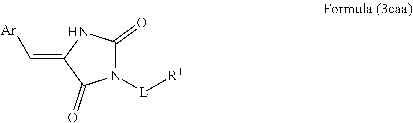

where Ar, L and R¹ are as defined above.

In the compounds that are used in the methods of the present invention Ar is an optionally substituted C₆-C₁₈aryl or an optionally substituted C₁-C₁₈heteroaryl group.

In some embodiments the group Ar is an optionally substituted C₆-C₁₈aryl. Examples of this group include optionally substituted phenyl and optionally substituted naphthyl.

In some embodiments the group Ar may be any optionally substituted C₁-C₁₈ heteroaryl group. Suitable heteroaryl groups include thiophene, benzothiophene, benzofuran, benzimidazole, benzoxazole, benzothiazole, benzisothiazole, naphtho[2,3-b]thiophene, furan, isoindolizine, xantholene, phenoxatine, pyrrole, imidazole, pyrazole, pyridine, pyrazine, pyrimidine, pyridazine, tetrazole, indole, isoindole, 1H-indazole, purine, quinoline, isoquinoline, phthalazine, naphthyridine, quinoxaline, cinnoline, carbazole, phenanthridine, acridine, phenazine, thiazole, isothiazole, phenothiazine, oxazole, isooxazole, furazane, phenoxazine, pyridyl, quinolyl, isoquinolinyl, indolyl, and thienyl. In each instance where there is the possibility of multiple sites of substitution on the heteroaryl ring all possible attachment points are contemplated. Merely by way of example if the heteroaryl is a pyridyl moiety it may be a 2-pyridyly, a 3-pyridyl or a 4-pyridyl.

In some embodiments Ar is selected from the group consisting of

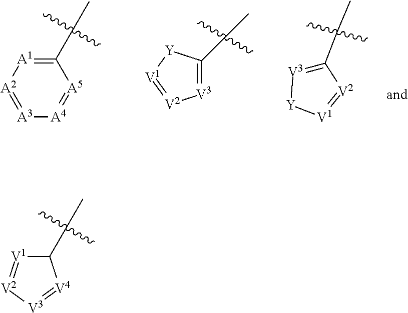

wherein each A¹, A², A³, A⁴ and A⁵ are independently selected from the group consisting of N and CR⁵;

each V¹, V², V³ and V⁴ are independently selected from the group consisting of N and CR⁵;

Y is selected from the group consisting of S, O, and NH;

each R⁵ is independently selected from the group consisting of H, halogen, OH, NO₂, CN, SH, NH₂, CF₃, OCF₃, C₁-C₁₂alkyl, C₁-C₁₂alkyloxy, C₁-C₁₂haloalkyl, C₂-C₁₂alkenyl, C₂-C₁₂alkynyl, C₂-C₁₂heteroalkyl, C₆-C₁₈arylC₁-C₁₂alkyloxy, SR⁶, SO₃H, SO₂NR⁶R⁶, SO₂R⁶, SONR⁶R⁶, SOR⁶, COR⁶, COOH, COOR⁶, CONR⁶R⁶, NR⁶COR⁶, NR⁶COOR⁶, NR⁶SO₂R⁶, NR⁶CONR⁶R⁶, NR⁶R⁶, and acyl,

or any two R⁵ on adjacent carbon atoms when taken together with the carbon atoms to which they are attached form a 5 or 6 membered cyclic moiety;

each R⁶ is independently selected from the group consisting of H and C₁-C₁₂alkyl.

In some embodiments Ar is an aromatic moiety of the formula:

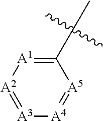

wherein A¹, A², A³, A⁴ and A⁵ are as defined above.

In some embodiments Ar is an aromatic moiety selected from the group consisting of:

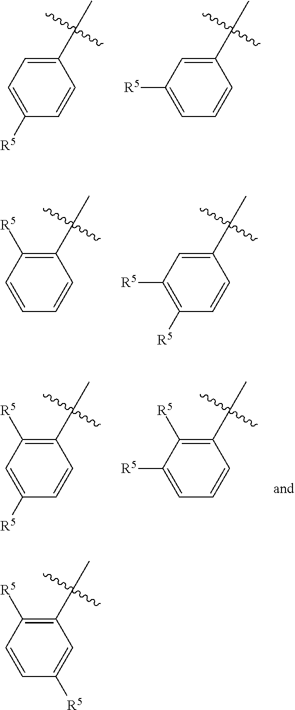

In some embodiments Ar is selected from the group consisting of:

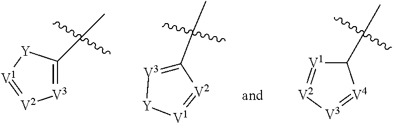

wherein each V¹, V², V³ and V⁴ are independently selected from the group consisting of N and CR⁵;

Y is selected from the group consisting of S, O, and NH.

In one embodiment Ar is selected from the group consisting of

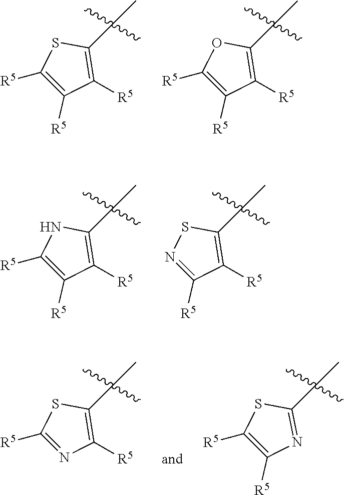

wherein R⁵ is as described above.

In one embodiment Ar is selected from the group consisting of

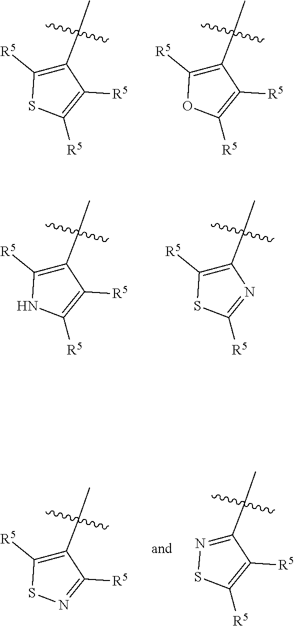

In the compounds that are used in the methods of the present invention L is selected from the group consisting of a bond, C₁-C₆alkyl, C₂-C₆alkenyl, C₁-C₆alkoxy, C₁-C₆alkoxyC₁-C₆ alkyl, and C₁-C₆heteroalkyl.

In one embodiment L is a bond. In one embodiment L is C₁-C₆alkyl. In one embodiment L is C₂-C₆alkenyl. In one embodiment L is C₁-C₆alkoxy. In one embodiment L is C₁-C₆alkoxyC₁-C₆alkyl. In one embodiment L is C₁-C₆heteroalkyl.

In one embodiment L is a C₁-C₆ alkyl group of the formula:

—(CH₂)ₐ—;

wherein a is selected from the group consisting of 1, 2, 3, and 4.

In one embodiment a is 1 and L is —CH₂—. In one embodiment a is 2 and L is —(CH₂)₂—. In one embodiment a is 3 and L is —(CH₂)₃—. In one embodiment a is 4 and L is —(CH₂)₄—.

In the compounds that are used in the methods of the present invention R¹ is selected from the group consisting of H, OH, CN, tetrazole, CO₂H, and COR².

In one embodiment R¹ is H. In one embodiment R¹ is OH. In one embodiment R¹ is CN. In one embodiment R¹ is tetrazole. In one embodiment R¹ is CO₂H. In one embodiment R¹ is COR².

In the compounds that are used in the methods of the present invention R² is selected from the group consisting of H, Cl, NR³R⁴, O—C₁-C₆alkyl, and O—C₁-C₆heteroalkyl.

In one embodiment R² is H. In one embodiment R² is Cl. In one embodiment R² is NR³R⁴. In one embodiment R² is O—C₁-C₆alkyl. In one embodiment R² is O—C₁-C₆heteroalkyl.

In the compounds that are used in the methods of the present invention each R³ and R⁴ is independently selected from H and C₁-C₆alkyl. In one embodiment R³ is H. In one embodiment R³ is C₁-C₆alkyl. In one embodiment R³ is CH₃. In one embodiment R⁴ is H. In one embodiment R⁴ is C₁-C₆alkyl. In one embodiment R⁴ is CH₃.

In the compounds that are used in the methods of the present invention each R⁵ is independently selected from the group consisting of H, halogen, OH, NO₂, CN, SH, NH₂, CF₃, OCF₃, C₁-C₁₂alkyl, C₁-C₁₂alkyloxy, C₁-C₁₂haloalkyl, C₂-C₁₂alkenyl, C₂-C₁₂alkynyl, C₂-C₁₂heteroalkyl, SR⁶, SO₃H, SO₂NR⁶R⁶, SO₂R⁶, SONR⁶R⁶, SOR⁶, COR⁶, COOH, COOR⁶, CONR⁶R⁶, NR⁶COR⁶, NR⁶COOR⁶, NR⁶SO₂R⁶, NR⁶CONR⁶R⁶, NR⁶R⁶, and acyl,

or any two R⁵ on adjacent carbon atoms when taken together with the carbon atoms to which they are attached form a 5 or 6 membered cyclic moiety;

each R⁶ is independently selected from the group consisting of H and C₁-C₁₂alkyl.

In one embodiment each R⁵ is independently selected from the group consisting of H, CI, Br, F, OH, NO₂, NH₂, C₁-C₁₂alkyl, C₁-C₁₂alkyloxy and NR⁶COR⁶.

In one embodiment each R⁵ is independently selected from the group consisting of H, F, Cl, Br, I, CH₃, CH₂CH₃, CH₂NH₂, OH, OCH₃, SH, SCH₃, CO₂H, CONH₂, CF₃, OCF₃, NO₂, NH₂, CN and NHCOCH₃.

In certain embodiments of the invention the compound used in the method is such that X is S, X¹ is O, X² is O, two R when taken together form a double bond, R¹ is CO₂H, and Ar is a group of the formula:

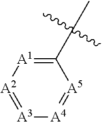

This provides compounds of Formula (4):

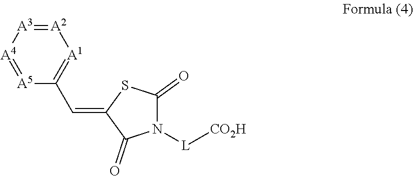

wherein L, A¹, A², A³, A⁴ and A⁵ are as defined above.

In the compounds of Formula (4) that are used in the methods of the present invention A¹, A², A³, A⁴ and A⁵ are each independently selected from the group consisting of N and CR⁵.

In one embodiment each of A¹, A², A³, A⁴ and A⁵ is CR⁵ that provides compounds of Formula (5).

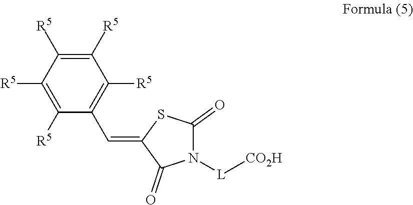

wherein L, and R⁵ are as defined above.

In certain embodiments of the compounds of formula 5 L is —CH₂—. This provides compounds of Formula (6).

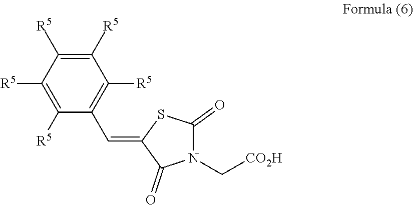

wherein R⁵ is as defined above

Examples of specific compounds of Formula (1) for use in the methods of the present invention include the following:

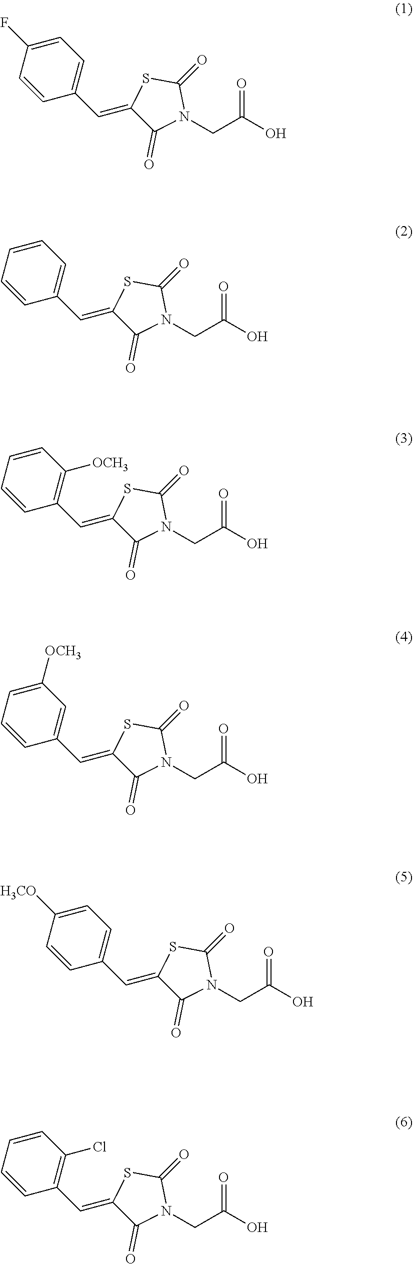 [SMILES: O=C(O)CN1C(=O)S/C(=C\c2ccc(F)cc2)C1=O ; O=C(O)CN1C(=O)S/C(=C\c2ccccc2)C1=O ; COc1ccccc1/C=C1\SC(=O)N(CC(=O)O)C1=O ; COc1cccc(/C=C2\SC(=O)N(CC(=O)O)C2=O)c1 ; COc1ccc(/C=C2\SC(=O)N(CC(=O)O)C2=O)cc1 ; O=C(O)CN1C(=O)S/C(=C\c2ccccc2Cl)C1=O]

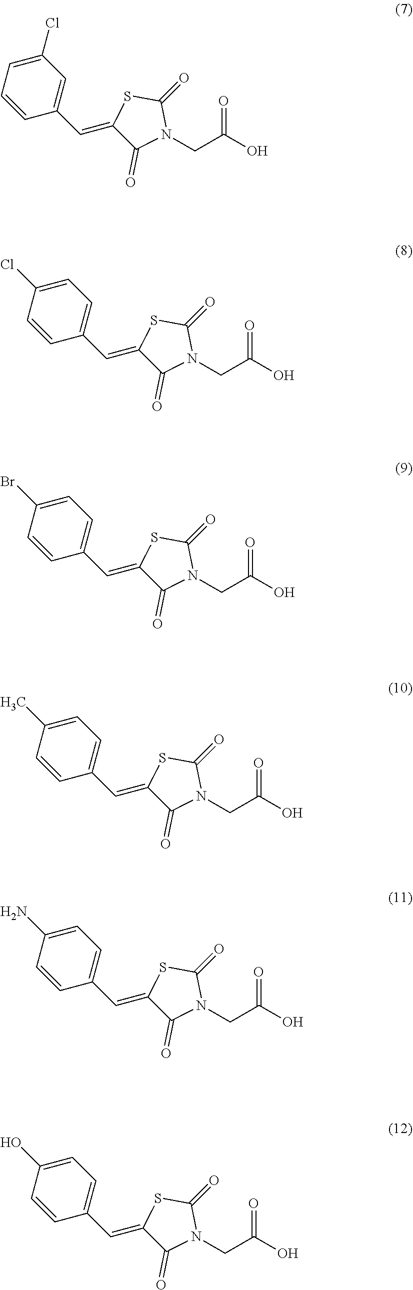 [SMILES: O=C(O)CN1C(=O)S/C(=C\c2cccc(Cl)c2)C1=O ; O=C(O)CN1C(=O)S/C(=C\c2ccc(Cl)cc2)C1=O ; O=C(O)CN1C(=O)S/C(=C\c2ccc(Br)cc2)C1=O ; Cc1ccc(/C=C2\SC(=O)N(CC(=O)O)C2=O)cc1 ; Nc1ccc(/C=C2\SC(=O)N(CC(=O)O)C2=O)cc1 ; O=C(O)CN1C(=O)S/C(=C\c2ccc(O)cc2)C1=O]

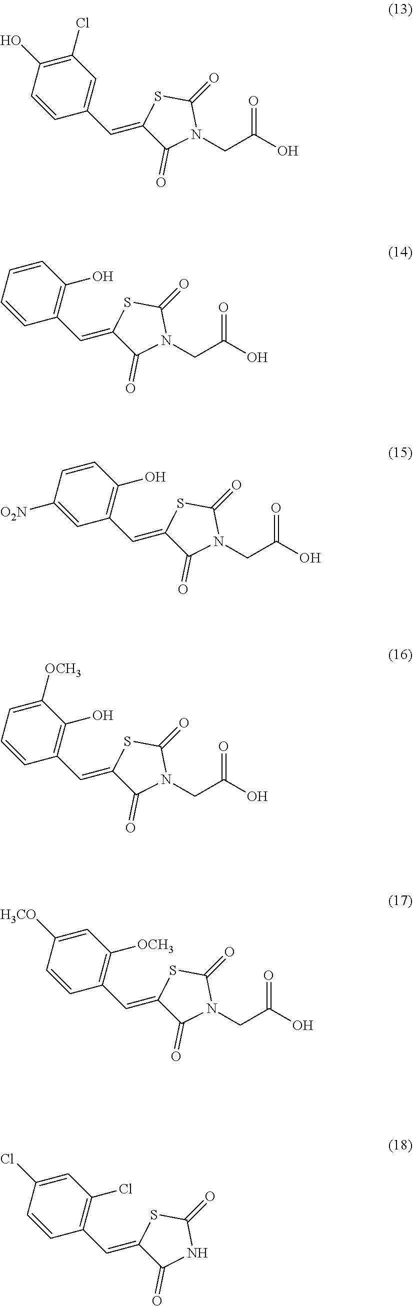 [SMILES: O=C(O)CN1C(=O)S/C(=C\c2ccc(O)c(Cl)c2)C1=O ; O=C(O)CN1C(=O)S/C(=C\c2ccccc2O)C1=O ; O=C(O)CN1C(=O)S/C(=C\c2cc([N+](=O)[O-])ccc2O)C1=O ; COc1cccc(/C=C2\SC(=O)N(CC(=O)O)C2=O)c1O ; COc1ccc(/C=C2\SC(=O)N(CC(=O)O)C2=O)c(OC)c1 ; O=C1NC(=O)/C(=C/c2ccc(Cl)cc2Cl)S1]

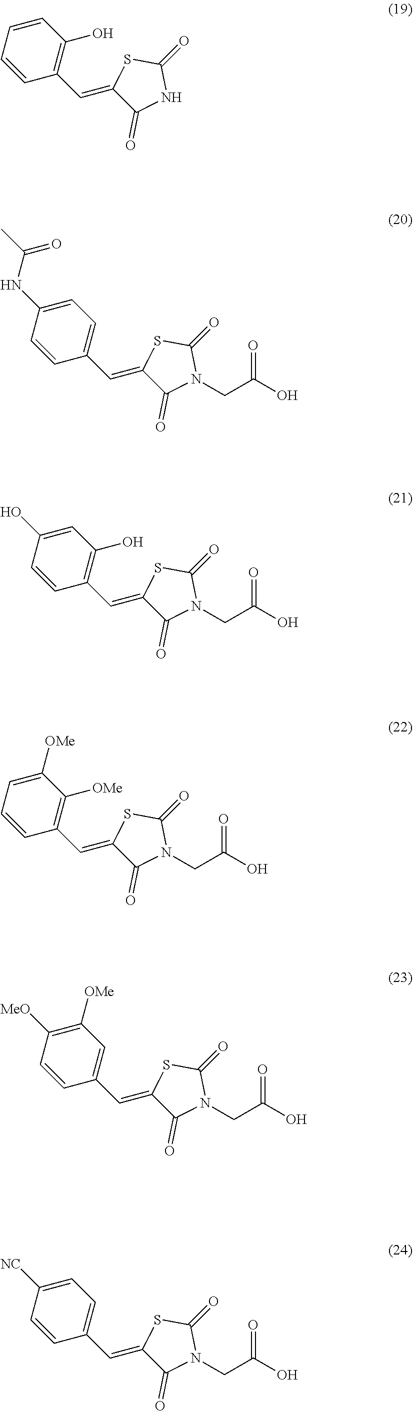 [SMILES: O=C1NC(=O)/C(=C/c2ccccc2O)S1 ; CC(=O)Nc1ccc(/C=C2\SC(=O)N(CC(=O)O)C2=O)cc1 ; O=C(O)CN1C(=O)S/C(=C\c2ccc(O)cc2O)C1=O ; COc1cccc(/C=C2\SC(=O)N(CC(=O)O)C2=O)c1OC ; COc1ccc(/C=C2\SC(=O)N(CC(=O)O)C2=O)cc1OC ; N#Cc1ccc(/C=C2\SC(=O)N(CC(=O)O)C2=O)cc1]

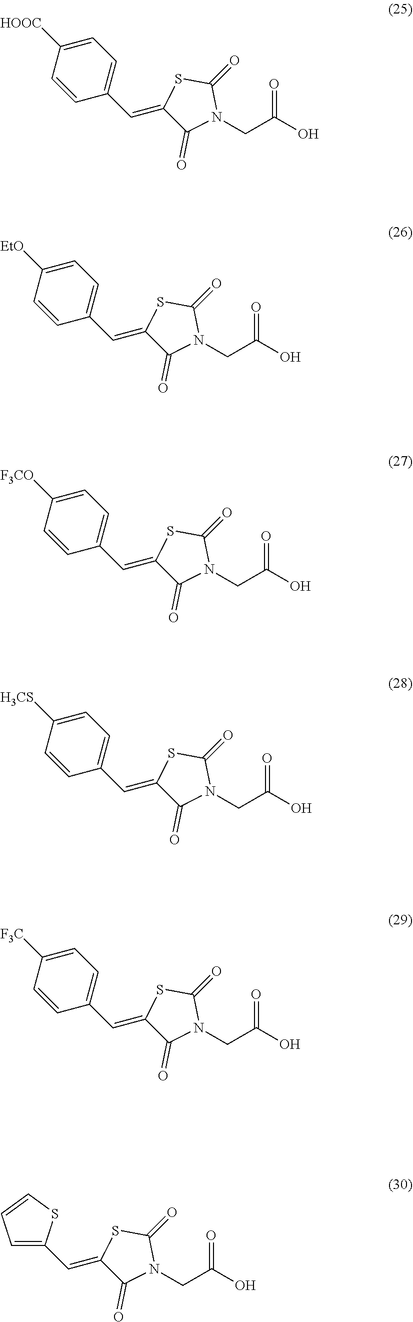

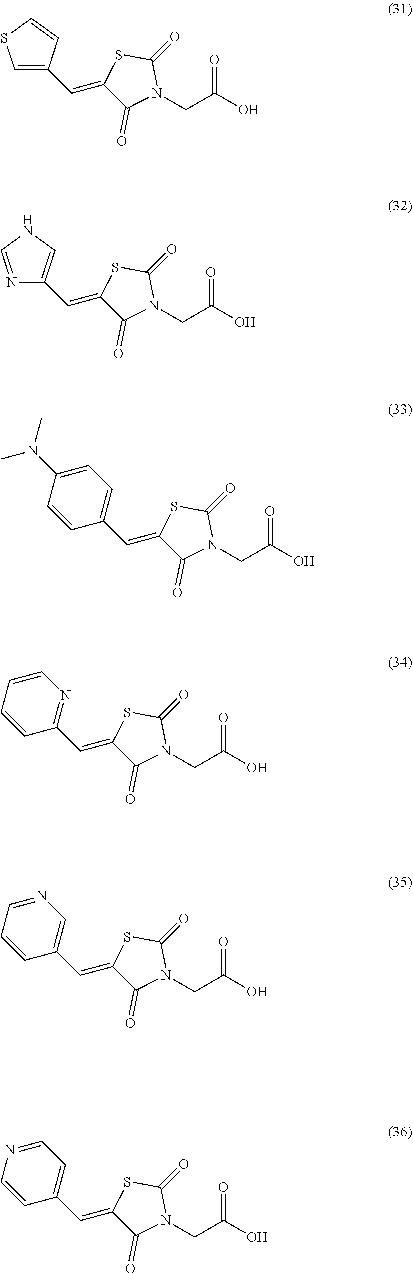 [SMILES: O=C(O)CN1C(=O)S/C(=C\c2ccsc2)C1=O ; O=C(O)CN1C(=O)S/C(=C\c2c[nH]cn2)C1=O ; CN(C)c1ccc(/C=C2\SC(=O)N(CC(=O)O)C2=O)cc1 ; O=C(O)CN1C(=O)S/C(=C\c2ccccn2)C1=O ; O=C(O)CN1C(=O)S/C(=C\c2cccnc2)C1=O ; O=C(O)CN1C(=O)S/C(=C\c2ccncc2)C1=O]

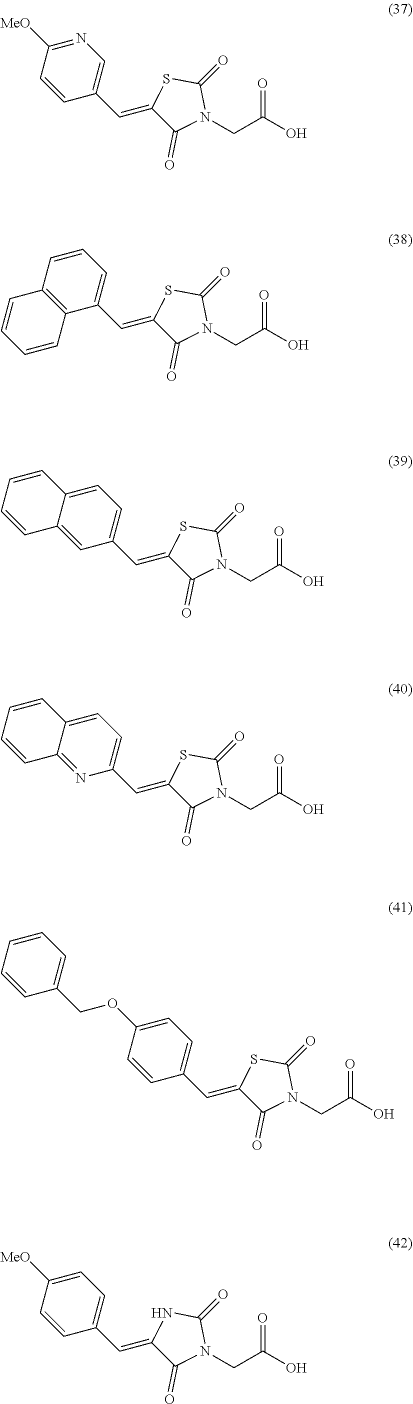 [SMILES: COc1ccc(/C=C2\SC(=O)N(CC(=O)O)C2=O)cn1 ; O=C(O)CN1C(=O)S/C(=C\c2cccc3ccccc23)C1=O ; O=C(O)CN1C(=O)S/C(=C\c2ccc3ccccc3c2)C1=O ; O=C(O)CN1C(=O)S/C(=C\c2ccc3ccccc3n2)C1=O ; O=C(O)CN1C(=O)S/C(=C\c2ccc(OCc3ccccc3)cc2)C1=O ; COc1ccc(/C=C2\NC(=O)N(CC(=O)O)C2=O)cc1]

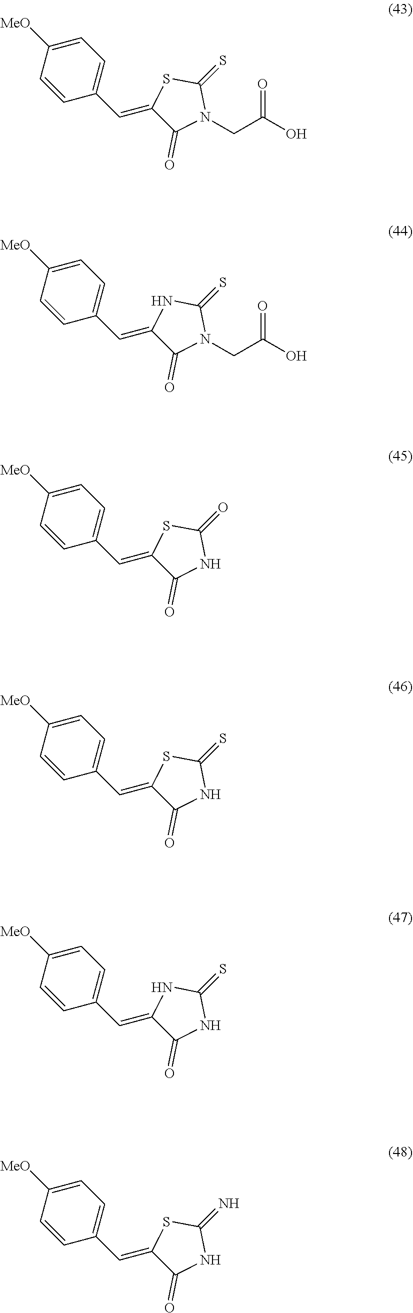 [SMILES: COc1ccc(/C=C2\SC(=S)N(CC(=O)O)C2=O)cc1 ; COc1ccc(/C=C2\NC(=S)N(CC(=O)O)C2=O)cc1 ; COc1ccc(/C=C2\SC(=O)NC2=O)cc1 ; COc1ccc(/C=C2\SC(=S)NC2=O)cc1 ; COc1ccc(/C=C2\NC(=S)NC2=O)cc1 ; COc1ccc(/C=C2\SC(=N)NC2=O)cc1]

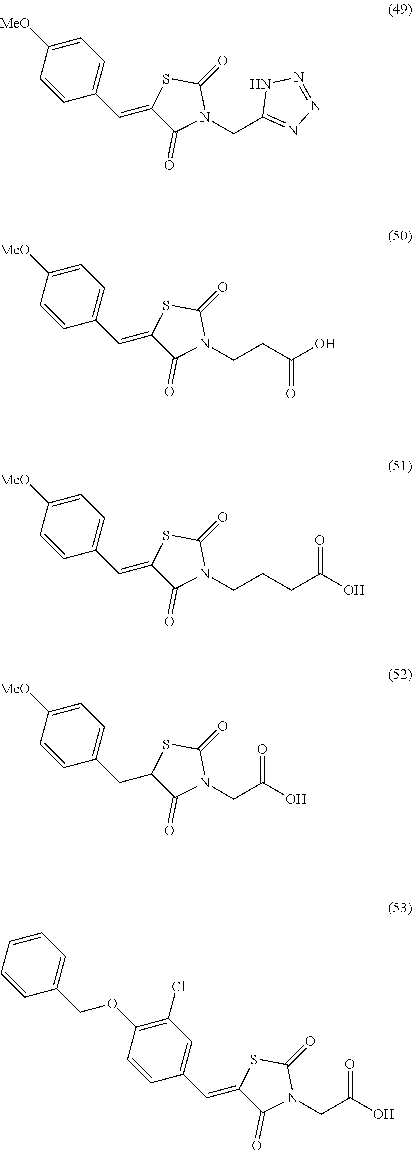 [SMILES: COc1ccc(/C=C2\SC(=O)N(Cc3nnn[nH]3)C2=O)cc1 ; COc1ccc(/C=C2\SC(=O)N(CCC(=O)O)C2=O)cc1 ; COc1ccc(/C=C2\SC(=O)N(CCCC(=O)O)C2=O)cc1 ; COc1ccc(CC2SC(=O)N(CC(=O)O)C2=O)cc1 ; O=C(O)CN1C(=O)S/C(=C\c2ccc(OCc3ccccc3)c(Cl)c2)C1=O]

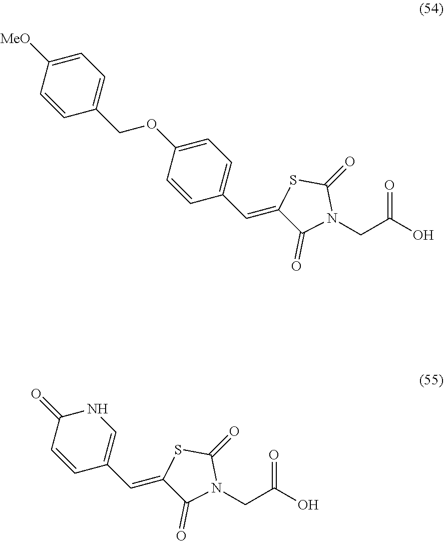 [SMILES: COc1ccc(COc2ccc(/C=C3\SC(=O)N(CC(=O)O)C3=O)cc2)cc1 ; O=C(O)CN1C(=O)S/C(=C\c2ccc(=O)[nH]c2)C1=O]

or a salt or N-oxide thereof.

The compounds of the invention as disclosed above have the ability to inhibit lysine biosynthesis in an organism in which the diaminopimelate biosynthesis pathway occurs by contacting the organism with an effective amount of the compound. Accordingly, the present invention also provides a method of inhibiting lysine biosynthesis in an organism in which the diaminopimelate biosynthesis pathway occurs the method comprising contacting the organism with an effective amount of a compound of formula (1):

The organism is typically contacted with the compound of formula (1) by contacting the organism with a composition containing the compound. In addition to the compound the compositions typically contain a suitable solvent or carrier as detailed below for herbicidal compositions. The concentration of the compound of formula (1) in the composition may vary although it is typically between 50 micromolar to 4000 micromolar. In one embodiment the concentration is from 50 micromolar to 2000 micromolar. In one embodiment the concentration is from 50 micromolar to 1000 micromolar. In one embodiment the concentration is from 100 micromolar to 1000 micromolar. In one embodiment the concentration is from 200 micromolar to 1000 micromolar. As would be appreciated by a skilled worker in the field higher concentrations would work but the higher the concentration the more expensive the treatment becomes.

The organism may be any organism in which lysine biosynthesis occurs via the diaminopimelate pathway. In one embodiment the organism is selected from, the group consisting of plants and bacteria. In one embodiment the organism is a plant. In another embodiment the organism is a bacteria. In one embodiment the organism is a Gram-positive bacteria. In one embodiment the organism is a Gram-negative bacteria.

Without wishing to be bound by theory it is felt that the compounds of the invention inhibit lysine biosynthesis by inhibiting the diaminopimelate pathway in the organism. Accordingly, in some embodiments the compounds inhibits lysine biosynthesis by inhibiting the diaminopimelate pathway in the organism. In some embodiments the compound inhibits lysine biosynthesis by inhibiting DHDPS activity in the organism.

In inhibiting lysine biosynthesis the compound of the invention is typically used in the form of a composition. In one embodiment the composition is a herbicidal composition as discussed below.

### Herbicidal Composition

A herbicidal composition containing the active agent may be in the form of a liquid or a solid composition and as such the composition may be in the form of a concentrate, a wettable powder, granules and the like. Typically these are intended to be admixed with other materials prior to application as a herbicide. In these formulations the active agent is typically present in from 1 wt % to 90 wt % based on the total weight of the composition with the remainder of the composition being made up of a solid or a liquid carrier and other additives as discussed below. In one embodiment the active agent is present in from 0.1 wt % to 90 wt % based on the total weight of the composition. In one embodiment the active agent is present in from 0.1 wt % to 50 wt % based on the total weight of the composition. In one embodiment the active agent is present in from 0.1 wt % to 10 wt % based on the total weight of the composition. In one embodiment the active agent is present in from 0.1 wt % to 5 wt % based on the total weight of the composition. In one embodiment the active agent is present in from 0.1 wt % to 1 wt % based on the total weight of the composition. In one embodiment the active agent is present in from 0.1 wt % to 0.5 wt % based on the total weight of the composition.

As would be appreciated by a skilled worker in the field the concentration of the active compound in the composition used to contact the plant can vary greatly depending upon a number of factors. In one embodiment the concentration is greater than 31.3 micromolar. In one embodiment the concentration is greater than 62.5 micromolar. In one embodiment the concentration is greater than 125 micromolar. In one embodiment the concentration is greater than 250 micromolar. In one embodiment the concentration is greater than 500 micromolar. In one embodiment the concentration is greater than 1000 micromolar. In one embodiment the concentration is from 15.6 micromolar to 500 micromolar. In one embodiment the concentration is from 31.3 micromolar to 2000 micromolar. In one embodiment the concentration is from 62.5 micromolar to 2000 micromolar. In one embodiment the concentration is from 125 micromolar to 2000 micromolar. In one embodiment the concentration is from 125 micromolar to 1000 micromolar. In one embodiment the concentration is from 250 micromolar to 1000 micromolar.

A suitable solid carrier for use in the herbicidal compositions include but are not limited to clays such as kaolinite, diatomaceous earth, synthetic hydrated silicon oxide and bentonites; talcs and other inorganic materials such as calcium carbonates, activated carbon, powdered sulphur, and powdered quartz; and inorganic fertilizers such as ammonium sulfate, ammonium nitrate, ammonium chloride and the like.

A suitable liquid carried may include water; alcohols such as methanol, ethanol, 2-ethylhexanol and n-octanol, halogenated hydrocarbons such as dichloroetheane and trichloroethane; aromatic hydrocarbons such as toluene, xylene and ethyl benzene; non aromatic hydrocarbons such as hexane, cyclohexane and the like; ketones such as acetone, methyl ethyl ketone, and cyclohexanone; esters such as ethyl acetate and butyl acetate; nitriles such as acetonitrile, isobutyronitrile and the like; ethers such as dioxane and diisopropyl ether; acid amides such as dimethyl formamide and dimethylacetamide; or organosulfur compound such as dimethylsulfoxide. In some embodiments the liquid carrier is a mixture of one or more of these materials.

The composition may include one or more additional additives such as surfactants; crystallisation inhibitors, viscosity-modifying substances, suspending agents, dyes, anti-oxidants, foaming agents, light absorbers, mixing aids, anti-foams, complexing agents, neutralising or pH-modifying substances and buffers, corrosion-inhibitors, fragrances, wetting agents, absorption improvers, plasticisers, lubricants, dispersants, thickeners, and the like.

The surfactants that may be used in herbicidal compositions of the invention are well known in the art and include, salts of alkyl sulfates, such as diethanolammonium lauryl sulfate; salts of arylsulfonates, such as calcium dodecylbenzenesulfonate; alkylphenol-alkylene oxide addition products, such as nonylphenol ethoxylate; alcohol-alkylene oxide addition products, such as tridecyl alcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; and salts of mono- and di-alkyl phosphate esters.

The additional additives that may be present in the herbicidal compositions are those that are well known in the art. The herbicidal compositions are typically prepared by combining each of the desired ingredients into a formulation mixer with mixing to produce the final formulation.

A skilled worker in the field of herbicidal formulation could easily prepare a suitable herbicide formulation containing the compounds of Formula (1)

### Use as a Herbicide

As stated previously the compounds of Formula (1) can be used as herbicides. As such in one embodiment the present invention provides a method for controlling undesired plant growth the method comprising contacting the plant with a herbicidal effective amount of a compound of the formula (I) or a salt or N-oxide thereof.

Whilst in principle the compounds may be used to control the growth of any plant they are typically used to control the growth of undesirable plants such as weeds particularly in agricultural settings.

Examples of plants that may be controlled using the methods of the present invention include Bindii, Bindweed, Mullumbimby couch, stinging nettle, pampas grass, lantana, capeweed, common sow thistle, African box thorn, asparagus fern, asthma weed, black nightshade, blue morning glory, bridal creeper, ox-eye daisy, sorrel, lippie, purple nut grass, onion grass, onion weed, paspalum, wandering trad, dandelion, boneseed, soursob, broad leafed privet, small leafed privet, golden bamboo, blackberry, annual rye grass, Barley grass, Black bindweed, bladder ketmia, brome grass, doublegee, fleabane, Funmitory, Indian hedge mustard, Liverseed, Muskweed, Paradoxa grass, Silver grass, Sweet summer grass, turnip weed, wild oats, Wild radish, Windmill grass, and Wire weed.

The compounds of formula (1) can be administered to a plant in any way known in the art. Nevertheless the compounds are typically used in this method in the form of a herbicidal composition as discussed above. In this form the administration of the compound to the plant typically involves a composition containing the active agent is being applied to the plant as such or by dilution of the composition in a solvent such as water followed by application of the diluted composition to the plant. Accordingly administration of the compound to the plant typically involves contacting the plant with the compound either neat or in the form of a herbicidal composition. The compound may be administered by contact with any part of the plant but this typically occurs through the roots, leaves or stem of the plant

Application of the composition to the plant by contact may be by any method known in the art. Thus for small scale applications the composition containing the compound may be painted or applied to the plant by hand. For larger scale applications the composition containing the compound is typically applied by spraying as would be well understood by a worker skilled in the art. The rate of application will vary depending on the plant to be controlled, the application rate, the maturity of the plant to be controlled and its extent of infestation of the land to be treated. In one embodiment application rate is typically from 0.1 kg to 1000 kg per hectare. In one embodiment the application rate is from 0.1 kg to 100 kg per hectare. In one embodiment the application rate is from 0.1 kg to 50 kg per hectare. In one embodiment the application rate is from 10 kg to 50 kg per hectare. In one embodiment application rate is typically from 0.1 kg to 50 kg per hectare. In one embodiment the application rate is from 0.1 kg to 10 kg per hectare. In one embodiment the application rate is from 1.0 kg to 0 kg per hectare. In one embodiment the application rate is from 1.0 kg to 5 kg per hectare.

Aqueous concentrate compositions may be diluted in an appropriate volume of water and applied, for example by spraying, the unwanted plant to be controlled. Compositions prepared by the method may be applied at rates in the range of for example from about 0.1 to about 5 kilograms per hectare (kg/ha), occasionally more. Typical rates for control of annual and perennial grasses and broadleaves are in the range from about 0.3 to about 3 kg/ha. Compositions of the invention may be applied in any convenient volume of water, most typically in the range from about 30 to about 2000 liters per hectare (l/ha). Compositions useful in the method of the invention also include solutions which may be applied by spraying for example. In these solutions, the concentration of the active agent is selected according to the volume per unit area of spray solution to be used and the desired rate of application of the active per unit area. For example, conventional spraying is done at 30 to 5000 liters (particularly 50-600 liters) of spray solution per hectare, and the rate of application of the active is typically 0.125 to 1.5 kg of active per hectare. Spray solution compositions can be prepared by diluting the aqueous liquid concentrates preferably comprising surfactant adjuvants or by tank mixing the aqueous concentrates formed by the method with adjuvants as described above.

### Synthesis of Compounds of the Invention

The compounds for use in the methods of the present invention may be prepared using the reaction routes and synthesis schemes as described below, employing the techniques available in the art using starting materials that are readily available. The preparation of particular compounds of the embodiments is described in detail in the following examples, but the artisan will recognize that the chemical reactions described may be readily adapted to prepare a number of other agents of the various embodiments. For example, the synthesis of non-exemplified compounds may be successfully performed by modifications apparent to those skilled in the art, e.g. by appropriately protecting interfering groups, by changing to other suitable reagents known in the art, or by making routine modifications of reaction conditions. A list of suitable protecting groups in organic synthesis can be found in T.W. Greene's Protective Groups in Organic Synthesis, 3rd Edition, John Wiley & Sons, 1991. Alternatively, other reactions disclosed herein or known in the art will be recognized as having applicability for preparing other compounds of the various embodiments.

The invention will now be illustrated by way of examples; however, the examples are not to be construed as being limitations thereto. Additional compounds, other than those described below, may be prepared using methods and synthetic protocols or appropriate variations or modifications thereof, as described herein.

The majority of the materials were purchased from Sigma-Aldrich as reagent grade. If they were not available from Sigma-Aldrich they were purchased from other commercial suppliers. Melting points taken were uncorrected and recorded on a Reichert “Thermopan” microscope hot stage apparatus.

Nuclear magnetic resonance (NMR) spectra were obtained on a Bruker Avance-400 spectrometer (¹H at 400.13 MHz and ¹³C at 100.62 MHz) or Bruker Avance-500 spectrometer (¹H at 500.03 MHz and ¹³C at 125.75 MHz). Proton chemical shifts are reported in ppm from an internal standard of residual chloroform (7.26 ppm), dimethylsulfoxide (2.50 ppm) or methanol (3.31 ppm). Each resonance was assigned according to the following convention; chemical shift (δ) (multiplicity, coupling constant(s) in Hz, integration). Carbon chemical shifts are reported in parts per million (ppm) using an internal standard of residual chloroform (77.16 ppm), dimethylsulfoxide (39.52 ppm) or methanol (49.00 ppm). Chemical shifts were reported as 8 values in parts per million (ppm). The following abbreviations have been used upon reporting spectral data: s, singlet; d, doublet; t, triplet; q, quartet; quin, quintet; sext, sextet; m, multiplet; app, apparent; and br, broad.

Electrospray ionisation (ESI) mass spectrometry was carried out using a Bruker Daltonics (Germany) Esquire⁶⁰⁰⁰ ion trap mass spectrometer at 140° C. with a flow rate of 4 μL/min, a mass range of 50-3000 m/z and a scan rate of 5500 m/z/second in positive ion mode. Methanol was used with 0.1% formic acid was used as the mobile phase.

Thin layer chromatography (TLC) was used to monitor reactions and chromatographic fractions on Merck Kieselgel 60 F254 aluminium backed plates. Silica gel 60 F254 was used as the stationary phase to perform flash chromatography. Gradient elution using ethyl acetate (EtOAc) and hexane, analytical grade were used unless otherwise stated.

Analytical reverse phase high performance liquid chromatography (HPLC) was performed on a Shimadzu Prominence HPLC system fitted with a Phenomenex® Jupiter C18 300 Å column (250 mm×4.60 mm, 10 μm) using a buffered binary system; solvent A: 0.1% trifluoroacetic acid; solvent B: acetonitrile. Gradient elution was performed using a gradient of 90% solvent A to 90% solvent B over 20 minutes with a flow rate of 1 mL/min, monitored at 254 nm. Semi-preparative reverse phase HPLC was performed using the previously described system, fitted with a Phenomenex® Jupiter C18 300 Å column (250 mm×10.0 mm, 10 μm) using the same binary buffer system described for RP-HPLC over 60 minutes with a flow rate of 2 mL/min, unless otherwise stated.

All glassware used in reactions requiring anhydrous conditions, was oven-dried (120° C.) and then cooled under nitrogen prior to use.

The general scheme for the formation of the compounds of the inventions is shown in scheme 1 below which can be modified depending on the variables chosen for Ar, X, X¹, X², L and R¹, in the final product.

In general the appropriately functionalised Ar-aldehyde (A) is reacted with the appropriately functionalised heterocyclic group such as 2,4-dioxothiazolidine (when X=S, X¹=O, X²=O), 4-oxo-2-thioxothiazolidine (when X=S, X¹=O, X²=S), hydantoin (when X=NH, X¹=O, X²=O) and thiohydantoin (when X=NH, X¹=O, X²=S), ((B) under reflux in the presence of trace amounts of piperidine and acetic acid to form the condensation product C. In the reaction the R¹ group on (B) is typically protected as an ester of the free acid. As would be appreciated by a skilled addressee other combinations of X, X¹ and X² are able to be made using the appropriate starting material. Following condensation the ester group on (C) may be removed under acidic conditions to form the free species if required.

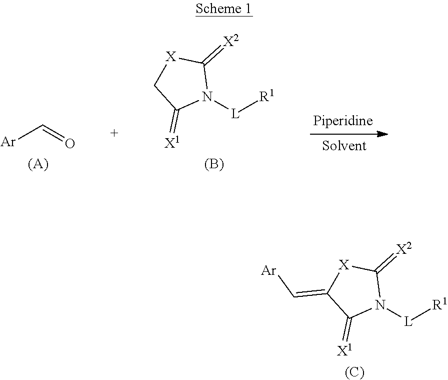

The reagent B utilised in scheme 1 is typically produced as shown in Scheme 2. Accordingly a suitable heterocyclic amine (B1) is reacted with an appropriately functionalised reagent (B2) containing a suitable leaving group (in this case Br) under mildly basic conditions to produce the reagent B as used in Scheme 1.

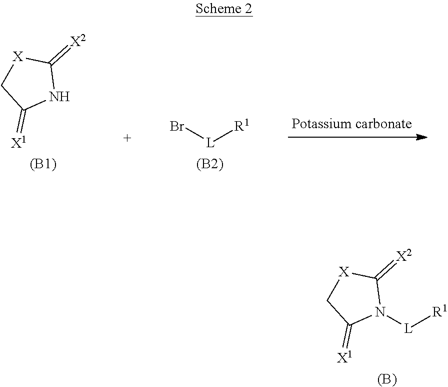

Almost all of the compounds of the invention can be produced using the procedure described in the reaction schemes above with minor modifications that would be within the skill of an organic synthetic chemist.

### Synthesis of Ethyl 2-(2,4-dioxothiazolidin-3-yl)acetate (Starting Material A)

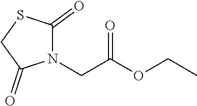

To a stirring suspension of 2,4-thiazolidinedione (0.200 g, 1.71 mmol) and potassium carbonate (0.473, 3.42 mmol) in dry acetonitrile (30 mL), ethyl bromoacetate (0.208 mL, 1.88 mmol) was added dropwise under nitrogen. After 18 hours of stirring at room temperature, the reaction was concentrated in vacuo and the residue partitioned between ethyl acetate (20 mL) and water (20 mL) and the aqueous phase extracted with ethyl acetate (3×20 mL). The organic phase was dried (MgSO₄) and concentrated. The crude product was subjected to column chromatography (silica; 20:80 ethyl acetate/hexanes elution) to afford starting material A as a pale yellow oil (0.279 g, 80%). δ_{H} (400 MHz, CDCl₃) 4.35 (s, 2H, CH₂), 4.23 (q, J 16.0, 8.0, 2H, CH₂), 4.04 (s, 2H, CH₂), 1.29 (t, J 8.0, 3H, CH₃). δ_{C} (100 MHz, CDCl₃) 171.1, 170.7, 166.2, 62.1, 42.1, 33.9, 14.0.

### Synthesis of 2-(2,4-Dioxothiazolidin-3-yl)acetic Acid (Starting Material C)

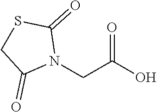 [SMILES: O=C(O)CN1C(=O)CSC1=O]

A mixture of starting material A (0.250 g, 1.23 mmol) in glacial acetic acid (6 mL) and concentrated hydrochloric acid (3 mL) was refluxed for one hour. The reaction was concentrated in vacuo and the residue partitioned between water (20 mL) and ethyl acetate (25 mL). The aqueous phase was washed with ethyl acetate (3×25 mL), dried (MgSO₄) and concentrated in vacuo to afford an oil which solidified under vacuum (0.183 g, 85%). δ_{H} (400 MHz, DMSO) 4.33 (s, 2H, CH₂), 4.21 (s, 2H, CH₂).

### Example 1—(Z)-2-(5-(4-Fluorobenzylidene)-2,4-dioxothiazolidin-3-yl)acetic Acid

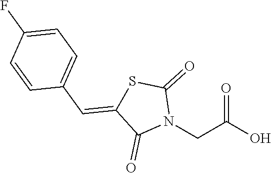 [SMILES: O=C(O)CN1C(=O)S/C(=C\c2ccc(F)cc2)C1=O]

### Step 1—Synthesis of Ethyl (Z)-2-(5-(4-fluorobenzylidene)-2,4-dioxothiazolidin-3-yl)acetate

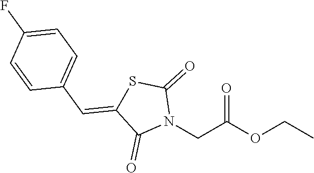 [SMILES: CCOC(=O)CN1C(=O)S/C(=C\c2ccc(F)cc2)C1=O]

To a solution of 4-fluorobenzaldehyde (0.211 mL, 1.97 mmol) and (Starting material A) (0.400 g, 1.97 mmol) in toluene (8 mL), six drops piperidine and four drops acetic acid were added. The reaction was heated under reflux for 18 hours where upon cooling a yellow precipitate formed. The precipitate was collected via vacuum filtration and washed with small amounts of toluene to afford the desired compound (0.323 g, 53%). δ_{H} (400 MHz, CDCl₃) 7.91 (s, 1H, CH), 7.53 (dd, J 8.0, 4.0, 2H, ArH), 7.19 (t, J 8.0, 2H, ArH), 4.48 (s, 2H, CH₂), 4.45 (q, J 16.0, 8.0, 2H, CH₂), 1.30 (t, J 8.0, 3H, CH₃). δ_{C} (100 MHz, CDCl₃) 167.2, 166.2, 165.5, 165.1, 162.5, 133.3, 132.4, 132.3, 129.42, 129.39, 120.8, 120.7, 116.7, 116.5, 62.2, 42.2, 14.1.

### Step 2—Synthesis of (Z)-2-(5-(4-Fluorobenzylidene)-2,4-dioxothiazolidin-3-yl)acetic Acid

A mixture of ethyl (Z)-2-(5-(4-fluorobenzylidene)-2,4-dioxothiazolidin-3-yl)acetate (0.270 g, 0.873 mmol), glacial acetic acid (12 mL) and concentrated hydrochloric acid (5 mL) was refluxed for two hours. The reaction was concentrated in vacuo and the product washed with water and dried to afford the desired compound (0.224 g, 91%). δ_{H} (400 MHz, DMSO) 13.42 (br s, 1H, COOH), 8.01 (s, 1H, CH), 7.73 (dd, J 16.0, 8.0, 2H, ArH), 7.40 (t, J 8.0, 2H, ArH), 4.37 (s, 2H, CH₂). δ_{C} (400 MHz, DMSO) 168.4, 167.3, 165.5, 164.8, 162.4, 133.32, 133.28, 133.2, 130.0, 129.9, 120.90, 120.87, 117.2, 117.0, 42.8.

### Example 2—Synthesis of (Z)-2-(5-Benzylidene-2,4-dioxothiazolidin-3-yl)acetic Acid

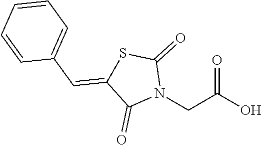 [SMILES: O=C(O)CN1C(=O)S/C(=C\c2ccccc2)C1=O]

### Step 1—Synthesis of Ethyl (Z)-2-(5-benzylidene-2,4-dioxothiazolidin-3-yl)acetate

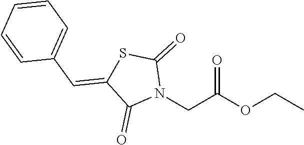 [SMILES: CCOC(=O)CN1C(=O)S/C(=C\c2ccccc2)C1=O]

To a solution of benzaldehyde (0.303 mL, 2.98 mmol) and (Starting material A) (0.605 g, 2.98 mmol) in toluene (6 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.532 g, 61%). δ_{H} (400 MHz, CDCl₃) 7.94 (s, 1H, CH), 7.54-7.44 (m, 5H, ArH), 4.48 (s, 2H, CH₂), 4.25 (q, J 12.0, 8.0, 2H, CH₂), 1.30 (t, J 6.0, 3H, CH₃). δ_{C} (100 MHz, CDCl₃) 167.5, 166.2, 165.6, 134.7, 133.1, 130.7, 130.3, 129.3, 121.1, 62.2, 42.1, 14.1.

### Step 2—Synthesis of (Z)-2-(5-Benzylidene-2,4-dioxothiazolidin-3-yl)acetic Acid

A mixture of ethyl (Z)-2-(5-benzylidene-2,4-dioxothiazolidin-3-yl)acetate (0.500 g, 2.28 mmol), glacial acetic acid (20 mL) and concentrated hydrochloric acid (10 mL) was refluxed for two hours. The reaction was concentrated in vacuo and the product washed with water and dried to afford the desired compound (0.389 g, 86%). δ_{H} (400 MHz, DMSO) 13.45 (br s, 1H, COOH), 7.99 (s, 1H, CH), 7.65 (d, J 8.0, 2H, ArH), 7.58-7.51 (m, 3H, ArH), 4.37 (s, 2H, CH₂). δ_{C} (100 MHz, DMSO) 168.4, 167.4, 165.5, 134.4, 133.3, 131.4, 130.7, 129.9, 121.2, 42.8.

### Example 3—Synthesis of (Z)-2-(5-(2-Methoxybenzylidene)-2,4-dioxothiazolidin-3-yl)acetic Acid

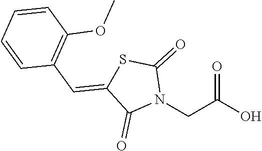 [SMILES: COc1ccccc1/C=C1\SC(=O)N(CC(=O)O)C1=O]

### Step 1—Synthesis of Ethyl (Z)-2-(5-(2-methoxybenzylidene)-2,4-dioxothiazolidin-3-yl)acetate

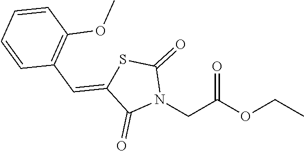 [SMILES: CCOC(=O)CN1C(=O)S/C(=C\c2ccccc2OC)C1=O]

To a solution of 2-methoxybenzaldehyde (0.402 g, 2.95 mmol) and starting material A (0.600 g, 2.95 mmol) in toluene (10 mL), six drops piperidine and four drops acetic acid were added. The reaction was heated under reflux for 18 hours then concentrated in vacuo. The crude solid was washed with small amounts of methanol and collected via vacuum filtration to afford the desired compound (0.639 g, 67%). δ_{H} (400 MHz, CDCl₃) 8.31 (s, 1H, CH), 7.45 (t, J 8.0, 2H, ArH), 7.05 (t, J 8.0, 1H, ArH), 6.96 (d, J 8.0, 1H, ArH), 4.48 (s, 2H, CH₂), 4.25 (q, J 16.0, 8.0, 2H, CH₂), 3.91 (s, 3H, CH₃), 1.30 (t, J 8.0, 3H, CH₃). δ_{C} (100 MHz, CDCl₃) 168.0, 166.3, 165.7, 158.6, 132.5, 130.5, 129.5, 122.3, 121.0, 120.9, 111.2, 62.1, 55.5, 42.0, 14.1.

### Step 2—Synthesis of (Z)-2-(5-(2-Methoxybenzylidene)-2,4-dioxothiazolidin-3-yl)acetic Acid

A mixture of ethyl (Z)-2-(5-(2-methoxybenzylidene)-2,4-dioxothiazolidin-3-yl)acetate (0.600 g, 1.87 mmol), glacial acetic acid (16 mL) and concentrated hydrochloric acid (8 mL) was refluxed for two hours. The reaction was concentrated in vacuo and the product washed with water and dried to afford the desired compound (0.548 g, 85%). δ_{H} (400 MHz, CDCl₃) 8.32 (s, 1H, CH), 7.46-7.41 (m, 2H, ArH), 7.05 (t, J 8.0, 1H, ArH), 6.96 (d, J 8.0, 1H, ArH), 4.55 (s, 2H, CH₂), 3.91 (s, 3H, CH₃). δ_{C} (100 MHz, CDCl₃) 171.5, 167.9, 165.6, 158.6, 132.6, 130.9, 129.5, 122.2, 120.9, 120.7, 111.2, 55.5, 41.6.

### Example 4—Synthesis of (Z)-2-(5-(3-Methoxybenzylidene)-2,4-dioxothiazolidin-3-yl)acetic Acid

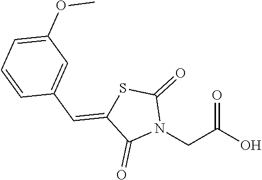 [SMILES: COc1cccc(/C=C2\SC(=O)N(CC(=O)O)C2=O)c1]

### Step 1—Synthesis of Ethyl (Z)-2-(5-(3-methoxybenzylidene)-2,4-dioxothiazolidin-3-yl)acetate

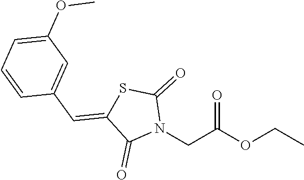 [SMILES: CCOC(=O)CN1C(=O)S/C(=C\c2cccc(OC)c2)C1=O]

To a solution of 3-methoxybenzaldehyde (0.060 mL, 0.492 mmol) and starting material A (0.100 g, 0.492 mmol) in toluene (5 mL), two drops piperidine and one drop acetic acid were added. The reaction was heated under reflux for 18 hours then concentrated in vacuo. The crude solid was washed with small amounts of methanol and collected via vacuum filtration to afford the desired compound (0.051 g, 32%).

δ_{H} (400 MHz, CDCl₃) 7.91 (s, 1H, CH), 7.40 (t, J 8.0, 1H, ArH), 7.12 (d, J 8.0, 1H, ArH), 7.04-6.99 (m, 2H, ArH), 4.48 (s, 2H, CH₂), 4.25 (q, J 16.0, 8.0, 2H, CH₂), 3.86 (s, 3H, CH₃), 1.30 (t, J 8.0, 3H, CH₃). δ_{C} (100 MHz, CDCl₃) 167.4, 166.2, 165.5, 160.1, 134.6, 134.4, 130.3, 122.8, 121.4, 116.7, 115.1, 62.2, 55.4, 42.1, 14.1.

### Step 2—Synthesis of (Z)-2-(5-(3-Methoxybenzylidene)-2,4-dioxothiazolidin-3-yl)acetic Acid

A mixture of ethyl (Z)-2-(5-(3-methoxybenzylidene)-2,4-dioxothiazolidin-3-yl)acetate (0.035 g, 0.109 mmol), glacial acetic acid (2 mL) and concentrated hydrochloric acid (1 mL) was refluxed for two hours. The reaction was concentrated in vacuo and the product washed with water and dried to afford the desired compound (0.030 g, 94%). δ_{H} (400 MHz, CDCl₃) 7.93 (s, 1H, CH), 7.40 (t, J 8.0, 1H, ArH), 7.12 (d, J 8.0, 1H, ArH), 7.03-6.99 (m, 2H, ArH), 4.56 (s, 2H, CH₂), 3.86 (s, 3H, CH₃). δ_{C} (100 MHz, CDCl₃) 171.0, 167.4, 165.4, 160.1, 135.0, 134.3, 130.3, 122.8, 121.1, 116.9, 115.2, 55.4, 41.6.

### Example 5—Synthesis of (Z)-2-(5-(4-Methoxybenzylidene)-2,4-dioxothiazolidin-3-yl)acetic Acid

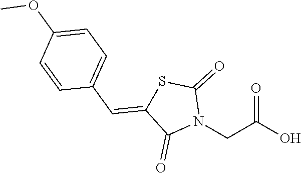 [SMILES: COc1ccc(/C=C2\SC(=O)N(CC(=O)O)C2=O)cc1]

### Step 1—Synthesis of Ethyl (Z)-2-(5-(4-methoxybenzylidene)-2,4-dioxothiazolidin-3-yl)acetate

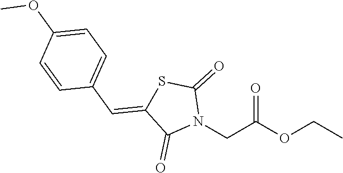 [SMILES: CCOC(=O)CN1C(=O)S/C(=C\c2ccc(OC)cc2)C1=O]

To a solution of 4-methoxybenzaldehyde (0.180 mL, 0.148 mmol) and starting material A (0.300 g, 0.148 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.384 g, 81%). δ_{H} (400 MHz, CDCl₃) 7.89 (s, 1H, CH), 7.48 (dd, J 8.0, 4.0, 2H, ArH), 7.00 (dd, J 8.0, 4.0, 2H, ArH), 4.47 (s, 2H, CH₂), 4.25 (q, J 12.0, 8.0, 2H, CH₂), 3.87 (s, 3H, CH₃), 1.29 (t, J 8.0, 3H, CH₃). δ_{C} (100 MHz, CDCl₃) 167.8, 166.5, 165.9, 161.8, 134.7, 132.5, 125.9, 118.1, 115.0, 62.2, 55.7, 42.2, 14.2.

### Step 2—Synthesis of (Z)-2-(5-(4-Methoxybenzylidene)-2,4-dioxothiazolidin-3-yl)acetic Acid

A mixture of ethyl (Z)-2-(5-(4-methoxybenzylidene)-2,4-dioxothiazolidin-3-yl)acetate (0.350 g, 1.09 mmol), glacial acetic acid (12 mL) and concentrated hydrochloric acid (6 mL) was refluxed for two hours. The reaction was concentrated in vacuo and the product washed with water and dried to afford the desired compound (0.309 g, 97%). δ_{H} (400 MHz, DMSO) 13.43 (br s, 1H, COOH), 7.94 (s, 1H, CH), 7.62 (d, J 8.0, 2H, ArH), 7.12 (d, J 8.0, 2H, ArH), 4.36 (s, 2H, CH₂), 3.83 (s, 3H, CH₃). δ_{C} (100 MHz, DMSO) 168.5, 167.5, 165.6, 161.8, 134.4, 132.9, 125.7, 117.8, 115.5, 56.0, 42.7.A

### Example 6—Synthesis of (Z)-2-(5-(2-Chlorobenzylidene)-2,4-dioxothiazolidin-3-yl)acetic Acid

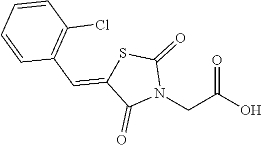 [SMILES: O=C(O)CN1C(=O)S/C(=C\c2ccccc2Cl)C1=O]

### Step 1—Synthesis of Ethyl (Z)-2-(5-(2-chlorobenzylidene)-2,4-dioxothiazolidin-3-yl)acetate

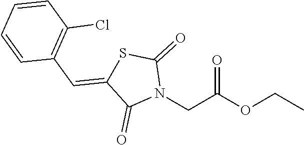 [SMILES: CCOC(=O)CN1C(=O)S/C(=C\c2ccccc2Cl)C1=O]

To a solution of 2-chlorobenzaldehyde (0.111 mL, 0.984 mmol) and starting material A (0.200 g, 0.984 mmol) in toluene (5 mL), three drops piperidine and two drops acetic acid were added. The reaction was heated under reflux for 18 hours then concentrated in vacuo. The crude product was subjected to column chromatography (silica; 15:85 ethyl acetate/hexanes elution) to afford the desired compound (0.160 g, 50%). δ_{H} (500 MHz, CDCl₃) 7.54 (s, 1H, CH), 7.53 (d, J 5.0, 1H, ArH), 7.49 (d, J 5.0, 1H, ArH), 7.40-7.35 (m, 2H, ArH), 4.48 (s, 2H, CH₂), 4.35 (q, J 15.0, 5.0, 2H, CH₂), 1.30 (t, J 5.0, 3H, CH₃). δ_{C} (125 MHz, CDCl₃) 167.2, 166.2, 165.0, 136.1, 131.6, 131.5, 130.9, 130.5, 128.9, 127.3, 124.1, 62.2, 42.2, 14.1.

### Step 2—Synthesis of (Z)-2-(5-(2-Chlorobenzylidene)-2,4-dioxothiazolidin-3-yl)acetic Acid

A mixture of ethyl (Z)-2-(5-(2-chlorobenzylidene)-2,4-dioxothiazolidin-3-yl)acetate (0.100 g, 0.307 mmol), glacial acetic acid (5 mL) and concentrated hydrochloric acid (2.5 mL) was refluxed for two hours. The reaction was concentrated in vacuo and the product washed with water and dried to afford the desired compound (0.087 g, 96%). δ_{H} (400 MHz, DMSO) 13.50 (br s, 1H, COOH), 8.08 (s, 1H, CH), 7.67-7.62 (m, 2H, ArH), 7.55-7.52 (m, 2H, ArH), 4.39 (s, 2H, CH₂). δ_{C} (100 MHz, DMSO) 168.3, 167.1, 165.1, 135.0, 132.8, 131.3, 130.9, 129.6, 129.5, 128.7, 125.0, 42.9.

### Example 7—Synthesis of (Z)-2-(5-(3-Chlorobenzylidene)-2,4-dioxothiazolidin-3-yl)acetic Acid

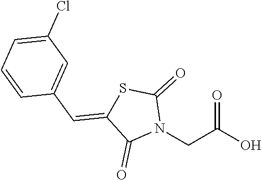 [SMILES: O=C(O)CN1C(=O)S/C(=C\c2cccc(Cl)c2)C1=O]

### Step 1—Synthesis of Ethyl (Z)-2-(5-(3-chlorobenzylidene)-2,4-dioxothiazolidin-3-yl)acetate

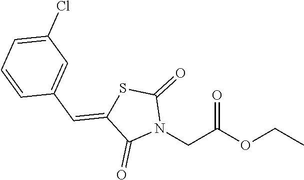 [SMILES: CCOC(=O)CN1C(=O)S/C(=C\c2cccc(Cl)c2)C1=O]

To a solution of 3-chlorobenzaldehyde (0.111 mL, 0.984 mmol) and starting material A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.171 g, 53%). δ_{H} (500 MHz, CDCl₃) 7.85 (s, 1H, CH), 7.49 (s, 1H, CH), 7.43-7.38 (m, 3H, ArH), 4.48 (s, 2H, CH₂), 4.24 (q, J 15.0 5.0, 2H, CH₂), 1.30 (t, J 10.0, 3H, CH₃). δ_{C} (125 MHz, CDCl₃) 166.9, 166.1, 165.3, 135.4, 134.8, 132.9, 130.6, 130.5, 130.0, 128.0, 122.8, 62.2, 42.2, 14.1.

### Step 2—Synthesis of (Z)-2-(5-(3-Chlorobenzylidene)-2,4-dioxothiazolidin-3-yl)acetic Acid

A mixture of ethyl (Z)-2-(5-(3-chlorobenzylidene)-2,4-dioxothiazolidin-3-yl)acetate (0.150 g, 0.460 mmol), glacial acetic acid (6 mL) and concentrated hydrochloric acid (3 mL) was refluxed for two hours. The reaction was concentrated in vacuo and the product washed with water and dried to afford the desired compound (0.121 g, 88%). δ_{H} (400 MHz, CDCl₃) 13.48 (br s, 1H, COOH), 7.99 (s, 1H, CH), 7.74 (s, 1H, ArH), 7.58 (s, 3H, ArH), 4.38 (s, 2H, CH₂). δ_{C} (100 MHz, CDCl₃) 168.4, 167.0, 165.3, 135.4, 134.5, 132.8, 131.7, 130.9, 130.7, 128.3, 123.0, 42.9.

### Example 8—Synthesis of (Z)-2-(5-(4-Chlorobenzylidene)-2,4-dioxothiazolidin-3-yl)acetic Acid

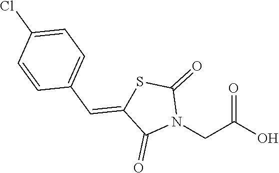 [SMILES: O=C(O)CN1C(=O)S/C(=C\c2ccc(Cl)cc2)C1=O]

### Step 1—Synthesis of Ethyl (Z)-2-(5-(4-chlorobenzylidene)-2,4-dioxothiazolidin-3-yl)acetate

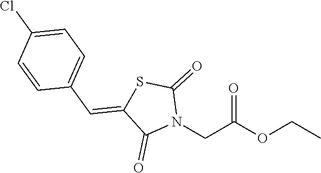 [SMILES: CCOC(=O)CN1C(=O)S/C(=C\c2ccc(Cl)cc2)C1=O]

To a solution of 4-chlorobenzaldehyde (0.138 g, 0.984 mmol) and 1 (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.168 g, 51%). δ_{H} (500 MHz, CDCl₃) 7.88 (s, 1H, CH), 7.45 (s, 4H, ArH), 4.48 (s, 2H, CH₂), 4.24 (q, J 15.0 5.0, 2H, CH₂), 1.30 (t, J 5.0, 3H, CH₃). δ_{C} (125 MHz, CDCl₃) 167.0, 166.2, 165.4, 136.9, 133.1, 131.6, 131.4, 129.6, 121.7, 62.2, 42.2, 14.1.

### Step 2—Synthesis of (Z)-2-(5-(4-Chlorobenzylidene)-2,4-dioxothiazolidin-3-yl)acetic Acid

A mixture of ethyl (Z)-2-(5-(4-chlorobenzylidene)-2,4-dioxothiazolidin-3-yl)acetate (0.150 g, 0.460 mmol), glacial acetic acid (6 mL) and concentrated hydrochloric acid (3 mL) was refluxed for two hours. The reaction was concentrated in vacuo and the product washed with water and dried to afford the desired compound (0.119 g, 87%). δ_{H} (400 MHz, DMSO) 13.46 (br s, 1H, COOH), 8.00 (s, 1H, CH), 7.68 (d, J 8.0, 2H, ArH), 7.62 (d, J 8.0, 2H, ArH), 4.38 (s, 2H, CH₂). δ_{C} (100 MHz, DMSO) 168.4, 167.1, 165.4, 136.0, 133.1, 132.3, 132.2, 130.0, 121.9, 42.8.

### Example 9—Synthesis of (Z)-2-(5-(4-Bromobenzylidene)-2,4-dioxothiazolidin-3-yl)acetic Acid

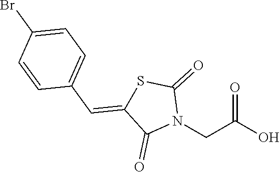 [SMILES: O=C(O)CN1C(=O)S/C(=C\c2ccc(Br)cc2)C1=O]

### Step 1—Synthesis of Ethyl (Z)-2-(5-(4-bromobenzylidene)-2,4-dioxothiazolidin-3-yl)acetate

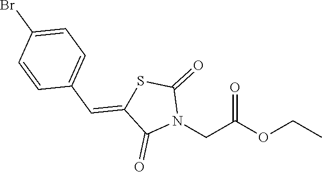 [SMILES: CCOC(=O)CN1C(=O)S/C(=C\c2ccc(Br)cc2)C1=O]

To a solution of 4-bromobenzaldehyde (0.182 g, 0.984 mmol) and starting material A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.201 g, 59%). δ_{H} (500 MHz, CDCl₃) 7.85 (s, 1H, CH), 7.61 (d, J 5.0, 2H, ArH), 7.37 (d, J 5.0, 2H, ArH), 4.47 (s, 2H, CH₂), 4.24 (q, J 15.0 5.0, 2H, CH₂), 1.29 (t, J 10.0, 3H, CH₃). δ_{C} (125 MHz, CDCl₃) 167.0, 166.1, 165.4, 133.2, 132.6, 132.0, 131.5, 125.3, 121.8, 62.2, 42.2, 14.1.

### Step 2—Synthesis of (Z)-2-(5-(4-Bromobenzylidene)-2,4-dioxothiazolidin-3-yl)acetic Acid

A mixture of ethyl (Z)-2-(5-(4-bromobenzylidene)-2,4-dioxothiazolidin-3-yl)acetate (0.150 g, 0.405 mmol), glacial acetic acid (6 mL) and concentrated hydrochloric acid (3 mL) was refluxed for two hours. The reaction was concentrated in vacuo and the product washed with water and dried to afford the desired compound (0.118 g, 85%). δ_{H} (400 MHz, DMSO) 13.47 (br s, 1H, COOH), 7.97 (s, 1H, CH), 7.75 (d, J 8.0, 2H, ArH), 7.59 (d, J 8.0, 2H, ArH), 4.37 (s, 2H, CH₂). δ_{C} (100 MHz, DMSO) 168.4, 167.1, 165.4, 133.2, 132.9, 132.5, 124.9, 122.0, 42.8.

### Example 10—Synthesis of (Z)-2-(5-(4-Methylbenzylidene)-2,4-dioxothiazolidin-3-yl)acetic Acid

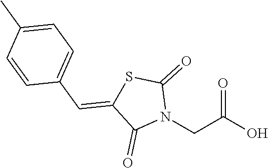 [SMILES: Cc1ccc(/C=C2\SC(=O)N(CC(=O)O)C2=O)cc1]

### Step 1—Synthesis of Ethyl (Z)-2-(5-(4-methylbenzylidene)-2,4-dioxothiazolidin-3-yl)acetate

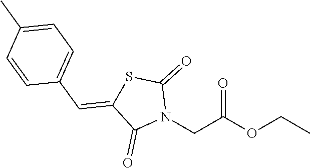 [SMILES: CCOC(=O)CN1C(=O)S/C(=C\c2ccc(C)cc2)C1=O]

To a solution of 4-tolualdehyde (0.116 mL, 0.984 mmol) and 1 (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.208 g, 76%). δ_{H} (500 MHz, CDCl₃) 7.91 (s, 1H, CH), 7.41 (d, J 5.0, 2H, ArH), 7.28 (d, J 5.0, 2H, ArH), 4.47 (s, 2H, CH₂), 4.24 (q, J 15.0, 5.0, 2H, CH₂), 2.41 (s, 3H, CH₃), 1.29 (t, 3H, J 10.0, 3H, CH₃). δ_{C} (125 MHz, CDCl₃) 167.6, 166.3, 165.7, 141.6, 134.8, 130.4, 130.4, 130.0, 119.8, 62.1, 42.1, 21.6, 14.1.

### Step 2—Synthesis of (Z)-2-(5-(4-Methylbenzylidene)-2,4-dioxothiazolidin-3-yl)acetic Acid

A mixture of ethyl (Z)-2-(5-(4-methylbenzylidene)-2,4-dioxothiazolidin-3-yl)acetate (0.150 g, 0.491 mmol), glacial acetic acid (6 mL) and concentrated hydrochloric acid (3 mL) was refluxed for two hours. The reaction was concentrated in vacuo and the product washed with water and dried to afford the desired compound (0.121 g, 89%). δ_{H} (400 MHz, DMSO) 13.47 (br s, 1H, COOH), 7.95 (s, 1H, CH), 7.54 (d, J 8.0, 2H, ArH), 7.37 (d, J 8.0, 2H, ArH), 4.38 (s, 2H, CH₂), 2.37 (s, 3H, CH₃). δ_{C} (100 MHz, DMSO) 168.5, 167.4, 165.5, 141.8, 134.4, 130.8, 130.5, 119.9, 42.7, 21.6.

### Example 11—Synthesis of (Z)-2-(5-(4-Aminobenzylidene)-2,4-dioxothiazolidin-3-yl)acetic Acid

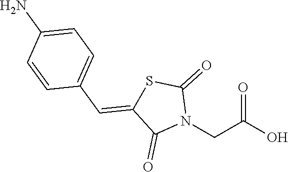 [SMILES: Nc1ccc(/C=C2\SC(=O)N(CC(=O)O)C2=O)cc1]

### Step 1—Synthesis of Ethyl (Z)-2-(5-(4-acetamidobenzylidene)-2,4-dioxothiazolidin-3-yl)acetate

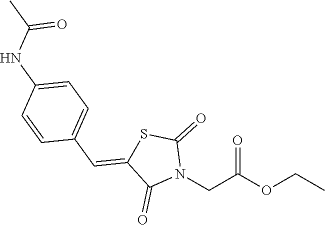 [SMILES: CCOC(=O)CN1C(=O)S/C(=C\c2ccc(NC(C)=O)cc2)C1=O]

To a solution of 4-acetamidobenzaldehyde (0.161 g, 0.984 mmol) and starting material A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.264 g, 77%). δ_{H} (500 MHz, CDCl₃) 7.99 (s, 1H, NH), 7.75 (s, 1H, CH), 7.62 (d, J 10.0, 2H, ArH), 7.35 (d, J 10.0, 2H, ArH), 4.48 (s, 2H, CH₂), 4.25 (q, J 15.0, 10.0, 2H, CH₂), 2.18 (s, 3H, CH₃), 1.31 (t, J 10.0, 3H, CH₃). δ_{C} (125 MHz, CDCl₃) 168.8, 167.6, 166.8, 165.6, 140.6, 134.2, 131.5, 128.3, 119.7, 119.0, 62.3, 42.1, 24.7, 14.1.

### Step 2—Synthesis of (Z)-2-(5-(4-Aminobenzylidene)-2,4-dioxothiazolidin-3-yl)acetic Acid

A mixture of ethyl (Z)-2-(5-(4-acetamidobenzylidene)-2,4-dioxothiazolidin-3-yl)acetate (0.150 g, 0.431 mmol), glacial acetic acid (6 mL) and concentrated hydrochloric acid (3 mL) was refluxed for two hours. The reaction was concentrated in vacuo and the product washed with water and dried to afford the desired compound (0.101 g, 73%). δ_{H} (400 MHz, DMSO) 7.75 (s, 1H, CH), 7.35 (d, J 8.0, 2H, ArH), 6.65 (d, J 8.0, 2H, ArH), 6.20 (br s, 2H, NH₂), 4.31 (s, 2H, CH₂). δ_{C} (100 MHz, DMSO) 168.6, 167.8, 165.8, 152.8, 135.6, 133.5, 120.0, 114.4, 112.2, 42.6.

### Example 12—Synthesis of (Z)-2-(5-(4-Hydroxybenzylidene)-2,4-dioxothiazolidin-3-yl)acetic Acid

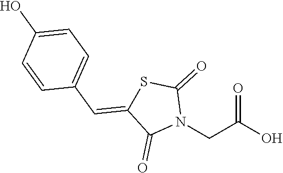 [SMILES: O=C(O)CN1C(=O)S/C(=C\c2ccc(O)cc2)C1=O]

### Step 1—Synthesis of Ethyl (Z)-2-(5-(4-hydroxybenzylidene)-2,4-dioxothiazolidin-3-yl)acetate

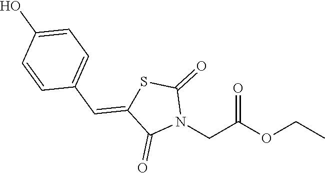 [SMILES: CCOC(=O)CN1C(=O)S/C(=C\c2ccc(O)cc2)C1=O]

To a solution of 4-hydroxybenzaldehyde (0.120 g, 0.984 mmol) and starting material A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.190 g, 63%). δ_{H} (500 MHz, CDCl₃) 7.76 (s, 1H, CH), 7.34 (d, J 10.0, 2H, ArH), 6.90 (d, J 10.0, 2H, ArH), 6.07 (br s, 1H, OH), 4.49 (s, 2H, CH₂), 4.27 (q, J 15.0, 10.0, 2H, CH₂), 1.31 (t, J 10.0, 3H, CH₃). δ_{C} (125 MHz, CDCl₃) 167.7, 167.1, 165.8, 158.4, 134.8, 132.8, 132.6, 125.6, 117.6, 116.4, 62.4, 42.1, 14.1

### Step 2—Synthesis of (Z)-2-(5-(4-Hydroxybenzylidene)-2,4-dioxothiazolidin-3-yl)acetic Acid

A mixture of ethyl (Z)-2-(5-(4-hydroxybenzylidene)-2,4-dioxothiazolidin-3-yl)acetate (0.150 g, 0.488 mmol), glacial acetic acid (6 mL) and concentrated hydrochloric acid (3 mL) was refluxed for two hours. The reaction was concentrated in vacuo and the product washed with water and dried to afford the desired compound (0.109 g, 80%). δ_{H} (400 MHz, DMSO) 13.40 (br s, 1H, COOH), 10.39 (s, 1H, OH), 7.88 (s, 1H, CH), 7.51 (d, J 8.0, 2H, ArH), 6.92 (d, J 8.0, 2H, ArH), 4.34 (s, 2H, CH₂). δ_{C} (100 MHz, DMSO) 168.5, 167.6, 165.7, 160.8, 134.8, 133.2, 124.2, 116.9, 116.5, 42.7.

### Example 13—Synthesis of (Z)-2-(5-(3-Chloro-4-hydroxybenzylidene)-2,4-dioxothiazolidin-3-yl)acetic Acid

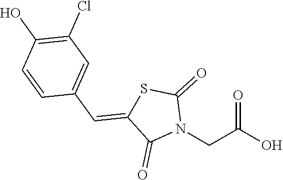 [SMILES: O=C(O)CN1C(=O)S/C(=C\c2ccc(O)c(Cl)c2)C1=O]

### Step 1—Synthesis of Ethyl (Z)-2-(5-(3-chloro-4-hydroxybenzylidene)-2,4-dioxothiazolidin-3-yl)acetate

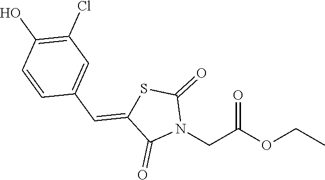 [SMILES: CCOC(=O)CN1C(=O)S/C(=C\c2ccc(O)c(Cl)c2)C1=O]

To a solution of 3-chloro-4-hydroxybenzaldehyde (0.154 g, 0.984 mmol) and (Starting material A) (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.231 g, 69%). δ_{H} (400 MHz, CDCl₃) 7.81 (s, 1H, CH), 7.52 (s, 1H, ArH), 7.38 (d, J 8.0, 1H, ArH), 7.13 (d, J 8.0, 1H, ArH), 4.48 (s, 2H, CH₂), 4.26 (q, J 12.0, 8.0, 2H, CH₂), 1.31 (t, J 8.0, 3H, CH₃). δ_{C} (100 MHz, CDCl₃) 167.1, 166.3, 165.5, 153.5, 132.9, 131.2, 130.7, 126.8, 121.1, 119.8, 117.2, 62.2, 42.2, 14.1

### Step 2—Synthesis of (Z)-2-(5-(3-Chloro-4-hydroxybenzylidene)-2,4-dioxothiazolidin-3-yl)acetic Acid

A mixture of ethyl (Z)-2-(5-(3-chloro-4-hydroxybenzylidene)-2,4-dioxothiazolidin-3-yl)acetate (0.150 g, 0.439 mmol), glacial acetic acid (6 mL) and concentrated hydrochloric acid (3 mL) was refluxed for two hours. The reaction was concentrated in vacuo and the product washed with water and dried to afford the desired compound (0.113 g, 82%). δ_{H} (400 MHz, DMSO) 13.40 (br s, 1H, COOH), 11.18 (br s, 1H, OH), 7.89 (s, 1H, CH), 7.70 (s, 1H, ArH), 7.45 (d, J 8.0, 1H, ArH), 7.12 (d, J 8.0, 1H, ArH), 4.35 (s, 2H, CH₂). δ_{C} (100 MHz, DMSO) 168.5, 167.3, 165.5, 156.1, 133.5, 133.3, 130.5, 125.4, 121.2, 118.4, 117.8, 42.7.

### General Procedure for Examples 14 to 20

To a solution of aldehyde (0.47 mmol) and starting material A (0.100 g, 0.46 mmol) in tetrahydrofuran (40 mL), five-six drops piperidine and two drops acetic acid were added. The reaction was heated at 70-80° C. for one hour and the progression of the reaction monitored via thin layer chromatography (50:50 acetic acid/petroleum ether or 40:60 ethyl acetate/hexanes). When the reaction was completed, the solvent was evaporated in vacuo and poured onto ice. The mixture was acidified with acetic acid to pH 3-4 then stirred for 30 minutes. The solids were collected via vacuum filtration and the product purified via column chromatography (silica gel) if required.

The previously generated product (0.200 g) was added to acetic acid (20 mL) and hydrochloric acid (10 mL) then refluxed for 1-2 hours. The reaction was monitored via thin layer chromatography and when completed, concentrated in vacuo. The residue was washed with water to afford the final product.

### Example 14—Synthesis of (Z)-2-(5-(2-Hydroxybenzylidene)-2,4-dioxothiazolidin-3-yl)acetic Acid

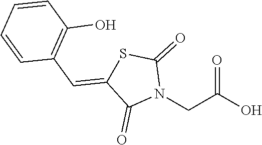 [SMILES: O=C(O)CN1C(=O)S/C(=C\c2ccccc2O)C1=O]

δ_{H} (400 MHz, CDCl₃) δ_{H} (400 MHz, DMSO) 10.67 (br s, 1H, OH), 8.15 (s, 1H, CH), 7.38-7.31 (m, 2H, ArH), 6.98-6.94 (m, 2H, ArH), 4.31 (s, 2H, CH₂).

### Example 15—Synthesis of (Z)-2-(5-(2-Hydroxy-5-nitrobenzylidene)-2,4-dioxothiazolidin-3-yl)acetic Acid

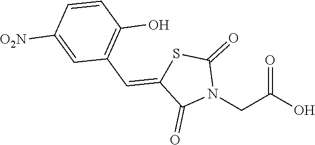 [SMILES: O=C(O)CN1C(=O)S/C(=C\c2cc([N+](=O)[O-])ccc2O)C1=O]

δ_{H} (400 MHz, CDCl₃) δ_{H} (400 MHz, DMSO) 8.26-8.21 (m, 2H, ArH), 8.06 (s, 1H, CH), 7.12 (d, J 8.0, 1H, ArH), 4.38 (s, 2H, CH₂).

### Example 16—Synthesis of (Z)-2-(5-(2-Hydroxy-3-methoxybenzylidene)-2,4-dioxothiazolidin-3-yl)acetic Acid

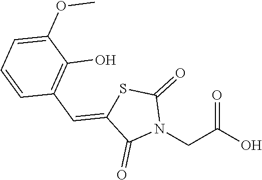 [SMILES: COc1cccc(/C=C2\SC(=O)N(CC(=O)O)C2=O)c1O]

δ_{H} (400 MHz, CDCl₃) δ_{H} (400 MHz, DMSO) 13.40 (br s, 1H, COOH), 9.84 (s, 1H, OH), 8.18 (s, 1H, CH), 7.11 (d, J 8.0, 1H, ArH), 6.99-6.91 (m, 2H, ArH), 4.36 (s, 2H, CH₂), 3.84 (s, 3H, CH₃).

### Example 17—Synthesis of (Z)-2-(5-(2,4-Dimethoxybenzylidene)-2,4-dioxothiazolidin-3-yl)acetic Acid

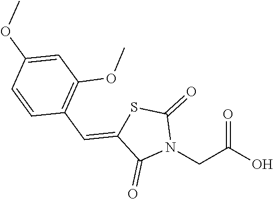 [SMILES: COc1ccc(/C=C2\SC(=O)N(CC(=O)O)C2=O)c(OC)c1]

δ_{H} (400 MHz, CDCl₃) δ_{H} (400 MHz, CDCl₃) 8.27 (s, 1H, CH), 7.39 (d, J 8.0, 1 H, ArH), 6.59 (d, J 8.0, 1 H, ArH), 6.48 (s, 1H, ArH), 4.53 (s, 2H, CH₂), 3.89 (s, 3H, CH₃), 3.87 (s, 3H, CH₃).

### Example 18—Synthesis of (Z)-5-(2,4-Dichlorobenzylidene)-2-thioxothiazolidin-4-one

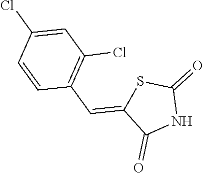 [SMILES: O=C1NC(=O)/C(=C/c2ccc(Cl)cc2Cl)S1]

δ_{H} (400 MHz, CDCl₃) δ_{H} (400 MHz, CDCl₃) 7.83 (s, 1H, CH), 7.50 (s, 1H, ArH), 7.44 (d, J 8.0, 1H, ArH), 7.36 (d, J 8.0, 1H, ArH).

### Example 19—Synthesis of (Z)-5-(2-Hydroxybenzylidene)thiazolidine-2,4-dione

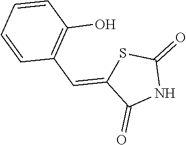 [SMILES: O=C1NC(=O)/C(=C/c2ccccc2O)S1]

δ_{H} (400 MHz, CDCl₃) δ_{H} (400 MHz, DMSO) 12.49 (br s, 1H, NH), 10.48 (s, 1H, OH), 8.00 (s, 1H, CH), 7.33-7.31 (m, 2H, ArH), 6.96-6.93 (m, 2H, ArH).

### Example 20—Synthesis of (Z)-2-(5-(4-Acetamidobenzylidene)-2,4-dioxothiazolidin-3-yl)acetic Acid

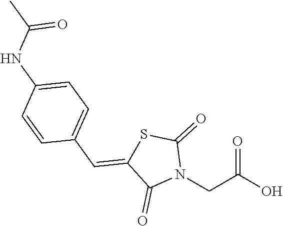 [SMILES: CC(=O)Nc1ccc(/C=C2\SC(=O)N(CC(=O)O)C2=O)cc1]

A mixture of 4-acetamidobenzaldehyde (0.093 g, 0.571 mmol), starting material C (0.100 g, 0.571 mmol) and piperidine (0.045 mL, 0.457 mmol) in ethanol (6 mL) was heated under reflux overnight. The reaction was poured onto water and acidified with acetic acid to give the desired compound, collected via vacuum filtration (0.050 g, 27%). δ_{H} (400 MHz, DMSO) 10.30 (s, 1H, NH), 7.90 (s, 1H, CH), 7.78 (d, J 8.0, 2H, ArH), 7.60 (d, J 8.0, 2H, ArH), 4.38 (s, 2H, CH₂), 2.09 (s, 3H, CH₃).

### Example 21—Synthesis of 2-(5-(2,4-Dihydroxybenzylidene)-2,4-dioxothiazolidin-3-yl)acetic Acid

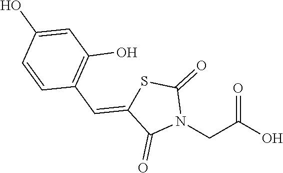 [SMILES: O=C(O)CN1C(=O)S/C(=C\c2ccc(O)cc2O)C1=O]

### Step 1—Synthesis of Ethyl 2-(5-(2,4-dihydroxybenzylidene)-2,4-dioxothiazolidin-3-yl)acetate

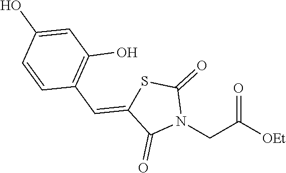 [SMILES: CCOC(=O)CN1C(=O)S/C(=C\c2ccc(O)cc2O)C1=O]

To a solution of ethyl 2-(2,4-dioxothiazolidin-3-yl)acetate (0.264 g, 1.299 mmol) and 2,4-dihydroxybenzaldehyde (0.173 g, 1.25 mmol) in ethanol (6.25 mL), three drops piperidine were added. The reaction was heated under reflux overnight then concentrated in vacuo. The crude residue was washed with small amounts of methanol and collected via vacuum filtration to afford the desired compound (0.404 g, 22%). δ_{H} (400 MHz, DMSO) 10.61 (s, 1H, OH), 10.30 (s, 1H, OH), 8.13 (s, 1H, CH), 7.25 (d, J 8.0, 1H, ArH), 6.44 (s, 1H, ArH), 6.43 (d, J 8.0, 1H, ArH), 4.46 (s, 2H, CH₂), 4.17 (q, J 12.0, 6.0, 2H, CH₂), 1.21 (t, J 8.0, 3H, CH₃).

### Step 2—Synthesis of 2-(5-(2,4-Dihydroxybenzyl idene)-2,4-dioxothiazolidin-3-yl)acetic Acid

A mixture of ethyl 2-(5-(2,4-dihydroxybenzylidene)-2,4-dioxothiazolidin-3-yl)acetate (0.997 g, 0.308 mmol), glacial acetic acid (6 mL) and concentrated hydrochloric acid (3 mL) was refluxed for two hours. The reaction was concentrated in vacuo and the product washed with water and dried to afford the desired compound (0.051 g, 56%). δ_{H} (400 MHz, DMSO) 10.59 (s, 1H, OH), 10.28, s, 1H, OH), 8.11 (s, 1H, CH), 7.23 (d, J 8.0, 1H, ArH), 6.44 (s, 1H, ArH), 6.42 (d, J 8.0, 1H, ArH), 4.35 (s, 2H, CH₂).

### Example 22—Synthesis of 2-(5-(2,3-Dimethoxybenzylidene)-2,4-dioxothiazolidin-3-yl) acetic Acid

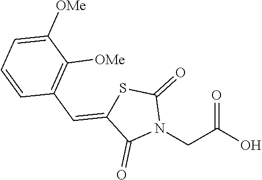 [SMILES: COc1cccc(/C=C2\SC(=O)N(CC(=O)O)C2=O)c1OC]

### Step 1—Synthesis of Ethyl 2-(5-(2,3-dimethoxybenzylidene)-2,4-dioxothiazolidin-3-yl)acetate

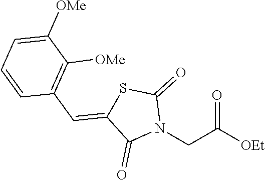 [SMILES: CCOC(=O)CN1C(=O)S/C(=C\c2cccc(OC)c2OC)C1=O]

To a solution of ethyl 2-(2,4-dioxothiazolidin-3-yl)acetate (0.249 g, 1.225 mmol) and 2,3-dimethoxybenzaldehyde (0.202 g, 1.216 mmol) in toluene (6 mL), three drops piperidine and two drops acetic acid were added. The reaction was heated under reflux overnight then concentrated in vacuo. The crude residue was washed with small amounts of methanol and collected via vacuum filtration to afford the desired compound (0.248 g, 58%). δ_{H} (400 MHz, CDCl₃) 8.25 (s, 1H, CH), 7.15 (dd app t, J 10.0, 1 H, ArH), 7.07 (d, J 8.0, 1 H, ArH), 7.01 (d, J 8.0, 1H, ArH), 4.47 (s, 2H, CH₂), 4.24 (q, J 16.0, 8.0, 2H, CH₂), 3.89 (s, 3H, CH₃), 3.89 (s, 3H, CH₃), 1.29 (t, J 8.0, 3H, CH₃).

### Step 2—Synthesis of 2-(5-(2,3-Dimethoxybenzylidene)-2,4-dioxothiazolidin-3-yl)acetatic Acid

A mixture of ethyl 2-(5-(2,3-dimethoxybenzylidene)-2,4-dioxothiazolidin-3-yl)acetate (0.102 g, 0.285 mmol), glacial acetic acid (6 mL) and concentrated hydrochloric acid (3 mL) was refluxed for two hours. The reaction was concentrated in vacuo and the product washed with water and dried to afford the desired compound (0.0267 g, 28%). δ_{H} (400 MHz, DMSO) 8.08 (s, 1H, CH), 7.27-7.25 (m, 2H, ArH), 7.10 (t, J 4.0, 1H, ArH), 4.37 (s, 2H, CH₂), 3.87 (s, 3H, CH₃), 3.81 (s, 3H, CH₃).

### Example 23—Synthesis of 2-(5-(3,4-Dimethoxybenzylidene)-2,4-dioxothiazolidin-3-yl)acetic Acid

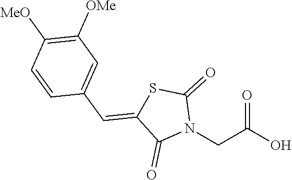 [SMILES: COc1ccc(/C=C2\SC(=O)N(CC(=O)O)C2=O)cc1OC]

### Step 1—Synthesis of Ethyl 2-(5-(3,4-dimethoxybenzylidene)-2,4-dioxothiazolidin-3-yl)acetate

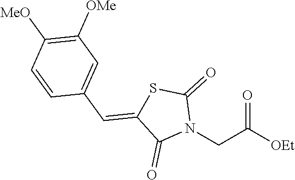 [SMILES: CCOC(=O)CN1C(=O)S/C(=C\c2ccc(OC)c(OC)c2)C1=O]

To a solution of ethyl 2-(2,4-dioxothiazolidin-3-yl)acetate (0.247 g, 1.215 mmol) and 3,4-dimethoxybenzaldehyde (0.204 g, 1.228 mmol) in toluene (6.25 mL), three drops piperidine and two drops acetic acid were added. The reaction was heated under reflux overnight then concentrated in vacuo. The crude residue was washed with small amounts of methanol and collected via vacuum filtration to afford the desired compound (0.271 g, 63%). δ_{H} (400 MHz, CDCl₃) 7.87 (s, 1H, CH), 7.14 (d app dd, J 8.0, 2.0, 1H, ArH), 7.00 (s, 1H, ArH), 6.95 (d, J 8.0, 1 H, ArH), 4.47 (s, 2H, CH₂), 4.23 (q, J 12.0, 8.0, 2H, CH₂), 3.94 (s, 3H, CH₃), 3.93 (s, 3H, CH₃), 1.29 (t, J 8.0, 3H, CH₃).

### Step 2—Synthesis of 2-(5-(3,4-Dimethoxybenzylidene)-2,4-dioxothiazolidin-3-yl)acetic Acid

A mixture of ethyl 2-(5-(3,4-dimethoxybenzylidene)-2,4-dioxothiazolidin-3-yl)acetate (0.102 g, 0.285 mmol), glacial acetic acid (6 mL) and concentrated hydrochloric acid (3 mL) was refluxed for two hours. The reaction was concentrated in vacuo and the product washed with water and dried to afford the desired compound (0.0732 g, 78%). δ_{H} (400 MHz, DMSO) 7.95 (s, 1H, CH), 7.26 (s, 1H, ArH), 7.25 (d, J 8.0, 1H, ArH), 7.15 (d, J 12.0, 1H, ArH), 4.38 (s, 2H, CH₂), 3.85 (s, 3H, CH₃), 3.83 (s, 3H, CH₃).

### Example 24—Synthesis of (Z)-2-(5-(4-Cyanobenzylidene)-2,4-dioxothiazolidin-3-yl)acetic Acid

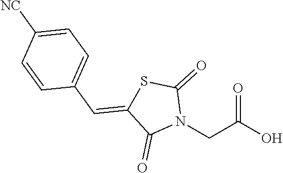 [SMILES: N#Cc1ccc(/C=C2\SC(=O)N(CC(=O)O)C2=O)cc1]

### Step 1—Synthesis of Ethyl (Z)-2-(5-(4-cyanobenzylidene)-2,4-dioxothiazolidin-3-yl)acetate

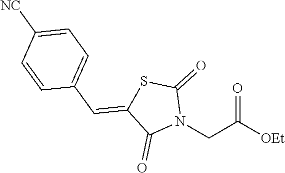 [SMILES: CCOC(=O)CN1C(=O)S/C(=C\c2ccc(C#N)cc2)C1=O]

To a solution of 4-cyanbenzaldehyde (0.258 g, 1.97 mmol) and A (0.400 g, 1.97 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.314 g, 50%). δ_{H} (400 MHz, CDCl₃) 7.90 (s, 1H, CH), 7.77 (d, J 8.0, 2H, ArH), 7.60 (d, J 8.0, 2H, ArH), 4.48 (s, 2H, CH₂), 4.25 (q, J 16.0, 8.0, 2H, CH₂), 1.30 (t, J 8.0, 3H, CH₃).

### Step 2—Synthesis of (Z)-2-(5-(4-Cyanobenzylidene)-2,4-dioxothiazolidin-3-yl)acetic Acid

A mixture of ethyl (Z)-2-(5-(4-cyanobenzylidene)-2,4-dioxothiazolidin-3-yl)acetate (0.080 g, 0.253 mmol), glacial acetic acid (6 mL) and concentrated hydrochloric acid (3 mL) was refluxed for 20 minutes. The reaction was concentrated in vacuo and the product washed with water to afford the crude product which was purified by semi-preparative RP-HPLC to afford the desired compound (0.011 g, 15%). δ_{H} (400 MHz, MeOD) 7.97 (s, 1H, CH), 7.86 (d, J 8.0, 2H, ArH), 7.76 (d, J 8.0, 2H, ArH), 4.47 (s, 2H, CH₂).

### Example 25—Synthesis of (Z)-4-((3-(Carboxymethyl)-2,4-dioxothiazolidin-5-ylidene)methyl)benzoic Acid

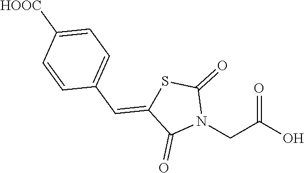 [SMILES: O=C(O)CN1C(=O)S/C(=C\c2ccc(C(=O)O)cc2)C1=O]

### Step 1—Synthesis of (Z)-4-((3-(2-Ethoxy-2-oxoethyl)-2,4-dioxothiazolidin-5-ylidene)methyl)benzoic Acid

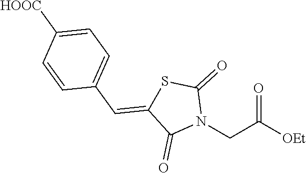 [SMILES: CCOC(=O)CN1C(=O)S/C(=C\c2ccc(C(=O)O)cc2)C1=O]

To a solution of 4-formylbenzoic acid (0.103 g, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.125 g, 38%). δ_{H} (400 MHz, DMSO) 8.08 (d, J 12.0, 2H, ArH), 8.06 (s, 1H, CH), 7.78 (d, J 8.0, 2H, ArH), 4.54 (s, 2H, CH₂), 4.19 (q, J 12.0, 8.0, 2H, CH₂), 1.21 (t, J 8.0, 3H, CH₃).

### Step 2—Synthesis of (Z)-4-((3-(Carboxymethyl)-2,4-dioxothiazolidin-5-ylidene)methyl)benzoic Acid

A mixture of (Z)-4-((1-(2-ethoxy-2-oxoethyl)-2,5-dioxoimidazolidin-4-ylidene)methyl)benzoic acid (0.100 g, 0.298 mmol), glacial acetic acid (6 mL) and concentrated hydrochloric acid (3 mL) was refluxed for two hours. The reaction was concentrated in vacuo and the product washed with water and dried to afford the desired compound (0.078 g, 90%). δ_{H} (400 MHz, DMSO) 8.09-8.05 (m, 3H, ArH, CH), 7.78 (d, J 8.0, 2H, ArH), 4.41 (s, 2H, CH₂).

### Example 26—Synthesis of (Z)-2-(5-(4-Ethoxybenzylidene)-2,4-dioxothiazolidin-3-yl)acetic Acid

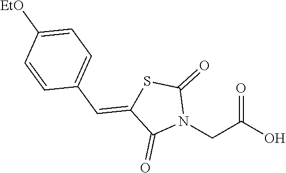 [SMILES: CCOc1ccc(/C=C2\SC(=O)N(CC(=O)O)C2=O)cc1]

### Step 1—Synthesis of Ethyl (Z)-2-(5-(4-ethoxybenzylidene)-2,4-dioxothiazolidin-3-yl)acetate

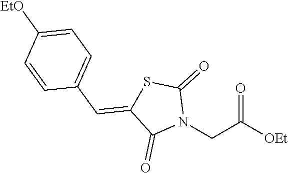 [SMILES: CCOC(=O)CN1C(=O)S/C(=C\c2ccc(OCC)cc2)C1=O]

To a solution of 4-ethoxybenzaldehyde (0.137 mL, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.230 g, 70%). δ_{H} (400 MHz, CDCl₃) 7.89 (s, 1H, CH), 7.47 (d, J 8.0, 2H, ArH), 6.98 (d, J 8.0, 2H ArH), 4.47 (s, 2H, CH₂), 4.24 (q, J 16.0, 8.0, 2H, CH₂), 4.10 (q, J 16.0, 8.0, 2H, CH₂), 1.45 (t, J 8.0, 3H, CH₃), 1.29 (t, J 8.0, 3H, CH₃).

### Step 2—Synthesis of (Z)-2-(5-(4-Ethoxybenzylidene)-2,4-dioxothiazolidin-3-yl)acetic Acid

A mixture of ethyl (Z)-2-(5-(4-ethoxybenzylidene)-2,4-dioxothiazolidin-3-yl)acetate (0.120 g, 0.358 mmol) in glacial acetic acid (6 mL) and concentrated hydrochloric acid (3 mL) was refluxed for two hours. The reaction was concentrated in vacuo and the product washed with water and dried to afford the desired compound (0.099 g, 90%). δ_{H} (400 MHz, DMSO) 7.95 (s, 1H, CH), 7.61 (d, J 8.0, 2H, ArH), 7.10 (d, J 8.0, 2H, ArH), 4.37 (s, 2H, CH₂), 4.11 (q, J 12.0, 4.0, 2H, CH₂). 1.35 (t, J 8.0, 3H, CH₃).

### Example 27—Synthesis of (Z)-2-(2,4-Dioxo-5-(4-(trifluoromethoxy)benzylidene)thiazolidin-3-yl)acetic Acid

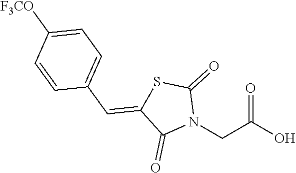 [SMILES: O=C(O)CN1C(=O)S/C(=C\c2ccc(OC(F)(F)F)cc2)C1=O]

### Step 1—Synthesis of Ethyl (Z)-2-(2,4-dioxo-5-(4-(trifluoromethoxy)benzylidene)thiazolidin-3-yl)acetate

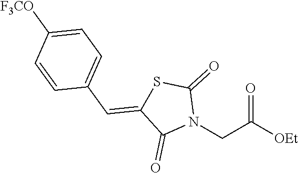 [SMILES: CCOC(=O)CN1C(=O)S/C(=C\c2ccc(OC(F)(F)F)cc2)C1=O]

To a solution of 4-(trifluoromethoxy)benzaldehyde (0.187 g, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.168 g, 46%). δ_{H} (400 MHz, CDCl₃) 7.90 (s, 1H, CH), 7.55 (d, J 8.0, 2H, ArH), 7.33 (d, J 8.0, 2H, ArH), 4.48 (s, 2H, CH₂), 4.24 (q, J 16.0, 8.0, 2H, CH₂), 1.29 (t, J 8.0, 3H, CH₃).

### Step 2—Synthesis of (Z)-2-(2,4-Dioxo-5-(4-(trifluoromethoxy)benzylidene)thiazolidin-3-yl)acetic Acid

A mixture of ethyl (Z)-2-(2,4-dioxo-5-(4-(trifluoromethoxy)benzylidene) thiazolidin-3-yl)acetate (0.100 g, 0.266 mmol), glacial acetic acid (6 mL) and concentrated hydrochloric acid (3 mL) was refluxed for two hours. The reaction was concentrated in vacuo and the product washed with water and dried to afford the desired compound (0.080 g, 86%). δ_{H} (400 MHz, DMSO) 8.05 (s, 1H, CH), 7.81 (d, J 8.0, 2H, ArH), 7.56 (d, J 8.0, 2H, ArH), 4.39 (s, 2H, CH₂).

### Example 28—Synthesis of (Z)-2-(5-(4-(Methylthio)benzylidene)-2,4-dioxothiazolidin-3-yl)acetic Acid

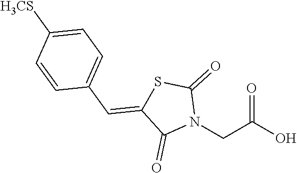

### Step 1—Synthesis of Ethyl (Z)-2-(5-(4-(methylthio)benzylidene)-2,4-dioxothiazolidin-3-yl)acetate

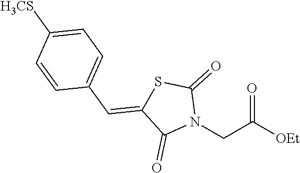

To a solution of 4-(methylthio)benzaldehyde (0.150 g, 0.984 mmol) and A (0.200 g, 0.984 mmol) in toluene (5 mL), three drops piperidine and two drops acetic acid were added.

The reaction was heated under reflux for 18 hours then concentrated in vacuo. The crude solid was washed with small amounts of methanol and collected via vacuum filtration to afford the desired compound (0.160 g, 48%). δ_{H} (400 MHz, CDCl₃) 7.87 (s, 1H, CH), 7.41 (d, J 8.0, 2H, ArH), 7.30 (d, J 8.0, 2H, ArH), 4.47 (s, 2H, CH₂), 4.24 (q, J 12.0, 8.0, 2H, CH₂), 1.29 (t, J 8.0, 3H, CH₃).

### Step 2—Synthesis of (Z)-2-(5-(4-(Methylthio)benzylidene)-2,4-dioxothiazolidin-3-yl)acetic Acid

A mixture of ethyl (Z)-2-(5-(4-(methylthio)benzylidene)-2,4-dioxothiazolidin-3-yl)acetate (0.120 g, 0.356 mmol), glacial acetic acid (6 mL) and concentrated hydrochloric acid (3 mL) was refluxed for two hours. The reaction was concentrated in vacuo and the product washed with water and dried to afford the desired compound (0.094 g, 86%). δ_{H} (400 MHz, DMSO) 7.94 (s, 1H, CH), 7.57 (d, J 8.0, 2H, ArH), 7.40 (d, J 8.0, 2H, ArH), 4.38 (s, 2H, CH₂), 2.53 (s, 3H, CH₃).

### Example 29—Synthesis of (Z)-2-(2,4-Dioxo-5-(4-(trifluoromethyl)benzylidene)thiazolidin-3-yl)acetic Acid

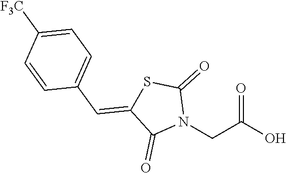 [SMILES: O=C(O)CN1C(=O)S/C(=C\c2ccc(C(F)(F)F)cc2)C1=O]

### Step 1—Synthesis of Ethyl (Z)-2-(2,4-dioxo-5-(4-(trifluoromethyl)benzylidene)thiazolidin-3-yl)acetate

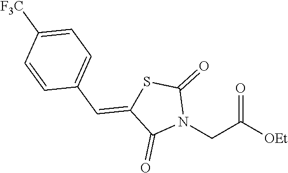 [SMILES: CCOC(=O)CN1C(=O)S/C(=C\c2ccc(C(F)(F)F)cc2)C1=O]

To a solution of 4-(trifluoromethyl)benzaldehyde (0.171 g, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.159 g, 45%). δ_{H} (400 MHz, CDCl₃) 7.94 (s, 1H, CH), 7.74 (d, J 8.0, 2H, ArH), 7.62 (d, J 8.0, 2H, ArH), 4.49 (s, 2H, CH₂), 4.25 (q, J 16.0, 8.0, 2H, CH₂), 1.30 (t, J 8.0, 3H, CH₃).

### Step 2—Synthesis of (Z)-2-(2,4-Dioxo-5-(4-(trifluoromethyl)benzylidene)thiazolidin-3-yl)acetic Acid

A mixture of ethyl (Z)-2-(2,4-dioxo-5-(4-(trifluoromethyl)benzylidene) thiazolidin-3-yl)acetate (0.120 g, 0.334 mmol), glacial acetic acid (6 mL) and concentrated hydrochloric acid (3 mL) was refluxed for two hours. The reaction was concentrated in vacuo and the product washed with water and dried to afford the desired compound (0.094 g, 85%). δ_{H} (400 MHz, DMSO) 8.08 (s, 1H, CH), 7.90 (d, J 8.0, 2H, ArH), 7.86 (d, J 8.0, 2H, ArH), 4.41 (s, 2H, CH₂).

### Example 30—Synthesis of (Z)-2-(2,4-Dioxo-5-(thiophen-2-ylmethylene)thiazolidin-3-yl)acetic Acid

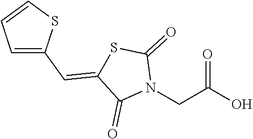 [SMILES: O=C(O)CN1C(=O)S/C(=C\c2cccs2)C1=O]

### Step 1—Synthesis of Ethyl (Z)-2-(2,4-dioxo-5-(thiophen-2-ylmethylene)thiazolidin-3-yl)acetate

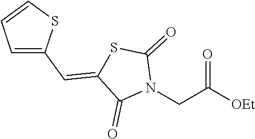 [SMILES: CCOC(=O)CN1C(=O)S/C(=C\c2cccs2)C1=O]

To a solution of 2-thiophenecarboxaldehyde (0.092 mL, 0.984 mmol) and A (0.200 g, 0.984 mmol) in toluene (5 mL), three drops piperidine and two drops acetic acid were added.

The reaction was heated under reflux for 18 hours then concentrated in vacuo. The crude solid was washed with small amounts of methanol and collected via vacuum filtration to afford the desired compound (0.119 g, 41%). δ_{H} (400 MHz, CDCl₃) 8.10 (s, 1H, CH), 7.68 (d, J 5.0, 1H, ArH), 7.42 (d, J 3.75, 1H, ArH), 7.20 (dd, J 5.0, 3.75, 1H, ArH), 4.47 (s, 2H, CH₂), 4.24 (q, J 16.0, 8.0, 2H, CH₂), 1.29 (t, J 8.0, 3H, CH₃).

### Step 2—Synthesis of (Z)-2-(2,4-Dioxo-5-(thiophen-2-ylmethylene)thiazolidin-3-yl)acetic Acid

A mixture of ethyl (Z)-2-(2,4-dioxo-5-(thiophen-2-ylmethylene)thiazolidin-3-yl)acetate (0.080 g, 0.269 mmol), glacial acetic acid (6 mL) and concentrated hydrochloric acid (3 mL) was refluxed for two hours. The reaction was concentrated in vacuo and the product washed with water and dried to afford the desired compound (64.6 mg, 89%). δ_{H} (400 MHz, DMSO) 8.28 (s, 1H, CH), 8.08 (d, J 5.0, 1H, ArH), 7.77 (d, J 3.75, 1H, ArH), 7.33 (dd, J 5.0, 3.75, 1H, ArH), 4.38 (s, 2H, CH₂).

### Example 31—Synthesis of (Z)-2-(2,4-Dioxo-5-(thiophen-2-ylmethylene)thiazolidin-3-yl)acetic Acid

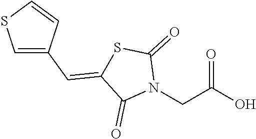 [SMILES: O=C(O)CN1C(=O)S/C(=C\c2ccsc2)C1=O]

### Step 1—Synthesis of Ethyl (Z)-2-(2,4-dioxo-5-(thiophen-3-ylmethylene)thiazolidin-3-yl)acetate

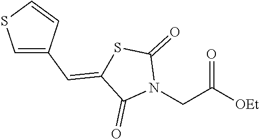 [SMILES: CCOC(=O)CN1C(=O)S/C(=C\c2ccsc2)C1=O]

To a solution of 3-thiophenecarboxaldehyde (0.110 g, 0.984 mmol) and 1 (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.182 g, 62%). δ_{H} (400 MHz, CDCl₃) 7.94 (s, 1H, CH), 7.65 (s, 1H, ArH), 7.46 (d, J 8.0, 1H, ArH), 7.31 (d, J 8.0, 1H, ArH), 4.47 (s, 2H, CH₂), 4.25 (q, J 12.0, 8.0, 2H, CH₂), 1.30 (t, J 8.0, 3H, CH₃).

### Step 2—Synthesis of (Z)-2-(2,4-Dioxo-5-(thiophen-3-ylmethylene)thiazolidin-3-yl)acetic Acid

A mixture of ethyl (Z)-2-(2,4-dioxo-5-(thiophen-3-ylmethylene)thiazolidin-3-yl)acetate (0.150 g, 0.439 mmol), glacial acetic acid (6 mL) and concentrated hydrochloric acid (3 mL) was refluxed for two hours. The reaction was concentrated in vacuo and the product washed with water and dried to afford the desired compound (0.117 g, 86%). δ_{H} (400 MHz, DMSO) 8.14 (s, 1H, ArH), 8.03 (s, 1H, CH), 7.79 (d, J 8.0, 1H, ArH), 7.45 (d, J 8.0, 1H, ArH), 4.38 (s, 2H, CH₂).

### Example 32—Synthesis of (Z)-2-(5-((1H-Imidazol-4-yl)methylene)-2,4-dioxothiazolidin-3-yl)acetic Acid

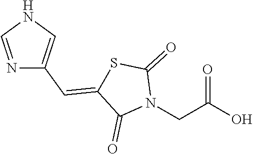 [SMILES: O=C(O)CN1C(=O)S/C(=C\c2c[nH]cn2)C1=O]

### Step 1—Synthesis of Ethyl (Z)-2-(5-((1H-imidazol-4-yl)methylene)-2,4-dioxothiazolidin-3-yl)acetate

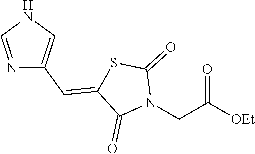 [SMILES: CCOC(=O)CN1C(=O)S/C(=C\c2c[nH]cn2)C1=O]

To a solution of 4-imidazolecarboxaldehyde (0.095 g, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.108 g, 39%). δ_{H} (400 MHz, CDCl₃) 7.71 (s, 1H, CH), 7.57 (s, 1H, ArH), 7.36 (s, 1H, ArH), 4.47 (s, 2H, CH₂), 4.27 (q, J 12.0, 8.0, 2H, CH₂), 1.32 (t, J 8.0, 3H, CH₃).

### Step 2—Synthesis of (Z)-2-(5-((1H-Imidazol-4-yl)methylene)-2,4-dioxothiazolidin-3-yl)acetic Acid

A mixture of ethyl (Z)-2-(5-((1H-imidazol-4-yl)methylene)-2,4-dioxothiazolidin-3-yl)acetate (0.080 g, 0.284 mmol), glacial acetic acid (6 mL) and concentrated hydrochloric acid (3 mL) was refluxed for two hours. The reaction was concentrated in vacuo and the product washed with water and dried to afford the desired compound (0.037 g, 51%). δ_{H} (400 MHz, DMSO) 8.52 (s, 1H, ArH), 7.94 (s, 1H, ArH), 7.86 (s, 1H, CH), 4.35 (s, 2H, CH₂).

### Example 33—Synthesis of (Z)-2-(5-(4-(Dimethylamino)benzylidene)-2,4-dioxothiazolidin-3-yl)acetic Acid

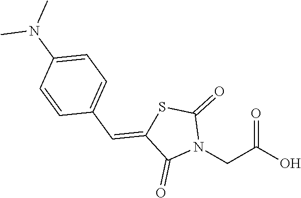 [SMILES: CN(C)c1ccc(/C=C2\SC(=O)N(CC(=O)O)C2=O)cc1]

### Step 1—Synthesis of Ethyl (Z)-2-(5-(4-(dimethylamino)benzylidene)-2,4-dioxothiazolidin-3-yl)acetate

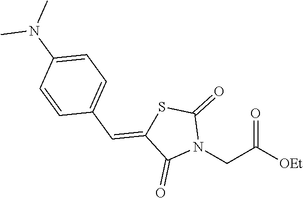 [SMILES: CCOC(=O)CN1C(=O)S/C(=C\c2ccc(N(C)C)cc2)C1=O]

To a solution of 4-(dimethylamino)benzaldehyde (0.147 g, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.267 g, 81%). δ_{H} (500 MHz, CDCl₃) 7.85 (s, 1H, CH), 7.40 (d, J 8.0, 2H, ArH), 6.72 (d, J 8.0, 2H, ArH), 4.46 (s, 2H, CH₂), 4.23 (q, J 12.0, 8.0, 2H, CH₂), 3.06 (s, 6H, CH₃ ×2), 1.28 (t, J 8.0, 3H, CH₃).

### Step 2—Synthesis of (Z)-2-(5-(4-(Dimethylamino)benzylidene)-2,4-dioxothiazolidin-3-yl)acetic Acid

A mixture of ethyl (Z)-2-(5-(4-(dimethylamino)benzylidene)-2,4-dioxothiazolidin-3-yl)acetate (0.150 g, 0.449 mmol), glacial acetic acid (6 mL) and concentrated hydrochloric acid (3 mL) was refluxed for two hours. The reaction was concentrated in vacuo and the product washed with water and dried to afford the desired compound (0.110 g, 74%). δ_{H} (500 MHz, DMSO) 7.82 (s, 1H, CH), 7.46 (d, J 10.0, 2H, ArH), 6.82 (d, J 10.0, 2H, ArH), 4.35 (s, 2H, CH₂), 3.02 (s, 6H, CH₃ ×2).

### Example 34—Synthesis of (Z)-2-(2,4-Dioxo-5-(pyridin-2-ylmethylene)thiazolidin-3-yl)acetic Acid

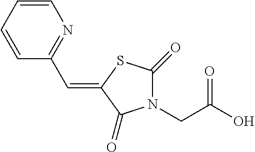 [SMILES: O=C(O)CN1C(=O)S/C(=C\c2ccccn2)C1=O]

### Step 1—Synthesis of Ethyl (Z)-2-(2,4-dioxo-5-(pyridin-2-ylmethylene)thiazolidin-3-yl)acetate

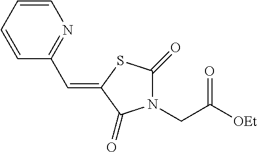 [SMILES: CCOC(=O)CN1C(=O)S/C(=C\c2ccccn2)C1=O]

To a solution of 2-pyridinecarboxaldehyde (0.094 mL, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.274 g, 71%). δ_{H} (400 MHz, CDCl₃) 8.76 (d, J 4.0, 1H, ArH), 7.83 (s, 1H, CH), 7.77 (dd app t, J 8.0, 1H, ArH), 7.51 (d, J 8.0, 1 H, ArH), 7.28 (dd app t, J 6.0, 1 H, ArH), 4.47 (s, 2H, CH₂), 4.23 (q, J 16.0, 8.0, 2H, CH₂), 1.28 (t, J 8.0, 3H, CH₃).

### Step 2—Synthesis of (Z)-2-(2,4-Dioxo-5-(pyridin-2-ylmethylene)thiazolidin-3-yl)acetic Acid

A mixture of ethyl (Z)-2-(2,4-dioxo-5-(pyridin-2-ylmethylene)thiazolidin-3-yl)acetate (0.150 g, 0.513 mmol), glacial acetic acid (6 mL) and concentrated hydrochloric acid (3 mL) was refluxed for two hours. The reaction was concentrated in vacuo and the product washed with water and dried to afford the desired compound (0.106 g, 78%). δ_{H} (400 MHz, DMSO) 8.78 (d, J 4.0, 1H, ArH), 8.02 (s, 1H, CH), 7.97 (dd app t, J 8.0, 1 H, ArH), 7.92 (d, J 8.0, 1 H, ArH), 7.46 (dd app t, J 6.0, 1H, ArH), 4.37 (s, 2H, CH₂).

### Example 35—Synthesis of (Z)-2-(2,4-Dioxo-5-(pyridin-3-ylmethylene)thiazolidin-3-yl)acetic Acid

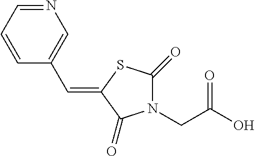 [SMILES: O=C(O)CN1C(=O)S/C(=C\c2cccnc2)C1=O]

### Step 1—Synthesis of Ethyl (Z)-2-(2,4-dioxo-5-(pyridin-3-ylmethylene)thiazolidin-3-yl)acetate

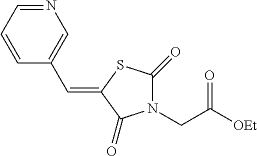 [SMILES: CCOC(=O)CN1C(=O)S/C(=C\c2cccnc2)C1=O]

To a solution of 3-pyridinecarboxaldehyde (0.093 mL, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.195 g, 68%). δ_{H} (500 MHz, CDCl₃) 8.82 (s, 1H, ArH), 8.68 (d, J 10.0, 1H, ArH), 7.94 (s, 1H, CH), 7.85 (d, J 10.0, 1 H, ArH), 7.47 (dd, J 10.0, 5.0, 1H, ArH), 4.52 (s, 2H, CH₂), 4.28 (q, J 15.0, 10.0, 2H, CH₂), 1.33 (t, J 10.0, 3H, CH₃).

### Step 2—Synthesis of (Z)-2-(2,4-Dioxo-5-(pyridin-3-ylmethylene)thiazolidin-3-yl)acetic Acid

A mixture of ethyl (Z)-2-(2,4-dioxo-5-(pyridin-3-ylmethylene)thiazolidin-3-yl)acetate (0.200 g, 0.684 mmol), glacial acetic acid (10 mL) and concentrated hydrochloric acid (5 mL) was refluxed for two hours. The reaction was concentrated in vacuo and the product washed with water and dried to afford the desired compound (0.103 g, 54%). δ_{H} (400 MHz, DMSO) 8.89 (s, 1H, ArH), 8.67 (d, J 8.0, 1H, ArH), 8.05 (s, 1H, CH), 8.03 (d, J 8.0, 1H, ArH), 7.60 (dd, J 8.0, 4.0, 1H, ArH), 4.41 (s, 2H, CH₂).

### Example 36—Synthesis of (Z)-2-(2,4-Dioxo-5-(pyridin-4-ylmethylene)thiazolidin-3-yl)acetic Acid

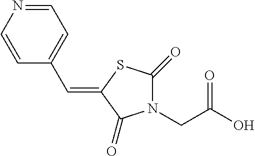 [SMILES: O=C(O)CN1C(=O)S/C(=C\c2ccncc2)C1=O]

### Step 1—Synthesis of Ethyl (Z)-2-(2,4-dioxo-5-(pyridin-4-ylmethylene)thiazolidin-3-yl)acetate

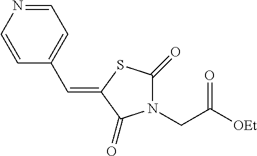 [SMILES: CCOC(=O)CN1C(=O)S/C(=C\c2ccncc2)C1=O]

To a solution of 4-pyridinecarboxaldehyde (0.093 mL, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was purified by column chromatography (silica; 30:70 ethyl acetate/hexanes elution) to afford the desired compound (0.155 g, 54%). δ_{H} (400 MHz, CDCl₃) 8.76 (d, J 4.0, 2H, ArH), 7.83 (s, 1H, CH), 7.36 (d, J 8.0, 2H, ArH), 4.48 (s, 2H, CH₂), 4.25 (q, J 16.0, 8.0, 2H, CH₂), 1.30 (t, J 8.0, 3H, CH₃).

### Step 2—Synthesis of (Z)-2-(2,4-Dioxo-5-(pyridin-4-ylmethylene)thiazolidin-3-yl)acetic Acid

A mixture of ethyl (Z)-2-(2,4-dioxo-5-(pyridin-4-ylmethylene)thiazolidin-3-yl)acetate (0.050 g, 0.171 mmol), glacial acetic acid (6 mL) and concentrated hydrochloric acid (3 mL) was refluxed for two hours. The reaction was concentrated in vacuo and the product washed with water and dried to afford the desired compound (0.025 g, 56%). δ_{H} (400 MHz, DMSO) 8.76 (d, J 8.0, 2H, ArH), 7.99 (s, 1H, CH), 7.60 (d, J 6.0, 2H, ArH), 4.41 (s, 2H, CH₂).

### Example 37—Synthesis of (Z)-2-(5-((6-Methoxypyridin-3-yl)methylene)-2,4-dioxothiazolidin-3-yl)acetic Acid

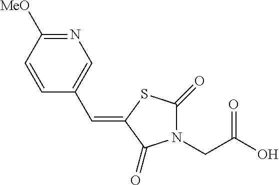 [SMILES: COc1ccc(/C=C2\SC(=O)N(CC(=O)O)C2=O)cn1]

A mixture of 6-methoxy-3-pyridinecarboxaldehyde (0.157 g, 1.14 mmol), C (0.200 g, 1.14 mmol) and piperidine (0.090 mL, 0.913 mmol) in dry ethanol (8 mL) was heated under reflux overnight under nitrogen. After three days, the reaction was poured onto water and acidified with acetic acid to give the desired compound, collected via vacuum filtration (0.175 g, 65%). δ_{H} (400 MHz, DMSO) 8.57 (s, 1H, ArH), 8.01 (s, 1H, CH), 7.95 (d app dd, J 8.0, 4.0, 1 H, ArH), 7.02 (d, J 8.0, 1 H, ArH), 4.38 (s, 2H, CH₂), 3.96 (s, 3H, CH₃).

### Example 38—Synthesis of (Z)-2-(5-(Naphthalen-1-ylmethylene)-2,4-dioxothiazolidin-3-yl)acetic Acid

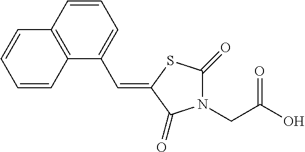 [SMILES: O=C(O)CN1C(=O)S/C(=C\c2cccc3ccccc23)C1=O]

### Step 1—Synthesis of Ethyl (Z)-2-(5-(naphthalen-1-ylmethylene)-2,4-dioxothiazolidin-3-yl)acetate

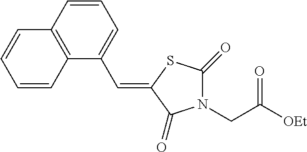 [SMILES: CCOC(=O)CN1C(=O)S/C(=C\c2cccc3ccccc23)C1=O]

To a solution of α-naphthaldehyde (0.134 g, 0.984 mmol) and A (0.200 g, 0.984 mmol) in toluene (5 mL), three drops piperidine and two drops acetic acid were added. The reaction was heated under reflux for 18 hours then concentrated in vacuo. The crude solid was purified by column chromatography (silica; 20:80 ethyl acetate/hexanes elution) to afford the desired compound (0.210 g, 48%). δ_{H} (400 MHz, CDCl₃) 8.67 (s, 1H, ArH), 8.10 (d, J 8.0, 1H, ArH), 7.95-7.90 (m, 2H, ArH), 7.68 (d, J 8.0, 1H, ArH), 7.64-7.54 (m, 3H, ArH), 4.52 (s, 2H, CH₂), 4.27 (q, J 12.0, 8.0, 2H, CH₂), 1.32 (t, J 8.0, 3H, CH₃).

### Step 2—Synthesis of (Z)-2-(5-(Naphthalen-1-ylmethylene)-2,4-dioxothiazolidin-3-yl)acetic Acid

A mixture of ethyl (Z)-2-(5-(naphthalen-1-ylmethylene)-2,4-dioxothiazolidin-3-yl)acetate (0.100 g, 0.293 mmol), glacial acetic acid (6 mL) and concentrated hydrochloric acid (3 mL) was refluxed for two hours. The reaction was concentrated in vacuo and the product washed with water and dried to afford the desired compound (0.085 g, 93%). δ_{H} (400 MHz, DMSO) 8.63 (s, 1H, CH), 8.14 (d, J 8.0, 1H, ArH), 8.11 (d, J 8.0, 1H, ArH), 8.06 (d, J 8.0, 1H, ArH), 7.75 (d, J 8.0, 1H, ArH), 7.71-7.63 (m, 3H, ArH), 4.42 (s, 2H, CH₂).

### Example 39—Synthesis of (Z)-2-(5-(Naphthalen-2-ylmethylene)-2,4-dioxothiazolidin-3-yl)acetic Acid

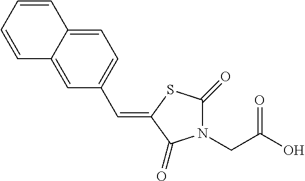 [SMILES: O=C(O)CN1C(=O)S/C(=C\c2ccc3ccccc3c2)C1=O]

### Step 1—Synthesis of Ethyl (Z)-2-(5-(naphthalen-2-ylmethylene)-2,4-dioxothiazolidin-3-yl)acetate

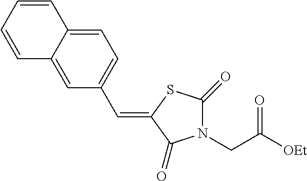 [SMILES: CCOC(=O)CN1C(=O)S/C(=C\c2ccc3ccccc3c2)C1=O]

To a solution of β-naphthaldehyde (0.308 g, 1.97 mmol) and 1 (0.400 g, 1.97 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.314 g, 50%). δ_{H} (400 MHz, CDCl₃) 8.08 (s, 1H, CH), 8.00 (s, 1H ArH), 7.92-7.85 (m, 4H, ArH), 7.59-7.55 (m, 3H, ArH), 4.50 (s, 2H, CH₂), 4.26 (q, J 16.0, 8.0, 2H, CH₂), 1.31 (t, J 8.0, 3H, CH₃).

### Step 2—Synthesis of (Z)-2-(5-(Naphthalen-2-ylmethylene)-2,4-dioxothiazolidin-3-yl)acetic Acid

A mixture of ethyl (Z)-2-(5-(naphthalen-2-ylmethylene)-2,4-dioxothiazolidin-3-yl)acetate (0.150 g, 0.440 mmol) in glacial acetic acid (6 mL) and concentrated hydrochloric acid (3 mL) was refluxed for two hours. The reaction was concentrated in vacuo and the product washed with water and dried to afford the desired compound (0.125 g, 90%). δ_{H} (400 MHz, DMSO) 8.25 (s, 1H, CH), 8.31 (s, 1H, ArH), 8.08-8.05 (m, 2H, ArH), 7.98 (d, J 8.0, 1H, ArH), 7.72 (dd, J 8.0, 4.0, 1 H, ArH), 7.67-7.60 (m, 2H, ArH), 4.42 (s, 2H, CH₂).

### Example 40—Synthesis of 2-(2,4-Dioxo-5-(quinolin-2-ylmethylene)thiazolidin-3-yl)acetic Acid

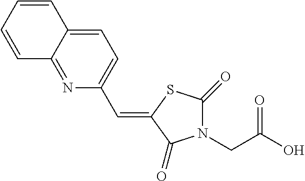 [SMILES: O=C(O)CN1C(=O)S/C(=C\c2ccc3ccccc3n2)C1=O]

### Step 1—Synthesis of Ethyl 2-(2,4-dioxo-5-(quinolin-2-ylmethylene)thiazolidin-3-yl)acetate

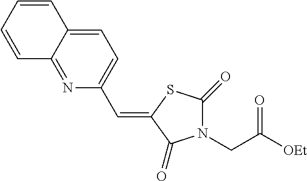 [SMILES: CCOC(=O)CN1C(=O)S/C(=C\c2ccc3ccccc3n2)C1=O]

To a solution of ethyl 2-(2,4-dioxothiazolidin-3-yl)acetate (0.250 g, 1.23 mmol) and 2-quinolinecarboxaldehyde (0.193 g, 1.227 mmol) in toluene (6 mL), three drops piperidine and two drops acetic acid were added. The reaction was heated under reflux overnight then concentrated in vacuo. The crude residue was washed with small amounts of methanol and collected via vacuum filtration to afford the desired compound (94.2 mg, 22%). δ_{H} (400 MHz, CDCl₃) 8.22 (t, J 8.0, 2H, ArH), 7.98 (s, 1H, CH), 7.84 (d, J 8.0, 1H, ArH), 7.79 (t, J 8.0, 1H, ArH), 7.62-7.58 (m, 2H, ArH), 4.51 (s, 2H, CH₂), 4.25 (q, J 16.0, 8.0, 2H, CH₂), 1.30 (t, J 8.0, 3H, CH₃).

### Step 2—Synthesis of 2-(2,4-Dioxo-5-(quinolin-2-ylmethylene)thiazolidin-3-yl)acetic Acid

A mixture of ethyl 2-(2,4-dioxo-5-(quinolin-2-ylmethylene)thiazolidin-3-yl)acetate (0.0497 g, 0.145 mmol), glacial acetic acid (6 mL) and concentrated hydrochloric acid (3 mL) was refluxed for two hours. The reaction was concentrated in vacuo and the product washed with water and dried to afford the desired compound (0.0361 g, 79%). δ_{H} (400 MHz, DMSO) 8.52 (d, J 8.0, 1H, ArH), 8.17 (s, 1H, CH), 8.15 (d, J 8.0, 1H, ArH), 8.04 (d, J 8.0, 1H, ArH), 8.00 (d, J 8.0, 1H, ArH), 7.86 (t, J 8.0, 1H, ArH), 7.70 (t, J 8.0, 1H, ArH), 4.41 (s, 2H, CH₂).

### Example 41—Synthesis of Z)-2-(5-(4-(Benzyloxy)benzylidene)-2,4-dioxothiazolidin-3-yl)acetic Acid

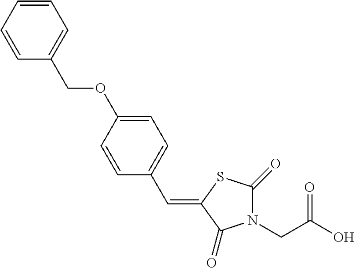 [SMILES: O=C(O)CN1C(=O)S/C(=C\c2ccc(OCc3ccccc3)cc2)C1=O]

A mixture of 4-(benzyloxy)benzaldehyde (0.121 g, 0.571 mmol), 3 (0.100 g, 0.571 mmol) and piperidine (0.045 mL, 0.457 mmol) in ethanol (6 mL) was heated under reflux overnight. The reaction was poured onto water and acidified with acetic acid to give a yellow precipitate which was collected via vacuum filtration. The solid were recrystallised from methanol to afford the desired compound (0.056 g, 27%). δ_{H} (400 MHz, DMSO) 7.96 (s, 1H, ArH), 7.63 (d, J 8.0, 2H, ArH), 7.47 (d, J 8.0, 2H, ArH), 7.41 (dd, J 8.0, 4.0, 2H, ArH), 7.35 (t, J 8.0, 1H, ArH), 7.21 (d, J 8.0, 2H, ArH), 5.21 (s, 2H, CH₂), 4.38 (s, 2H, CH₂).

### Example 42—Synthesis of (Z)-2-(4-(4-Methoxybenzylidene)-2,5-dioxoimidazolidin-1-yl)acetic Acid

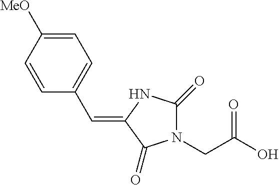 [SMILES: COc1ccc(/C=C2\NC(=O)N(CC(=O)O)C2=O)cc1]

### Step 1—Synthesis of Ethyl 2-(2,5-dioxoimidazolidin-1-yl)acetate

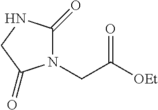 [SMILES: CCOC(=O)CN1C(=O)CNC1=O]

To a stirring suspension of hydantoin (1.00 g, 9.99 mmol) and potassium carbonate (2.76 g, 20.0 mmol) in dry acetonitrile (100 mL), ethyl bromoacetate (1.22 mL, 11.0 mmol) was added dropwise under nitrogen. After two days of stirring at room temperature, the reaction was concentrated in vacuo and the residue partitioned between ethyl acetate (50 mL) and water (50 mL) and the aqueous phase extracted with ethyl acetate (3×50 mL). The organic phase was dried (MgSO₄) and concentrated. The crude product was subjected to column chromatography (silica; 30:50 ethyl acetate/hexanes elution) to afford the desired compound (0.556 g, 30%). δ_{H} (400 MHz, CDCl₃) 6.24 (br s, 1H, NH), 4.25 (s, 2H, CH₂), 4.22 (q, J 16.0, 8.0, 2H, CH₂), 4.06 (s, 2H, CH₂), 1.28 (t, J 8.0, 3H, CH₃).

### Step 2—Synthesis of Ethyl (Z)-2-(4-(4-methoxybenzylidene)-2,5-dioxoimidazolidin-1-yl)acetate

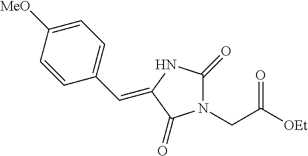 [SMILES: CCOC(=O)CN1C(=O)N/C(=C\c2ccc(OC)cc2)C1=O]

To a solution of ethyl 2-(2,5-dioxoimidazolidin-1-yl)acetate (0.150 mg, 0.804 mmol) and 4-methoxybenzaldehyde (0.098 mL, 0.804 mmol) in ethanol (5 mL), piperidine (0.199 mL, 20.1 mmol) was added and the reaction heated under reflux for four days. Upon cooling, a yellow solid crystallised and was collected via vacuum filtration and washed with cool ethanol to afford the desired compound (0.065 mg, 27%). δ_{H} (400 MHz, CDCl₃) 8.00 (br s, 1H, NH), 7.38 (d, J 8.0, 2H, ArH), 6.96 (d, J 8.0, 2H, ArH), 6.77 (s, 1H, CH), 4.37 (s, 2H, CH₂), 4.24 (q, J 12.0, 8.0, 2H, CH₂), 3.86 (s, 3H, CH₃), 1.29 (t, J 8.0, 3H, CH₃).

### Step 3—Synthesis of (Z)-2-(4-(4-Methoxybenzylidene)-2,5-dioxoimidazolidin-1-yl)acetic Acid

A mixture ethyl (Z)-2-(4-(4-methoxybenzylidene)-2,5-dioxoimidazolidin-1-yl)acetate (0.070 g, 0.230 mmol), glacial acetic acid (4 mL) and concentrated hydrochloric acid (2 mL) was refluxed for two hours. The reaction was concentrated in vacuo and the product washed with water and dried to afford the desired compound (0.051 g, 79%). δ_{H} (400 MHz, DMSO) 10.81 (s, 1H, NH), 7.64 (d, J 8.0, 2H, ArH), 7.00 (d, J 8.0, 2H, ArH), 6.58 (s, 1H, CH), 4.20 (s, 2H, CH₂), 3.81 (s, 3H, CH₃).

### Example 43—Synthesis of (Z)-2-(5-(4-Methoxybenzylidene)-4-oxo-2-thioxothiazolidin-3-yl)acetic Acid

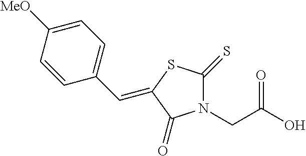 [SMILES: COc1ccc(/C=C2\SC(=S)N(CC(=O)O)C2=O)cc1]

### Step 1—Synthesis of Ethyl 2-(4-oxo-2-thioxothiazolidin-3-yl)acetate

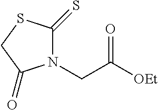 [SMILES: CCOC(=O)CN1C(=O)CSC1=S]

A mixture of glycine ethyl ester hydrochloride (0.250 g, 1.79 mmol) and bis(carboxymethyl)trithiocarbonate (0.405 g, 1.79 mmol) in a mixed solvent of isopropanol (8 mL) and triethylamine (0.8 mL) was heated under reflux for one hour. The reaction had turned a deep red colour and was concentrated in vacuo and the residue was purified by column chromatography (silica; 30:70 ethyl acetate/hexanes elution increasing to 50:50) to afford the desired compound (0.262 g, 67%). δ_{H} (400 MHz, CDCl₃) 4.70 (s, 2H, CH₂), 4.21 (q, J 16.0, 8.0, 2H, CH₂), 4.07 (s, 2H, CH₂), 1.27 (t, J 8.0, 3H, CH₃).

### Step 2—Synthesis of Ethyl (Z)-2-(5-(4-methoxybenzylidene)-4-oxo-2-thioxothiazolidin-3-yl)acetate

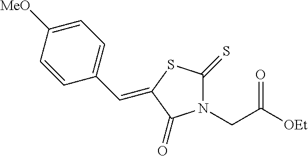 [SMILES: CCOC(=O)CN1C(=O)/C(=C/c2ccc(OC)cc2)SC1=S]

To a solution of 4-methoxybenzaldehyde (0.124 g, 0.912 mmol) and ethyl 2-(4-oxo-2-thioxothiazolidin-3-yl)acetate (0.200 g, 0.912 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.213 g, 69%). δ_{H} (400 MHz, CDCl₃) 7.73 (s, 1H, CH), 7.47 (d, J 5.0, 2H, ArH), 7.00 (s, J 5.0, 2H, ArH), 4.85 (s, 2H, CH₂), 4.23 (q, J 10.0, 5.0, 2H, CH₂), 3.87 (s, 3H, CH₃), 1.28 (t, J 7.5, 3H, CH₃).

### Step 3—Synthesis of (Z)-2-(5-(4-Methoxybenzylidene)-4-oxo-2-thioxothiazolidin-3-yl)acetic Acid

A mixture of ethyl (Z)-2-(5-(4-methoxybenzylidene)-4-oxo-2-thioxothiazolidin-3-yl)acetate (0.150 g, 0.445 mmol), glacial acetic acid (6 mL) and concentrated hydrochloric acid (3 mL) was refluxed for two hours. The reaction was concentrated in vacuo and the product washed with water and dried to afford the desired compound (0.137 g, 99%). δ_{H} (400 MHz, DMSO) 7.84 (s, 1H, CH), 7.64 (d, J 8.0, 2H, ArH), 7.13 (d, J 8.0, 2H, ArH), 4.71 (s, 2H, CH₂), 3.85 (s, 3H, CH₃).

### Example 44—Synthesis of (Z)-2-(4-(4-Methoxybenzylidene)-5-oxo-2-thioxoimidazolidin-1-yl)acetic Acid

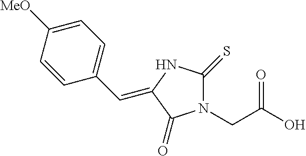 [SMILES: COc1ccc(/C=C2\NC(=S)N(CC(=O)O)C2=O)cc1]

### Step 1—Synthesis of Ethyl 2-(5-oxo-2-thioxoimidazolidin-1-yl)acetate

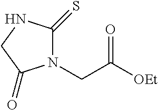 [SMILES: CCOC(=O)CN1C(=O)CNC1=S]

Ethyl isocyanoacetate (0.201 mL, 1.79 mmol) was added to a stirring mixture of glycine ethyl ester hydrochloride (0.250 g, 1.79 mmol) and triethylamine (0.7 mL, 5.02 mmol) in acetonitrile (7 mL). The reaction was allowed to stir for 15 minutes then the solvent was removed in vacuo. The crude product was subjected to column chromatography (silica; 50:50 ethyl acetate/hexanes elution) to afford the desired compound (0.275 g, 76%). δ_{H} (400 MHz, CDCl₃) 4.57 (s, 2H, CH₂), 4.26-4.21 (m, 4H, CH₂×2), 1.30 (t, J 8.0, 3H, CH₃).

### Step 2—Synthesis of Ethyl (Z)-2-(4-(4-methoxybenzylidene)-5-oxo-2-thioxoimidazolidin-1-yl)acetate

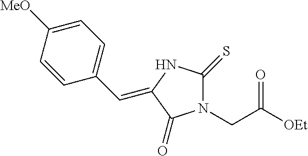 [SMILES: CCOC(=O)CN1C(=O)/C(=C/c2ccc(OC)cc2)NC1=S]

To a solution of 4-methoxybenzaldehyde (0.066 mL, 0.544 mmol) and ethyl 2-(5-oxo-2-thioxoimidazolidin-1-yl)acetate (0.110 g, 0.544 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.079 g, 48%). δ_{H} (400 MHz, CDCl₃) 8.45 (s, 1H, NH), 7.40 (d, J 8.0, 2H, ArH), 6.98 (d, J 8.0, 2H, ArH), 6.76 (s, 1H, CH), 4.66 (s, 2H, CH₂), 4.24 (q, J 12.0, 8.0, 2H, CH₂), 3.86 (s, 3H, CH₃), 1.29 (t, J 8.0, 3H, CH₃).

### Step 3—Synthesis of (Z)-2-(4-(4-Methoxybenzylidene)-5-oxo-2-thioxoimidazolidin-1-yl)acetic Acid

A mixture of ethyl (Z)-2-(4-(4-methoxybenzylidene)-5-oxo-2-thioxoimidazolidin-1-yl)acetate (0.060 g, 0.197 mmol), glacial acetic acid (5 mL) and concentrated hydrochloric acid (2.5 mL) was refluxed for two hours. The reaction was concentrated in vacuo and the product washed with water and dried to afford the desired compound (0.049 g, 85%). δ_{H} (400 MHz, CDCl₃) 12.47 (s, 1H, NH), 7.80 (d, J 8.0, 2H, ArH), 7.02 (d, J 8.0, 2H, ArH), 6.73 (s, 1H, CH), 4.50 (s, 2H, CH₂), 3.83 (s, 3H, CH₃).

### Example 45—Synthesis of (Z)-5-(4-Methoxybenzylidene)thiazolidine-2,4-dione

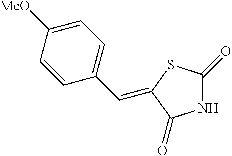 [SMILES: COc1ccc(/C=C2\SC(=O)NC2=O)cc1]

A mixture of 2,4-thiazolididione (0.500 g, 4.27 mmol), 4-methoxybenzaldehyde (0.519 mL, 4.27 mmol) and sodium acetate (1.40 g, 17.0 mmol) in acetic acid (8 mL) was set to heat under reflux overnight. After 16 hours, the reaction was cooled to room temperature and poured onto ice. The precipitate was collected via vacuum filtration and washed with water to afford the desired compound (0.502 g, 30%). δ_{H} (400 MHz, DMSO) 7.72 (s, 1H, CH), 7.55 (d, J 8.0, 2H, ArH), 7.09 (d, J 8.0, 2H, ArH), 3.82 (s, 3H, CH₃).

### Example 46—Synthesis of (Z)-5-(4-Methoxybenzylidene)-2-thioxothiazolidin-4-one

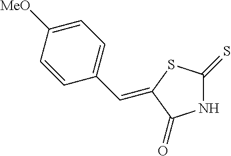 [SMILES: COc1ccc(/C=C2\SC(=S)NC2=O)cc1]

A mixture of rhodanine (0.500 g, 3.75 mmol), 4-methoxybenzaldehyde (0.457 mL, 3.75 mmol) and sodium acetate (1.23 g, 15.0 mmol) in acetic acid (8 mL) was set to heat under reflux overnight. After 16 hours, the reaction was cooled to room temperature and poured onto ice. The precipitate was collected via vacuum filtration and washed with water. The crude product was recrystallised from ethanol to afford the desired compound (0.745 g, 79%). δ_{H} (400 MHz, DMSO) 7.60 (s, 1H, CH), 7.58 (d, J 8.0, 2H, ArH), 7.12 (d, J 8.0, 2H, ArH), 3.84 (s, 3H, CH₃).

### Example 47—Synthesis of (Z)-5-(4-Methoxybenzylidene)-2-thioxoimidazolidin-4-one

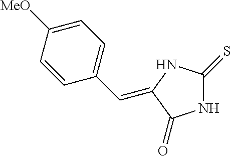 [SMILES: COc1ccc(/C=C2\NC(=S)NC2=O)cc1]

A mixture of thiohydantoin (0.500 g, 4.31 mmol), 4-methoxybenzaldehyde (0.524 mL, 4.31 mmol) and sodium acetate (1.41 g, 17.2 mmol) in acetic acid (8 mL) was set to heat under reflux overnight. After 16 hours, the reaction was cooled to room temperature and poured onto ice. The precipitate was collected via vacuum filtration and washed with water to afford the desired compound (0.602 g, 60%). δ_{H} (400 MHz, DMSO) 12.30 (br s, 1H, NH), 12.07 (br s, 1H, NH), 7.74 (d, J 8.0, 2H, ArH), 6.99 (d, J 8.0, 2H, ArH), 6.47 (s, 1H, CH), 3.82 (s, 3H, CH₃).

### Example 48—Synthesis of (Z)-2-Imino-5-(4-methoxybenzylidene)thiazolidin-4-one

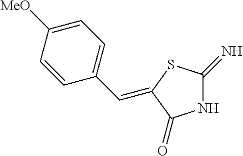 [SMILES: COc1ccc(/C=C2\SC(=N)NC2=O)cc1]

A mixture of pseudothiohydantoin (0.500 g, 4.31 mmol), 4-methoxybenzaldehyde (0.524 mL, 4.31 mmol) and sodium acetate (1.41 g, 17.2 mmol) in acetic acid (8 mL) was set to heat under reflux overnight. After 16 hours, the reaction was cooled to room temperature and poured onto ice. The precipitate was collected via vacuum filtration and washed with water. The crude product was recrystallised from ethanol to afford the desired compound (0.843 g, 84%). δ_{H} (400 MHz, DMSO) 9.35 (br s, 1H, NH), 9.10 (br s, 1H, NH), 7.57 (s, 1H, CH), 7.54 (d, J 8.0, 2H, ArH), 7.09 (d, J 8.0, 2H, ArH), 3.83 (s, 3H, CH₃).

### Example 49—Synthesis of (Z)-3-((1H-Tetrazol-5-yl)methyl)-5-(4-methoxybenzylidene)thiazolidine-2,4-dione

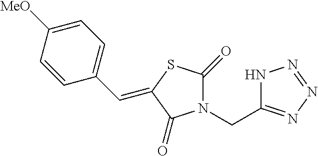 [SMILES: COc1ccc(/C=C2\SC(=O)N(Cc3nnn[nH]3)C2=O)cc1]

### Step 1—Synthesis of (Z)-2-(5-(4-Methoxybenzylidene)-2,4-dioxothiazolidin-3-yl)acetamide

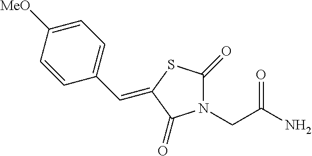 [SMILES: COc1ccc(/C=C2\SC(=O)N(CC(N)=O)C2=O)cc1]

A mixture of (Z)-2-(5-(4-methoxybenzylidene)-2,4-dioxothiazolidin-3-yl)acetic acid (0.200 g, 0.682 mmol) and phosphorus pentachloride (0.144 g, 0.682 mmol) in dichloromethane (15 mL) was heated under reflux for 30 minutes. The reaction was cooled to room temperature and ammonia gas (produced by heating ammonium hydroxide solution to 50° C.) was bubbled through. After several minutes, a white solid precipitated out of solution and the ammonia gas was allowed to bubble though for a further 5 minutes. The dichloromethane was removed under reduced pressure and the solids washed with water (50 mL) and collected via vacuum filtration to afford the desired compound (0.177 g, 88%). δ_{H} (400 MHz, DMSO) 7.92 (s, 1H, CH), 7.73 (br s, 1H, NH), 7.63 (d, J 8.0, 2H, ArH), 7.32 (br s, 1H, NH), 7.13 (d, J 8.0, 2H, ArH), 4.23 (s, 2H, CH₂), 3.84 (s, 3H, CH₃).

### Step 2—Synthesis of (Z)-2-(5-(4-Methoxybenzylidene)-2,4-dioxothiazolidin-3-yl)acetonitrile

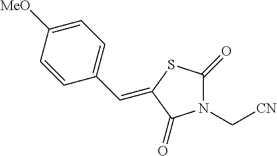 [SMILES: COc1ccc(/C=C2\SC(=O)N(CC#N)C2=O)cc1]

A mixture of (Z)-2-(5-(4-methoxybenzylidene)-2,4-dioxothiazolidin-3-yl)acetamide (0.100 g, mmol) in phosphorus oxychloride was heated under reflux for two hours. The reaction was cooled to room temperature and partitioned between dichloromethane (10 mL) and water (30 mL). The two phases were separated and the aqueous phase further extracted with dichloromethane (10 mL×2). The combined organic phases were then back washed with 1M sodium hydroxide solution, dried (MgSO₄) and concentrated in vacuo to afford a pale cream solid that was recrystallised form ethanol to afford the desired compound (0.057 g, 61%). δ_{H} (400 MHz, CDCl₃) 7.95 (s, 1H, CH), 7.48 (d, J 8.0, 2H, ArH), 7.01 (d, J 8.0, 2H, ArH), 4.61 (s, 2H, CH₂), 3.88 (s, 3H, CH₃).

### Step 3—Synthesis of (Z)-3-((1H-Tetrazol-5-yl)methyl)-5-(4-methoxybenzylidene)thiazolidine-2,4-dione

(Z)-2-(5-(4-Methoxybenzylidene)-2,4-dioxothiazolidin-3-yl)acetonitrile (0.050 g, 0.182 mmol), sodium azide (0.036 g, 0.182 mmol) and triethylammonium chloride (0.075 g, 0.547 mmol) were suspended in dry toluene (4 mL) in an atmosphere of nitrogen. The suspension was stirred under reflux for two days with monitoring via HPLC. The reaction was cooled to room temperature and water was added. A precipitate was collected via vacuum filtration and the filtrate further acidified with concentrated hydrochloric acid and precipitates collected via vacuum filtration to afford the desired compound as a white solid (0.033 g, 57%). δ_{H} (400 MHz, MeOD) 7.93 (s, 1H, CH), 7.56 (d, J 8.0, 2H, ArH), 7.08 (d, J 8.0, 2H, ArH), 5.24 (s, 2H, CH₂), 3.87 (s, 3H, CH₃).

### Example 50—Synthesis of (Z)-3-(5-(4-Methoxybenzylidene)-2,4-dioxothiazolidin-3-yl)propanoic Acid

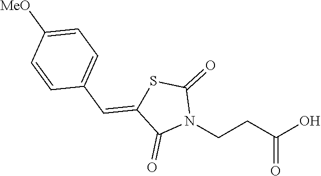 [SMILES: COc1ccc(/C=C2\SC(=O)N(CCC(=O)O)C2=O)cc1]

### Step 1—Synthesis of Ethyl 3-(2,4-dioxothiazolidin-3-yl)propanoate

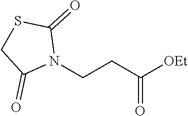 [SMILES: CCOC(=O)CCN1C(=O)CSC1=O]

A solution of ethyl 3-chloropropionate (0.250 mL, 1.84 mmol) and 2,4-thiazolididone (0.430 g, 3.67 mmol) in dry DMF (8 mL) was heated at 90° C. under nitrogen for two hours. One equivalent of potassium phosphate dibasic (0.320 g, 1.84 mmol) was added and the reaction continued to heat at 90° C. for a further two hours. One equivalent of potassium hydrogen carbonate (0.184 g, 1.84 mmol) was added and the reaction was heated at 90° C. for 30 mins then allowed to stir at room temperature overnight. The reaction was concentrated in vacuo and the residue partitioned between ethyl acetate (20 mL) and water (20 mL) then extracted with ethyl acetate (3×20 mL). The combined organic phases were washed with water (2×20 mL) then brine (1×20 mL) then dried (MgSO₄) and concentrated in vacuo. The crude product was purified via column chromatography (silica; 30:70 ethyl acetate/hexanes elution) to afford the desired compound (0.125 g, 37%). δ_{H} (400 MHz, CDCl₃) 4.12 (q, J 14.0, 8.0, 2H, CH₂), 3.95 (s, 2H, CH₂), 3.92 (t, J 8.0, 2H, CH₂), 2.63 (t, J 8.0, 2H, CH₂), 1.25 (t, J 8.0, 3H, CH₃).

### Step 2—Synthesis of Ethyl (Z)-3-(5-(4-methoxybenzylidene)-2,4-dioxothiazolidin-3-yl)propanoate

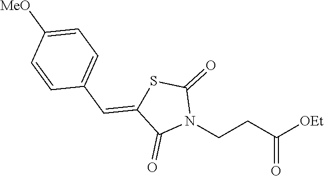 [SMILES: CCOC(=O)CCN1C(=O)S/C(=C\c2ccc(OC)cc2)C1=O]

To a solution of 4-methoxybenzaldehyde (0.076 mL, 0.575 mmol) and ethyl 3-(2,4-dioxothiazolidin-3-yl)propanoate (0.125 g, 0.575 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.122 g, 63%). δ_{H} (400 MHz, CDCl₃) 7.85 (s, 1H, CH), 7.46 (d, J 8.0, 2H, ArH), 6.99 (d, J 8.0, 2H, ArH), 4.14 (q, J 16.0, 8.0, 2H, CH₂), 4.04 (t, J 8.0, 2H, CH₂), 3.89 (s, 3H, CH₃), 1.25 (t, J 8.0, 3H, CH₃).

### Step 3—Synthesis of (Z)-3-(5-(4-Methoxybenzylidene)-2,4-dioxothiazolidin-3-yl)propanoic Acid

A mixture of ethyl (Z)-3-(5-(4-methoxybenzylidene)-2,4-dioxothiazolidin-3-yl)propanoate (0.085 g, 0.253 mmol) in glacial acetic acid (6 mL) and concentrated hydrochloric acid (3 mL) was refluxed for two hours. The reaction was concentrated in vacuo and the product washed with water and dried to afford the desired compound (0.060 g, 77%). δ_{H} (400 MHz, DMSO) 7.89 (s, 1H, CH), 7.60 (d, J 8.0, 2H, ArH), 7.13 (d, J 8.0, 2H, ArH), 3.86 (t, J 8.0, 2H, CH₂), 3.84 (s, 3H, CH₃), 2.59 (t, J 8.0, 2H, CH₂).

### Example 51—Synthesis of (Z)-4-(5-(4-Methoxybenzylidene)-2,4-dioxothiazolidin-3-yl)butanoic Acid

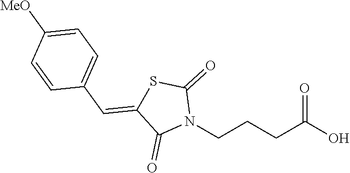 [SMILES: COc1ccc(/C=C2\SC(=O)N(CCCC(=O)O)C2=O)cc1]

### Step 1—Synthesis of Ethyl 4-(2,4-dioxothiazolidin-3-yl)butanoate

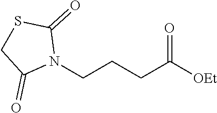 [SMILES: CCOC(=O)CCCN1C(=O)CSC1=O]

A suspension of 2,4-thiazolididione (0.250 g, 2.13 mmol), ethyl 4-bromobutyrate (0.623 mL, 2.35 mmol) and potassium carbonate (0.590 g, 4.27 mmol) in dry acetonitrile (60 mL) was set to stir at room temp overnight under nitrogen. The next day a further 0.2 equivalents of 2,4-thiazolididione (50 mg) was added and the reaction was allowed to stir at room temperature overnight. The reaction was concentrated in vacuo and partitioned between ethyl acetate (30 mL) and water (30 mL) and extracted with ethyl acetate (3×30 mL). The combined organic layers were then dried (MgSO₄) and concentrated in vacuo. The crude product was purified by column chromatography (silica; 30:70 ethyl acetate/hexanes elution) to afford the desired compound (0.385 g, 78%). δ_{H} (400 MHz, CDCl₃) 4.13 (q, J 16.0, 8.0, 2H, CH₂), 3.94 (s, 2H, CH₂), 3.69 (t, J 8.0, 2H, CH₂), 2.33 (t, J 8.0, 2H, CH₂), 1.94 (quin, J 8.0, 2H, CH₂) 1.26 (t, J 8.0, 3H, CH₃).

### Step 2—Synthesis of Ethyl (Z)-4-(5-(4-methoxybenzylidene)-2,4-dioxothiazolidin-3-yl)butanoate

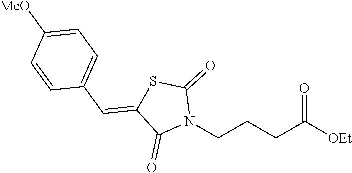 [SMILES: CCOC(=O)CCCN1C(=O)S/C(=C\c2ccc(OC)cc2)C1=O]

To a solution of 4-methoxybenzaldehyde (0.115 mL, 0.865 mmol) and ethyl 4-(2,4-dioxothiazolidin-3-yl)butanoate (0.200 g, 0.865 mmol) in toluene (5 mL), three drops piperidine and two drops acetic acid were added. The reaction was heated under reflux for 18 hours then concentrated in vacuo. The crude solid was washed with small amounts of methanol and collected via vacuum filtration to afford the desired compound (0.227 g, 75%). δ_{H} (400 MHz, CDCl₃) 7.85 (s, 1H, CH), 7.46 (d, J 8.0, 2H, ArH), 6.99 (d, J 8.0, 2H, ArH), 4.13 (q, J 12.0, 8.0, 2H, CH₂), 3.87 (s, 3H, CH₃), 3.81 (t, J 8.0, 2H, CH₂), 2.36 (t, J 8.0, 2H, CH₂), 2.01 (quin, J 8.0, 2H, CH₂), 1.25 (t, J 8.0, 3H, CH₃).

### Step 3—Synthesis of (Z)-4-(5-(4-Methoxybenzylidene)-2,4-dioxothiazolidin-3-yl)butanoic Acid

A mixture of ethyl (Z)-4-(5-(4-methoxybenzylidene)-2,4-dioxothiazolidin-3-yl)butanoate (0.150 g, 0.429 mmol) in glacial acetic acid (6 mL) and concentrated hydrochloric acid (3 mL) was refluxed for two hours. The reaction was concentrated in vacuo and the product washed with water and dried to afford the desired compound (0.122 g, 88%). δ_{H} (400 MHz, DMSO) 12.12 (br s, 1H, COOH), 7.87 (s, 1H, CH), 7.59 (d, J 8.0, 2H, ArH), 7.11 (d, J 8.0, 2H, ArH), 3.84 (s, 3H, CH₃), 3.39 (t, J 8.0, 2H, CH₂), 2.27 (t, J 8.0, 2H, CH₂), 1.81 (quin, J 8.0, 2H, CH₂).

### Example 52—Synthesis of (Z)-2-(4-(4-Methoxybenzylidene)-5-oxo-2 thioxo imidazolidin-1-yl) acetic Acid

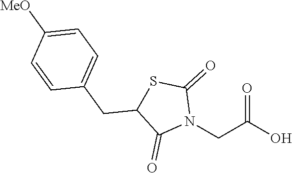 [SMILES: COc1ccc(CC2SC(=O)N(CC(=O)O)C2=O)cc1]

A 12.5 mM solution of (Z)-2-(5-(4-methoxybenzylidene)-2,4-dioxothiazolidin-3-yl)acetic acid in 75:25 methanol:dichloromethane was reduced using a ThalesNano H-Cube Pro™ hydrogenator through a 10% Pd/C catalyst bed with a flow rate of 0.3 mL/min at 16 bar, 40° C. The resulting solution was concentrated in vacuo to yield the crude product which was recrystallised from ethanol to afford the desired compound (0.021 g, 70%). δ_{H} (400 MHz, MeOD) 7.20 (d, J 8.0, 2H, ArH), 6.89 (d, J 8.0, 2H, ArH), 4.74 (dd, J 12.0, 4.0, 1H, CH), 4.18 (s, 2H, CH₂), 3.79 (s, 3H, CH₃), 3.50 (dd, J 16.0, 4.0, 1 H, CH₂), 3.08 (dd, J 12.0, 8.0, 1 H, CH₂).

### Example 53—Synthesis of (Z)-2-(5-(4-(Benzyloxy)-3-chlorobenzylidene)-2,4-dioxothiazolidin-3-yl)acetic Acid

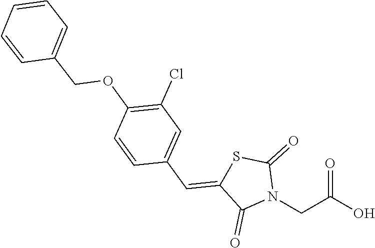 [SMILES: O=C(O)CN1C(=O)S/C(=C\c2ccc(OCc3ccccc3)c(Cl)c2)C1=O]

### Step 1—Synthesis of 4-(Benzyloxy)-3-chlorobenzaldehyde

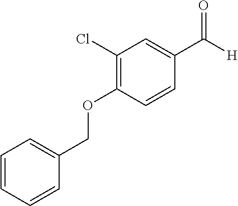 [SMILES: O=Cc1ccc(OCc2ccccc2)c(Cl)c1]

3-Chloro-4-hydroxybenzaldehyde (300 mg, 1.9 mmol), potassium carbonate (873 mg, 6.3 mmol) and 1-(bromomethyl)-2-chlorobenzene (1.811 g, 8.8 mmol) were refluxed in dry acetonitrile under atmospheric nitrogen overnight. The solution was allowed to cool, separated between ethyl acetate and brine, and the combined organic phases dried with magnesium sulfate. The product was concentrated, purified by flash chromatography (silica; 10:90 ethyl acetate/hexanes elution) and recrystallised in ethanol to afford a white solid (145 mg, 35%). δ_{H} (400 MHz, CDCl₃) 9.76 (s, 1H, H), 7.85 (d, J 2.04, 1H, ArH), 7.65 (dd, J 8.0, 1H, ArH), 7.32 (m, 5H, ArH), 7.0 (d, J 8.0, 1H, ArH), 5.17 (s, 2H, CH₂).

### Step 2—Synthesis of Z)-2-(5-(4-(Benzyloxy)-3-chlorobenzylidene)-2,4-dioxothiazolidin-3-yl)acetic Acid

A mixture of 4-(benzyloxy)-3-chlorobenzaldehyde (0.121 g, 0.571 mmol), 3 (0.100 g, 0.571 mmol) and piperidine (0.045 mL, 0.457 mmol) in ethanol (6 mL) was heated under reflux for three days. The reaction was poured onto water and acidified with acetic acid to give a yellow precipitate which was collected via vacuum filtration. The solid were recrystallised from methanol to afford the desired compound (22 mg, 20%). δ_{H} (400 MHz, MeOD) 7.94 (s, 1H CH), 7.81 (d, J 2.16, 1H, ArH), 7.60 (dd, J 11.04, 1H ArH), 7.43 (m, 6H, ArH), 5.32 (s, 2H, CH₂), 4.31 (s, 2H, CH₂).

### Example 54—Synthesis of (Z)-2-(5-(4-((4-Methoxybenzyl)oxy)benzylidene)-2,4-dioxothiazolidin-3-yl)acetic Acid

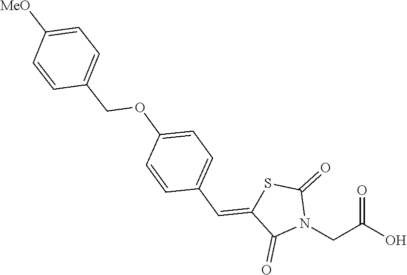 [SMILES: COc1ccc(COc2ccc(/C=C3\SC(=O)N(CC(=O)O)C3=O)cc2)cc1]

### Step 1—Synthesis of 4-((4-Methoxybenzyl)oxy)benzaldehyde

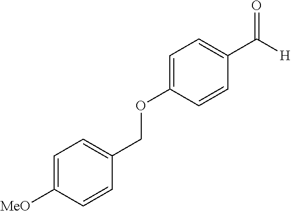 [SMILES: COc1ccc(COc2ccc(C=O)cc2)cc1]

4-Methoxybenzyl bromide (250 mg, 1.2 mmol), potassium carbonate (187 mg, 1.3 mmol) and 4-hydroxybenzaldehyde (138 mg, 1.13 mmol) were stirred at 80° C. for three hours. The solution was allowed to cool, poured into ethyl acetate (40 mL), and the organic layer was washed with water (15 mL) and brine (15 mL), then dried over Na₂SO₄ and concentrated in vacuo to remove solvents. The crude product was purified by flash column chromatography (silica; 10-15% ethyl acetate/hexanes) to afford the desired compound (104 mg, 35%). δ_{H} (400 MHz, CDCl₃) 9.88 (s, 1H, H), 7.83 (d, J 8.0, 2H, ArH), 7.35 (d, J 8.0, 2H, ArH), 7.06 (d, 2H, ArH), 7.6.92 (d, J 8.0, 2H, ArH), 5.07 (s, 2H, CH₂), 3.82 (s, 3H, CH₃).

### Step 2—Synthesis of (Z)-2-(5-(4-((4-Methoxybenzyl)oxy)benzylidene)-2,4-dioxothiazolidin-3-yl)acetic Acid

A mixture of 4-(benzyloxy)-3-chlorobenzaldehyde (0.121 g, 0.571 mmol), 3 (0.100 g, 0.571 mmol) and piperidine (0.045 mL, 0.457 mmol) in ethanol (6 mL) was heated under reflux for three days. The reaction was poured onto water and acidified with acetic acid to give a yellow precipitate which was collected via vacuum filtration. The crude solid was recrystallised from methanol to afford the desired compound (15 mg, 13%). δ_{H} (400 MHz, MeOD) 7.88 (s, 1H CH), 7.54 (d, J 8.0, 2H, ArH), 7.36 (d, J 8.0, 2H, ArH), 7.14 (d, J 8.0, 2H, ArH), 6.93 (d, J 12.0, 2H, ArH), 5.08 (s, 2H, CH₂), 4.43 (s, 2H, CH₂), 3.79 (s, 3H, CH₃).

### Example 55—Synthesis of (Z)-2-(2,4-Dioxo-5-((6-oxo-1,6-dihydropyridin-3-yl)methylene)thiazolidin-3-yl)acetic Acid

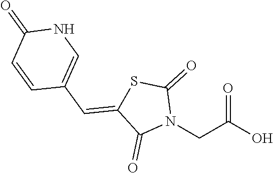 [SMILES: O=C(O)CN1C(=O)S/C(=C\c2ccc(=O)[nH]c2)C1=O]

A mixture of ethyl (Z)-2-(5-((6-methoxypyridin-3-yl)methylene)-2,4-dioxothiazolidin-3-yl)acetate (0.150 g, 0.465 mmol), glacial acetic acid (6 mL) and concentrated hydrochloric acid (3 mL) was refluxed for two hours. The reaction was concentrated in vacuo and the product washed with water and dried to afford the desired compound (0.100 g, 77%). δ_{H} (400 MHz, DMSO) 12.3 (br s, 1H, NH), 8.07 (s, 1H, ArH), 7.85 (s, 1H, CH), 7.66 (d app dd, J 12.0, 4.0, 1 H, ArH), 6.50 (d, J 12.0, 1H, ArH), 4.36 (s, 2H, CH₂).

### Example 56—DHDPS Inhibition

The compounds of the invention as discussed above were tested to determine their ability to inhibit DHDPS.

### DHDPS-DHDPR Coupled Assay

DHDPS enzyme activity was determined using the coupled assay in a Cary 4000 UV/Vis spectrophotometer at 340 nm in 1 cm acrylic cuvettes. A master mix was prepared for each reaction as per Table 1. Reaction mixtures containing enzymes, pyruvate, buffer and NADPH were incubated at 30° C. for 12 mins before the addition of ASA to initiate the reaction. The oxidation of NADPH to NADP⁺ was then monitored at 340 nm at 30° C. as a function of time. The initial rate (ΔA₃₄₀·min⁻¹) was calculated from the slope of the linear portion of the A340 versus time profile. All experiments were carried out in triplicate. The enzyme kinetic parameters, including K_{M} values, were determined using the Michaelis-Menten equation (Equation 1). Unless otherwise stated, all kinetic data were fitted using the built-in equations in GraphPad Prism.

TABLE 1
Coupled assay master mix.

| | Volume | Final concentration |
|---|---|---|
| Reagent | (μL) | (mM) |
| HEPES (pH 8.0) | 400 | 250 |
| NADPH | 20 | 0.2 |
| Pyruvate | 8 | 1 |
| ASA | 10 | 0.125 |
| EcDHDPR | 20 | 0.0009 |
| AtDHDPS | 10 | 0.00008 |
| H₂O* | Up to 800 | — |
| Total | 800 | — |

*H₂O volume was varied according to experiment.
Note:
At = Arabidopsis thaliana and Ec = Escherichia coli.

V=Vₘₐₓ×[S]/(K_{M}+[S]) Equation 1

Where:

V=initial rate

Vmax=maximal enzyme velocity/activity

K_{M}=Michaelis-Menten constant

[S]=concentration of substrate being titrated

### Dose Response Inhibitor Assays

To determine/C50 values for the inhibitors, A. thaliana DHDPS enzyme activity was measured using the coupled assay (detailed above) in the presence of increasing concentrations of inhibitor. The initial rate was then plotted as a function of the log 10 of the inhibitor concentration and the/C50 determined according to Equation 2.

A=100/(1+10\hat{ }((log IC₅₀−[I])×S)) Equation 2

Where:

A=% activity

IC₅₀=concentration resulting in 50% inhibition

[I]=inhibitor concentration S=slope

The IC₅₀ values are given in Table 2.

TABLE 2
IC₅₀ values for selected compounds

| Compound | IC₅₀ values μM |
|---|---|
| 1 | 92.4 |
| 2 | 80.1 |
| 3 | 70.5 |
| 4 | 110.0 |
| 5 | 46.9 |
| 6 | 137 |
| 7 | 121 |
| 8 | 84.3 |
| 9 | 74.0 |
| 10 | 80.1 |
| 11 | 153 |
| 12 | 103 |
| 13 | 316 |
| 14 | 79.7 |
| 15 | 152 |
| 16 | 127 |
| 17 | 173 |
| 18 | 121 |
| 19 | 125 |
| 20 | 68.4 |
| 21 | 162 |
| 22 | 108 |
| 23 | 116 |
| 24 | 79.6 |
| 25 | 69.8 |
| 26 | 71.6 |
| 27 | 97.8 |
| 28 | 125 |
| 29 | 122 |
| 30 | 71.6 |
| 31 | 81.8 |
| 32 | 94 |
| 33 | >500 |
| 34 | 80.4 |
| 35 | 138 |
| 36 | 90.2 |
| 37 | 46 |
| 38 | 97.0 |
| 39 | 76.1 |
| 40 | 110 |
| 41 | 71.4 |
| 42 | 66.1 |
| 43 | 540 |
| 44 | 222 |
| 45 | 70.8 |
| 46 | >250 |
| 47 | 323 |
| 48 | 156 |
| 49 | 89.1 |
| 50 | >250 |
| 51 | 66.8 |
| 52 | >250 |

### Example 57—Antibacterial Activity of Compounds 1, 3 and 5

To determine whether DHDPS inhibitors were plant-specific, compounds 1, 3 and 5 were selected and tested against a panel of Gram-positive and Gram-negative bacteria.

Assays were carried out by a broth microdilution method using a 96-well plate according to guidelines defined by the European Committee on Antimicrobial Susceptibility Testing as described here. Overnight cultures of strains were grown in tryptic soy broth (TSB) at 37° C. The overnight cultures were diluted to a concentration of 1×10⁶ bacteria/ml (OD₆₀₀=0.01) in TSB media. To each well on 96 well plates, 100 μl of bacterially infected media at a concentration of 1×10⁶/ml and compounds at various concentrations were added. An uninfected control (i.e. no bacteria) was also included. The plates were incubated at 37° C. wrapped in parafilm for 20 hrs. The growth was assessed by measuring the absorbance at 600 nm. The minimum inhibitory concentration (MIC) was determined to be the lowest concentration of compound that inhibits visible bacterial growth.

The results for compound 1 are as follows:

TABLE 3
MIC of compound 1 against Gram-positive and Gram-negative bacteria.

| | MIC #1 | MIC #2 | MIC #3 |
|---|---|---|---|
| Bacterial species | (μg/ml) | (μg/ml) | (μg/ml) |
| Gram-negative species | | | |
| Escherichia coli NCTC12923 | >64 | >64 | >64 |
| Acinetobacter baumannii AYE | >64 | >64 | >64 |
| Acinetobacter baumannii 17978 | >64 | >64 | >64 |
| Klebsiella pneumoniae M6 | >64 | >64 | >64 |
| Klebsiella pneumoniae 13368 | >64 | >64 | >64 |
| Pseudomonas aeruginosa 13437 | >64 | >64 | >64 |
| Pseudomonas aeruginosa PA01 | >64 | >64 | >64 |
| Gram-positive species | | | |
| MSSA 9144 | >64 | >64 | >64 |
| EMRSA-15 | >64 | >64 | >64 |
| EMRSA-16 | >64 | >64 | >64 |
| Enterococcus faecalis 775 | >64 | >64 | >64 |
| Enterococcus faecalis 12201 | >64 | >64 | >64 |
| Enterococcus faecium 12204 | >64 | >64 | >64 |

As can be seen, compound 1 lacks antibacterial activity against both Gram-positive and Gram-negative bacterial species with MIC values greater than 64 μg/ml.

The results for compound 3 are as follows:

TABLE 4
MIC of compound 3 against Gram-positive and Gram-negative bacteria.

| | MIC #1 | MIC #2 | MIC #3 |
|---|---|---|---|
| Bacterial species | (μg/ml) | (μg/ml) | (μg/ml) |
| Gram-negative species | | | |
| Escherichia coli NCTC12923 | >64 | >64 | >64 |
| Acinetobacter baumannii AYE | >64 | >64 | >64 |
| Acinetobacter baumannii 17978 | >64 | >64 | >64 |
| Klebsiella pneumoniae M6 | >64 | >64 | >64 |
| Klebsiella pneumoniae 13368 | >64 | >64 | >64 |
| Pseudomonas aeruginosa 13437 | >64 | >64 | >64 |
| Pseudomonas aeruginosa PA01 | >64 | >64 | >64 |
| Gram-positive species | | | |
| MSSA 9144 | >64 | >64 | >64 |
| EMRSA-15 | >64 | >64 | >64 |
| EMRSA-16 | >64 | >64 | >64 |
| Enterococcus faecalis 775 | >64 | >64 | >64 |
| Enterococcus faecalis 12201 | >64 | >64 | >64 |
| Enterococcus faecium 12204 | >64 | >64 | >64 |

As can be seen, compound 3 lacks antibacterial activity against both Gram-positive and Gram-negative bacterial species with MIC values greater than 64 μg/ml.

The results for compound 5 are as follows:

TABLE 5
MIC of compound 5 against Gram-positive and Gram-negative bacteria.

| | MIC #1 | MIC #2 | MIC #3 |
|---|---|---|---|
| Bacterial species | (μg/ml) | (μg/ml) | (μg/ml) |
| Gram-negative species | | | |
| Escherichia coli NCTC12923 | >64 | >64 | >64 |
| Acinetobacter baumannii AYE | >64 | >64 | >64 |
| Acinetobacter baumannii 17978 | >64 | >64 | >64 |
| Klebsiella pneumoniae M6 | >64 | >64 | >64 |
| Klebsiella pneumoniae 13368 | >64 | >64 | >64 |
| Pseudomonas aeruginosa 13437 | >64 | >64 | >64 |
| Pseudomonas aeruginosa PA01 | >64 | >64 | >64 |
| Gram-positive species | | | |
| MSSA 9144 | >64 | >64 | >64 |
| EMRSA-15 | >64 | >64 | >64 |
| EMRSA-16 | >64 | >64 | >64 |
| Enterococcus faecalis 775 | >64 | >64 | >64 |
| Enterococcus faecalis 12201 | >64 | >64 | >64 |
| Enterococcus faecium 12204 | >64 | >64 | >64 |

As can be seen, compound 5 lacks antibacterial activity against both Gram-positive and Gram-negative bacterial species with MIC values greater than 64 μg/ml.

### Example 58—in Planta Effects of Compounds 3 and 5

Gamborg modified/Murashige Skoog (GM/MS) media and soil were prepared as according to Table 6.

TABLE 6
Plant growth Media.

| Growth Medium | Reagent | Amount |
|---|---|---|
| GM/MS agar* | MS salts + vitamins (Sigma M0404) | 4.4 g |
| | MES hydrate | 5 g |
| | Plant grade agar | 8 g |
| | H₂O | Up to 1 L |
| Soil | Post in vitro potting mix (Brute) | 3 parts |
| | Fine grade perlite | 1 part |
| | Fine grade vermiculite | 1 part |

*Note that GM/MS agar was adjusted to pH 5.7 by addition of 1M KOH.

A. thaliana seeds were sterilised including a 15 min wash step in 10% (v/v) commercial bleach without the addition of detergents. All plants were grown in a controlled environment room (CER) at 22±5° C. with 16 hrs: 8 hrs light: dark, 50-60% humidity under cool-white fluorescent light. Plants grown on soil were regularly watered and relocated within the CER.

To determine the effect of compounds 3 and 5 on A. thaliana seedling development, the compounds were diluted into GM/MS media to final concentrations of 15.6 μM, 31.3 μM, 62.5 μM, 125 μM, 250 μM, and 500 μM (at 1% (v/v) DMSO). Basta was employed as a positive control at a final recommended concentration of 10 μg/mL (50 μM). Negative controls included 0% (v/v) DMSO (H₂O) and 1% (v/v) DMSO (vehicle). Media was poured into 100 mL plates and allowed to set before adding 20 sterilised seeds per plate. Seeds were then stratified at 4° C. for 72 hrs in a dark room prior to relocation into a CER.

The resulting growth plates were monitored daily and allowed to grow in an upright position for up to 14 days post stratification to determine the average root length using ImageJ analysis. Experiments were carried out in triplicates. Results were statistically validated using t-tests employing GraphPad Prism. The results were as follows:

Relative to both the vehicle (DMSO) and negative (H₂O) controls, the effect of compounds 3 and 5 on the development and growth of A. thaliana was profound. This was exemplified by the lack of any chlorophyll containing leaves (lack of green) at the highest concentrations tested. Interestingly, at concentrations 125 μM and higher with both compounds 3 and 5, the seedlings did not develop past the point of hypocotyl formation (thin root), and produced no cotyledons (small leaves) or rosette leaves. This indicates that compounds 3 and 5 resulted in qualitative and quantitative effects on seedling development that is akin to those observed in Basta (glufosinate) (commercial herbicide) at the same concentration. Thus, compounds 3 and 5 exhibit several herbicide-like effects on A. thaliana seedlings.

The root lengths are summarised in Tables 7 and 8 below.

TABLE 7
A. thaliana root lengths in the presence of compound 3.

| | | Root Length | Normalised |
|---|---|---|---|
| Treatment | Plant # | (cm) | root |
| 500 μM | 1 | 0.046 | 1.374925276 |
| 500 μM | 2 | 0.056 | 1.673822075 |
| 500 μM | 3 | 0.037 | 1.105918157 |
| 500 μM | 4 | 0.046 | 1.374925276 |
| 500 μM | 5 | 0.092 | 2.749850552 |
| 500 μM | 6 | 0.136 | 4.064996468 |
| 500 μM | 7 | 0.056 | 1.673822075 |
| 500 μM | 8 | 0.055 | 1.643932395 |
| 500 μM | 9 | 0.044 | 1.315145916 |
| 500 μM | 10 | 0.078 | 2.331395033 |
| 500 μM | 11 | 0.025 | 0.747241998 |
| 500 μM | 12 | 0.078 | 2.331395033 |
| 500 μM | 13 | 0.076 | 2.271615673 |
| 500 μM | 14 | 0.069 | 2.062387914 |
| 500 μM | 15 | 0.036 | 1.076028477 |
| 500 μM | 16 | 0.048 | 1.434704636 |
| 500 μM | 17 | 0.088 | 2.630291832 |
| 500 μM | 18 | 0.07 | 2.092277594 |
| 500 μM | 19 | 0.053 | 1.584153035 |
| 500 μM | 20 | 0.168 | 5.021466225 |
| 250 μM | 1 | 0.614 | 18.35226346 |
| 250 μM | 2 | 1.172 | 35.03070485 |
| 250 μM | 3 | 0.647 | 19.3386229 |
| 250 μM | 4 | 0.259 | 7.741427096 |
| 250 μM | 5 | 0.111 | 3.31775447 |
| 250 μM | 6 | 0.425 | 12.70311396 |
| 250 μM | 7 | 0.102 | 3.048747351 |
| 250 μM | 8 | 0.252 | 7.532199337 |
| 250 μM | 9 | 0.914 | 27.31916744 |
| 250 μM | 10 | 0.588 | 17.57513179 |
| 250 μM | 11 | 0.465 | 13.89870116 |
| 250 μM | 12 | 0.131 | 3.915548068 |
| 250 μM | 13 | 0.332 | 9.92337373 |
| 250 μM | 14 | 0.27 | 8.070213575 |
| 250 μM | 15 | 0.188 | 5.619259823 |
| 250 μM | 16 | 0.117 | 3.497092549 |
| 250 μM | 17 | 0.151 | 4.513341666 |
| 250 μM | 18 | 0.089 | 2.660181512 |
| 250 μM | 19 | 0.113 | 3.37753383 |
| 250 μM | 20 | 0.123 | 3.676430629 |
| 125 μM | 1 | 1.106 | 33.05798598 |
| 125 μM | 2 | 2.339 | 69.91196131 |
| 125 μM | 3 | 0.655 | 19.57774034 |
| 125 μM | 4 | 0.745 | 22.26781153 |
| 125 μM | 5 | 0.127 | 3.795989348 |
| 125 μM | 6 | 2.074 | 61.99119613 |
| 125 μM | 7 | 0.287 | 8.578338134 |
| 125 μM | 8 | 0.784 | 23.43350905 |
| 125 μM | 9 | 1.391 | 41.57654475 |
| 125 μM | 10 | 1.55 | 46.32900386 |
| 125 μM | 11 | 0.604 | 18.05336666 |
| 125 μM | 12 | 0.427 | 12.76289332 |
| 125 μM | 13 | 0.252 | 7.532199337 |
| 125 μM | 14 | 0.041 | 1.225476876 |
| 125 μM | 15 | 0.423 | 12.6433346 |
| 125 μM | 16 | 0.132 | 3.945437748 |
| 125 μM | 17 | 0.709 | 21.19178306 |
| 125 μM | 18 | 0.499 | 14.91495027 |
| 125 μM | 19 | 0.298 | 8.907124613 |
| 125 μM | 20 | 0.068 | 2.032498234 |
| 62.5 μM | 1 | 2.152 | 64.32259116 |
| 62.5 μM | 2 | 2.757 | 82.40584751 |
| 62.5 μM | 3 | 2.339 | 69.91196131 |
| 62.5 μM | 4 | 2.773 | 82.88408239 |
| 62.5 μM | 5 | 2.157 | 64.47203956 |
| 62.5 μM | 6 | 1.165 | 34.82147709 |
| 62.5 μM | 7 | 2.65 | 79.20765176 |
| 62.5 μM | 8 | 2.693 | 80.49290799 |
| 62.5 μM | 9 | 2.619 | 78.28107168 |
| 62.5 μM | 10 | 2.12 | 63.36612141 |
| 62.5 μM | 11 | 1.939 | 57.95608934 |
| 62.5 μM | 12 | 1.533 | 45.8208793 |
| 62.5 μM | 13 | 0.535 | 15.99097875 |
| 62.5 μM | 14 | 1.711 | 51.14124232 |
| 62.5 μM | 15 | 0.67 | 20.02608554 |
| 62.5 μM | 16 | 1.092 | 32.63953046 |
| 62.5 μM | 17 | 0.826 | 24.6888756 |
| 62.5 μM | 18 | 1.503 | 44.9241889 |
| 62.5 μM | 19 | 2.154 | 64.38237052 |
| 62.5 μM | 20 | 1.48 | 44.23672626 |
| 31.3 μM | 1 | 0.129 | 3.855768708 |
| 31.3 μM | 2 | 2.321 | 69.37394707 |
| 31.3 μM | 3 | 4.305 | 128.675072 |
| 31.3 μM | 4 | 2.183 | 65.24917124 |
| 31.3 μM | 5 | 0.746 | 22.29770121 |
| 31.3 μM | 6 | 2.221 | 66.38497908 |
| 31.3 μM | 7 | 3.159 | 94.42149883 |
| 31.3 μM | 8 | 0.542 | 16.20020651 |
| 31.3 μM | 9 | 4.602 | 137.5523069 |
| 31.3 μM | 10 | 2.597 | 77.62349872 |
| 31.3 μM | 11 | 1.616 | 48.30172273 |
| 31.3 μM | 12 | 3.128 | 93.49491875 |
| 31.3 μM | 13 | 0.133 | 3.975327428 |
| 31.3 μM | 14 | 1.475 | 44.08727787 |
| 31.3 μM | 15 | 2.343 | 70.03152003 |
| 31.3 μM | 16 | 2.18 | 65.1595022 |
| 31.3 μM | 17 | 1.076 | 32.16129558 |
| 31.3 μM | 18 | 2.255 | 67.40122819 |
| 31.3 μM | 19 | 0.695 | 20.77332754 |
| 31.3 μM | 20 | 1.594 | 47.64414977 |
| 15.6 μM | 1 | 4.242 | 126.7920222 |
| 15.6 μM | 2 | 2.654 | 79.32721048 |
| 15.6 μM | 3 | 0.282 | 8.428889734 |
| 15.6 μM | 4 | 3.737 | 111.6977338 |
| 15.6 μM | 5 | 3.653 | 109.1870007 |
| 15.6 μM | 6 | 3.988 | 119.2000435 |
| 15.6 μM | 7 | 4.202 | 125.596435 |
| 15.6 μM | 8 | 4.361 | 130.3488941 |
| 15.6 μM | 9 | 3.42 | 102.2227053 |
| 15.6 μM | 10 | 3.494 | 104.4345416 |
| 15.6 μM | 11 | 2.5 | 74.72419977 |
| 15.6 μM | 12 | 2.921 | 87.30775501 |
| 15.6 μM | 13 | 2.601 | 77.74305744 |
| 15.6 μM | 14 | 2.424 | 72.4525841 |
| 15.6 μM | 15 | 4.28 | 127.92783 |
| 15.6 μM | 16 | 3.066 | 91.6417586 |
| 15.6 μM | 17 | 3.403 | 101.7145807 |
| 15.6 μM | 18 | 0.129 | 3.855768708 |
| 15.6 μM | 19 | 3.794 | 113.4014456 |
| 15.6 μM | 20 | 1.977 | 59.09189718 |

TABLE 8
A. thaliana root lengths in the presence of compound 5.

| | | Root Length | Normalised |
|---|---|---|---|
| Treatment | Plant # | (cm) | root |
| 500 μM | 1 | 0.062 | 1.853160154 |
| 500 μM | 2 | 0.033 | 0.986359437 |
| 500 μM | 3 | 0.04 | 1.195587196 |
| 500 μM | 4 | 0.032 | 0.956469757 |
| 500 μM | 5 | 0.027 | 0.807021358 |
| 500 μM | 6 | 0.032 | 0.956469757 |
| 500 μM | 7 | 0.02 | 0.597793598 |
| 500 μM | 8 | 0.091 | 2.719960872 |
| 500 μM | 9 | 0.032 | 0.956469757 |
| 500 μM | 10 | 0.014 | 0.418455519 |
| 500 μM | 11 | 0.014 | 0.418455519 |
| 500 μM | 12 | 0.025 | 0.747241998 |
| 500 μM | 13 | 0.031 | 0.926580077 |
| 500 μM | 14 | 0.032 | 0.956469757 |
| 500 μM | 15 | 0.008 | 0.239117439 |
| 500 μM | 16 | 0.012 | 0.358676159 |
| 500 μM | 17 | 0.029 | 0.866800717 |
| 500 μM | 18 | 0.046 | 1.374925276 |
| 500 μM | 19 | 0.044 | 1.315145916 |
| 500 μM | 20 | 0.112 | 3.34764415 |
| 250 μM | 1 | 0.101 | 3.018857671 |
| 250 μM | 2 | 0.129 | 3.855768708 |
| 250 μM | 3 | 0.088 | 2.630291832 |
| 250 μM | 4 | 0.1 | 2.988967991 |
| 250 μM | 5 | 0.157 | 4.692679746 |
| 250 μM | 6 | 0.102 | 3.048747351 |
| 250 μM | 7 | 0.013 | 0.388565839 |
| 250 μM | 8 | 0.168 | 5.021466225 |
| 250 μM | 9 | 0.085 | 2.540622792 |
| 250 μM | 10 | 0.082 | 2.450953753 |
| 250 μM | 11 | 0.414 | 12.37432748 |
| 250 μM | 12 | 0.169 | 5.051355905 |
| 250 μM | 13 | 0.1 | 2.988967991 |
| 250 μM | 14 | 0.161 | 4.812238465 |
| 250 μM | 15 | 0.117 | 3.497092549 |
| 250 μM | 16 | 0.079 | 2.361284713 |
| 250 μM | 17 | 0.041 | 1.225476876 |
| 250 μM | 18 | 0.076 | 2.271615673 |
| 250 μM | 19 | 0.029 | 0.866800717 |
| 250 μM | 20 | 0.014 | 0.418455519 |
| 125 μM | 1 | 0.594 | 17.75446987 |
| 125 μM | 2 | 0.817 | 24.41986849 |
| 125 μM | 3 | 0.626 | 18.71093962 |
| 125 μM | 4 | 0.734 | 21.93902505 |
| 125 μM | 5 | 0.713 | 21.31134177 |
| 125 μM | 6 | 0.689 | 20.59398946 |
| 125 μM | 7 | 0.722 | 21.58034889 |
| 125 μM | 8 | 0.762 | 22.77593609 |
| 125 μM | 9 | 0.231 | 6.904516059 |
| 125 μM | 10 | 0.507 | 15.15406771 |
| 125 μM | 11 | 0.222 | 6.63550894 |
| 125 μM | 12 | 0.525 | 15.69208195 |
| 125 μM | 13 | 0.55 | 16.43932395 |
| 125 μM | 14 | 0.069 | 2.062387914 |
| 125 μM | 15 | 0.472 | 14.10792892 |
| 125 μM | 16 | 0.034 | 1.016249117 |
| 125 μM | 17 | 0.55 | 16.43932395 |
| 125 μM | 18 | 0.668 | 19.96630618 |
| 125 μM | 19 | 0.446 | 13.33079724 |
| 125 μM | 20 | 0.029 | 0.866800717 |
| 62.5 μM | 1 | 0.248 | 7.412640617 |
| 62.5 μM | 2 | 1.205 | 36.01706429 |
| 62.5 μM | 3 | 0.044 | 1.315145916 |
| 62.5 μM | 4 | 2.416 | 72.21346666 |
| 62.5 μM | 5 | 1.934 | 57.80664094 |
| 62.5 μM | 6 | 1.461 | 43.66882235 |
| 62.5 μM | 7 | 1.468 | 43.87805011 |
| 62.5 μM | 8 | 1.971 | 58.9125591 |
| 62.5 μM | 9 | 1.601 | 47.85337753 |
| 62.5 μM | 10 | 1.828 | 54.63833487 |
| 62.5 μM | 11 | 1.198 | 35.80783653 |
| 62.5 μM | 12 | 1.033 | 30.87603935 |
| 62.5 μM | 13 | 0.093 | 2.779740232 |
| 62.5 μM | 14 | 0.508 | 15.18395739 |
| 62.5 μM | 15 | 1.48 | 44.23672626 |
| 62.5 μM | 16 | 2.027 | 60.58638117 |
| 62.5 μM | 17 | 0.073 | 2.181946633 |
| 62.5 μM | 18 | 0.636 | 19.00983642 |
| 62.5 μM | 19 | 0.078 | 2.331395033 |
| 62.5 μM | 20 | 2.019 | 60.34726374 |
| 31.3 μM | 1 | 0.078 | 2.331395033 |
| 31.3 μM | 2 | 3.155 | 94.30194011 |
| 31.3 μM | 3 | 2.824 | 84.40845606 |
| 31.3 μM | 4 | 2.977 | 88.98157709 |
| 31.3 μM | 5 | 3.844 | 114.8959296 |
| 31.3 μM | 6 | 2.777 | 83.00364111 |
| 31.3 μM | 7 | 0.136 | 4.064996468 |
| 31.3 μM | 8 | 3.518 | 105.1518939 |
| 31.3 μM | 9 | 2.905 | 86.82952013 |
| 31.3 μM | 10 | 2.177 | 65.06983316 |
| 31.3 μM | 11 | 2.03 | 60.67605021 |
| 31.3 μM | 12 | 1.89 | 56.49149503 |
| 31.3 μM | 13 | 1.955 | 58.43432422 |
| 31.3 μM | 14 | 0.173 | 5.170914624 |
| 31.3 μM | 15 | 2.957 | 88.38378349 |
| 31.3 μM | 16 | 0.06 | 1.793380795 |
| 31.3 μM | 17 | 2.394 | 71.5558937 |
| 31.3 μM | 18 | 1.99 | 59.48046302 |
| 31.3 μM | 19 | 2.659 | 79.47665888 |
| 31.3 μM | 20 | 0.199 | 5.948046302 |
| 15.6 μM | 1 | 2.769 | 82.76452367 |
| 15.6 μM | 2 | 3.235 | 96.6931145 |
| 15.6 μM | 3 | 2.467 | 73.73784033 |
| 15.6 μM | 4 | 2.351 | 70.27063747 |
| 15.6 μM | 5 | 2.393 | 71.52600402 |
| 15.6 μM | 6 | 4.682 | 139.9434813 |
| 15.6 μM | 7 | 3.856 | 115.2546057 |
| 15.6 μM | 8 | 4.902 | 146.5192109 |
| 15.6 μM | 9 | 2.594 | 77.53382968 |
| 15.6 μM | 10 | 2.945 | 88.02510733 |
| 15.6 μM | 11 | 2.464 | 73.6481713 |
| 15.6 μM | 12 | 2.193 | 65.54806804 |
| 15.6 μM | 13 | 2.617 | 78.22129232 |
| 15.6 μM | 14 | 2.503 | 74.81386881 |
| 15.6 μM | 15 | 3.482 | 104.0758654 |
| 15.6 μM | 16 | 2.183 | 65.24917124 |
| 15.6 μM | 17 | 0.115 | 3.43731319 |
| 15.6 μM | 18 | 2.725 | 81.44937775 |
| 15.6 μM | 19 | 2.204 | 65.87685452 |
| 15.6 μM | 20 | 2.434 | 72.7514809 |

### Example 59—Toxicity to Human Cells

Compounds 3, 5 and 42 were chosen as representative compounds and their toxicity to human liver cells (HepG2) and human kidney cells (HEK293) were tested using the following protocols:

### MTT Viability Assay Protocol

Day 1: Seed Cells into 96-Well Plates

Cells were harvested and resuspended in growth media (5-10 ml) to count. Cells were diluted to the appropriate concentration (5×10³), and seeded into 96-well plates as follows: (a) 50 μl of cells per well, (b) 100 μl of growth media in the Blank wells, (c) 100 μl PBS in outer wells (to prevent dehydration of media from the cells). Cells were incubated overnight at 37° C. (5% CO₂).

### Day 2: Treat Cells

Compounds were prepared as serial dilutions in growth media. Each treatment concentration was performed in triplicate. 50 μl/well of prepared compound was added to cells.

A no treatment triplicate (100% viability) was also included by adding 50 μl of growth media to cells. Plates were returned to the incubator for 48 hrs.

### Day 4: MTT Assay

MTT powder in 1×PBS was prepared at 5 mg/ml and filter sterilised. MTT was added to serum-free media to a final concentration of 1 mg/ml. 100 μl of the MTT solution (1 mg/ml) was added to each well, including 0 μM and blank wells. Plates were incubated at 37° C. in incubator for 3 hrs. Following incubation, the media was removed from wells without disrupting the purple crystals formed. 100 μl of DMSO was added to each well using a multichannel pipette. The plates were shaken on the plate shaker until all the crystals have dissolved. The absorbance was measured at 570 nm using a plate reader. The data was analysed using Microsoft Excel. For each treatment concentration the average was calculated, the blank was subtracted and the cell viability was determined as a percentage of the no treatment control (DMSO vehicle control).

The results for compound 3 for HepG2 are shown in Table 9 and for HEK293 in Table 10.

TABLE 9
Cell viability in HepG2 for various treatments using compound 3

| Treatment | % viability 1 | % viability 2 | % viability 3 |
|---|---|---|---|
| 400 μM Cmpd3 | 76.2 | 87.9 | 87.5 |
| 200 μM Cmpd3 | 84.2 | 96.5 | 92.9 |
| 100 μM Cmpd3 | 80.2 | 89.3 | 82.2 |
| 50 μM Cmpd3 | 106.4 | 89.9 | 98.7 |
| 25 μM Cmpd3 | 80.2 | 86.4 | 91.4 |
| 12.5 μM Cmpd3 | 110 | 104 | 92.2 |
| 100 μM Defensin | 15.4 | 13.7 | 15.6 |

As can be seen, whilst the Defensin positive control was cytotoxic to HepG2 cells, compound 3 was effectively nontoxic.

TABLE 10
Cell viability in HEK293 for various treatments using compound 3

| | % Viability | % Viability | % Viability |
|---|---|---|---|
| | Remaining 1 | Remaining 2 | Remaining 3 |
| 400 μM Cmpd3 | 72.3 | 106 | 85.6 |
| 200 μM Cmpd3 | 82.5 | 89.8 | 94.3 |
| 100 μM Cmpd3 | 84.2 | 93.0 | 91.6 |
| 50 μM Cmpd3 | 78.5 | 80.4 | 92.2 |
| 25 μM Cmpd3 | 100 | 86.3 | 83.8 |
| 12.5 μM Cmpd3 | 73.4 | 104 | 99.0 |
| 100 μM Defensin | 14.6 | 15.3 | 16.9 |

As can be seen, whilst the Defensin positive control was cytotoxic to HEK293 cells, compound 3 was effectively nontoxic.

The results for compound 5 for HepG2 are shown in Table 11 and for HEK293 in Table 12.

TABLE 11
Cell viability in Hep G2 for various treatments using compound 5

| Treatment | % viability 1 | % viability 2 | % viability 3 |
|---|---|---|---|
| 400 μM Cmpd5 | 82.1 | 84.9 | 92.5 |
| 200 μM Cmpd5 | 78.7 | 110 | 94.4 |
| 100 μM Cmpd5 | 111 | 105 | 84.8 |
| 50 μM Cmpd5 | 102 | 91.9 | 104 |
| 25 μM Cmpd5 | 111 | 106 | 105 |
| 12.5 μM Cmpd5 | 111 | 107 | 105 |
| 100 μM Defensin | 15.4 | 13.7 | 15.6 |

As can be seen whilst the Defensin positive control was cytotoxic to HepG2 cells, compound 5 was effectively nontoxic.

TABLE 12
Cell viability in HEK293 for various treatments using compound 5

| | % Viability | % Viability | % Viability |
|---|---|---|---|
| | Remaining 1 | Remaining 2 | Remaining 3 |
| 400 μM Cmpd5 | 96.4 | 91.3 | 89.1 |
| 200 μM Cmpd5 | 82.7 | 86.0 | 84.9 |
| 100 μM Cmpd5 | 106 | 103 | 82.8 |
| 50 μM Cmpd5 | 92.3 | 101 | 90.8 |
| 25 μM Cmpd5 | 105 | 103 | 85.0 |
| 12.5 μM Cmpd5 | 105 | 103 | 85.0 |
| 100 μM Defensin | 14.6 | 15.3 | 16.9 |

As can be seen, whilst the control Defensin was cytotoxic to HEK293 cells, compound 5 was effectively nontoxic.

The results for compound 42 for HepG2 are shown in Table 13 and for HEK293 in Table 14.

Cell viability in HepG2 for various treatments using compound 42

| Treatment | % viability 1 | % viability 2 | % viability 3 |
|---|---|---|---|
| 400 μM Cmpd42 | 80.9 | 82.9 | 82.1 |
| 200 μM Cmpd42 | 98.4 | 101 | 82.4 |
| 100 μM Cmpd42 | 88.0 | 86.0 | 84.1 |
| 50 μM Cmpd42 | 88.8 | 98.3 | 90.4 |
| 25 μM Cmpd42 | 81.0 | 99.1 | 70.9 |
| 12.5 μM Cmpd42 | 81.0 | 99.1 | 70.9 |
| 100 μM Defensin | 15.4 | 13.7 | 15.6 |

As can be seen, whilst the Defensin positive control was cytotoxic to HepG2 cells, compound 42 was effectively nontoxic.

TABLE 14
Cell viability in HEK293 for various treatments using compound 42

| | % Viability | % Viability | % Viability |
|---|---|---|---|
| | Remaining 1 | Remaining 2 | Remaining 3 |
| 400 μM Cmpd42 | 105 | 103 | 80.9 |
| 200 μM Cmpd42 | 94.0 | 99.6 | 94.1 |
| 100 μM Cmpd42 | 110 | 107 | 115 |
| 50 μM Cmpd42 | 80.6 | 94.5 | 98.9 |
| 25 μM Cmpd42 | 110 | 93.9 | 87.6 |
| 12.5 μM Cmpd42 | 104 | 93.9 | 87.6 |
| 100 μM Defensin | 14.6 | 15.3 | 16.9 |

As can be seen, whilst the Defensin positive control was cytotoxic to HEK293 cells, compound 42 was effectively nontoxic.

Finally, it will be appreciated that various modifications and variations of the methods and compositions of the invention described herein would be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that is apparent to those skilled in the art are intended to be within the scope of the present invention.

1. A method of inhibiting lysine biosynthesis in an organism in which the diaminopimelate biosynthesis pathway occurs, the method comprising contacting the organism with an effective amount of a compound of formula (I): 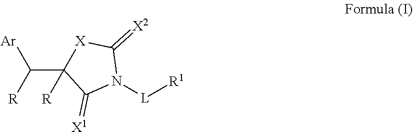
wherein
X, X¹ and X² are each independently selected from the group consisting of O, NH, and S;
Ar is an optionally substituted C₆-C₁₈aryl or an optionally substituted C₁-C₁₈heteroaryl group;
each R is H, or when taken together two R form a double bond between the carbon atoms to which they are attached;
L is selected from the group consisting of a bond, C₁-C₆alkyl, C₂-C₆alkenyl, C₁-C₆alkoxy, C₁-C₆alkoxyC₁-C₆ alkyl, and C₁-C₆heteroalkyl;
R¹ is selected from the group consisting of H, OH, CN, tetrazole, CO₂H, and COR²;
R² is selected from the group consisting of H, Cl, NR³R⁴, O—C₁-C₆alkyl, and O—C₁-C₆heteroalkyl;
each R³ and R⁴ is independently selected from H and C₁-C₆alkyl;
or a salt or N-oxide thereof.

2. (canceled)

3. A method according to claim 1 wherein in the compound of formula I, X is S.

4. A method according to claim 1 wherein in the compound of formula I, X¹ is O.

5. A method according to claim 1 wherein in the compound of formula I, wherein X² is O.

6-7. (canceled)

8. A method according to claim 1 wherein in the compound of formula I, Ar is selected from the group consisting of: 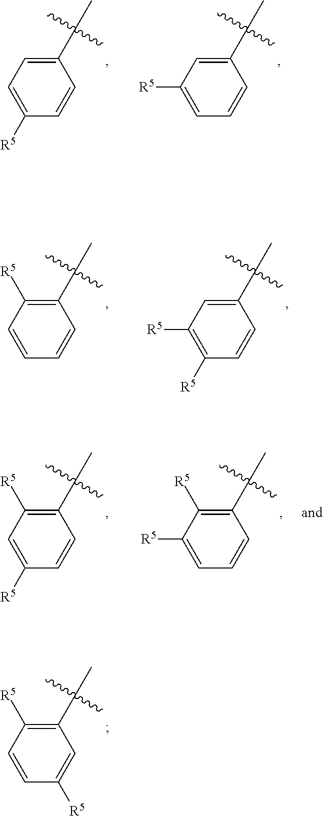
wherein:
each R⁵ is independently selected from the group consisting of H, halogen, OH, NO₂, CN, SH, NH₂, CF₃, OCF₃, C₁-C₁₂alkyl, C₁-C₁₂alkyloxy, C₁-C₁₂haloalkyl, C₂-C₁₂alkenyl, C₂-C₁₂alkynyl, C₂-C₁₂heteroalkyl, SR⁶, SO₃H, SO₂NR⁶R⁶, SO₂R⁶, SONR⁶R⁶, SOR⁶, COR⁶, COOH, COOR⁶, CONR⁶R⁶, NR⁶COR⁶, NR⁶COOR⁶, NR⁶SO₂R⁶, NR⁶CONR⁶R⁶, NR⁶R⁶, and acyl;
or any two R⁵ on adjacent carbon atoms when taken together with the carbon atoms to which they are attached form a 5 or 6 membered cyclic moiety; and
each R⁶ is independently selected from the group consisting of H and C₁-C₁₂alkyl.

9. (canceled)

10. A method according to claim 8 wherein in the compound of formula I, each R⁵ is independently selected from the group consisting of H, F, Cl, Br, I, CH₃, CH₂CH₃, CH₂NH₂, OH, OCH₃, SH, SCH₃, CO₂H, CONH₂, CF₃, OCF₃, NO₂, NH₂, CN, and NHCOCH.

11. (canceled)

12. A method according to claim 1 L is a C₁-C₆ alkyl group of the formula:
—(CH₂)ₐ—;
wherein a is selected from the group consisting of 1, 2, 3, and 4.

13. (canceled)

14. A method according to claim 1 wherein in the compound of formula I, R¹ is CO₂H.

15. A method according to claim 1 wherein the organism is a plant.

16. (canceled)

17. A method according to claim 1 wherein the compound inhibits lysine biosynthesis by inhibiting DHDPS activity in the organism.

18. A method according to claim 1 wherein the compound is selected from the group consisting of:

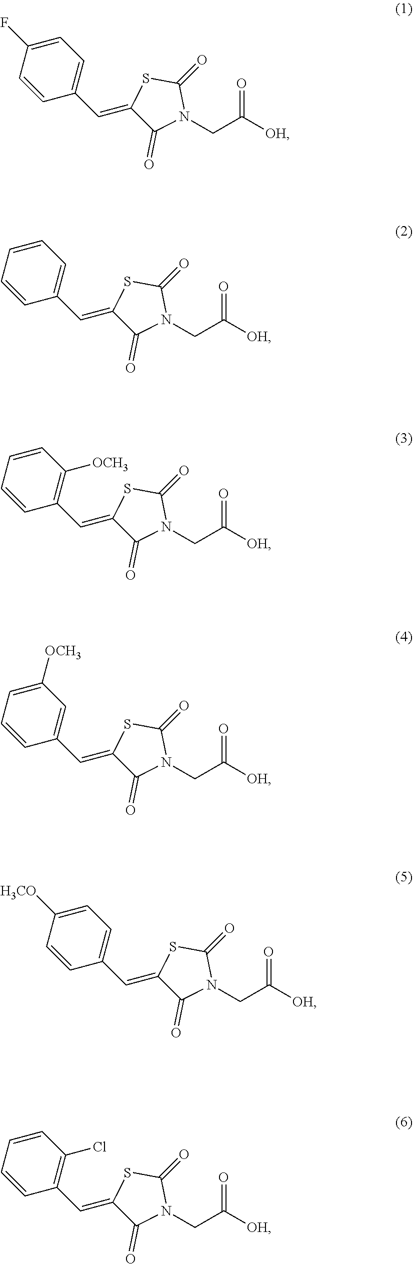 [SMILES: O=C(O)CN1C(=O)S/C(=C\c2ccc(F)cc2)C1=O ; O=C(O)CN1C(=O)S/C(=C\c2ccccc2)C1=O ; COc1ccccc1/C=C1\SC(=O)N(CC(=O)O)C1=O ; COc1cccc(/C=C2\SC(=O)N(CC(=O)O)C2=O)c1 ; COc1ccc(/C=C2\SC(=O)N(CC(=O)O)C2=O)cc1 ; O=C(O)CN1C(=O)S/C(=C\c2ccccc2Cl)C1=O]

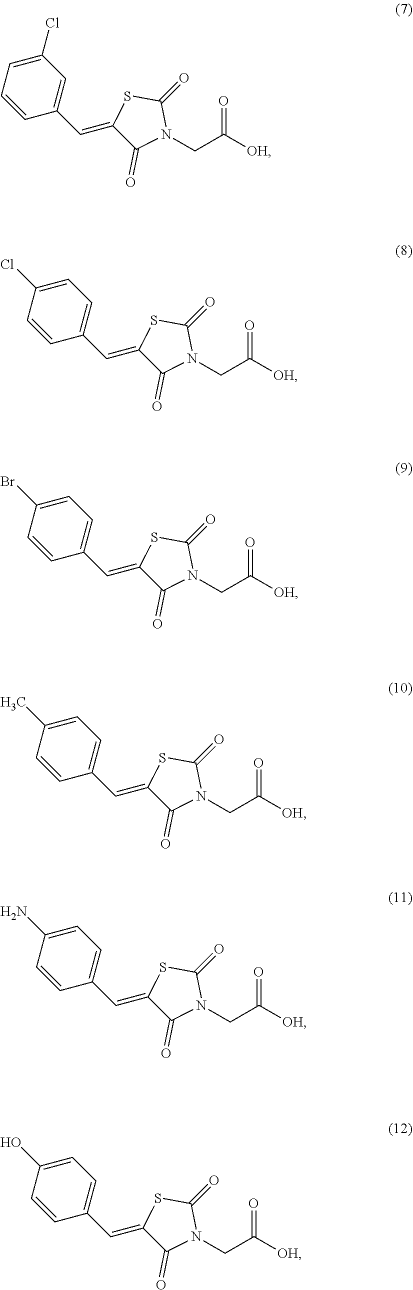 [SMILES: O=C(O)CN1C(=O)S/C(=C\c2cccc(Cl)c2)C1=O ; O=C(O)CN1C(=O)S/C(=C\c2ccc(Cl)cc2)C1=O ; O=C(O)CN1C(=O)S/C(=C\c2ccc(Br)cc2)C1=O ; Cc1ccc(/C=C2\SC(=O)N(CC(=O)O)C2=O)cc1 ; Nc1ccc(/C=C2\SC(=O)N(CC(=O)O)C2=O)cc1 ; O=C(O)CN1C(=O)S/C(=C\c2ccc(O)cc2)C1=O]

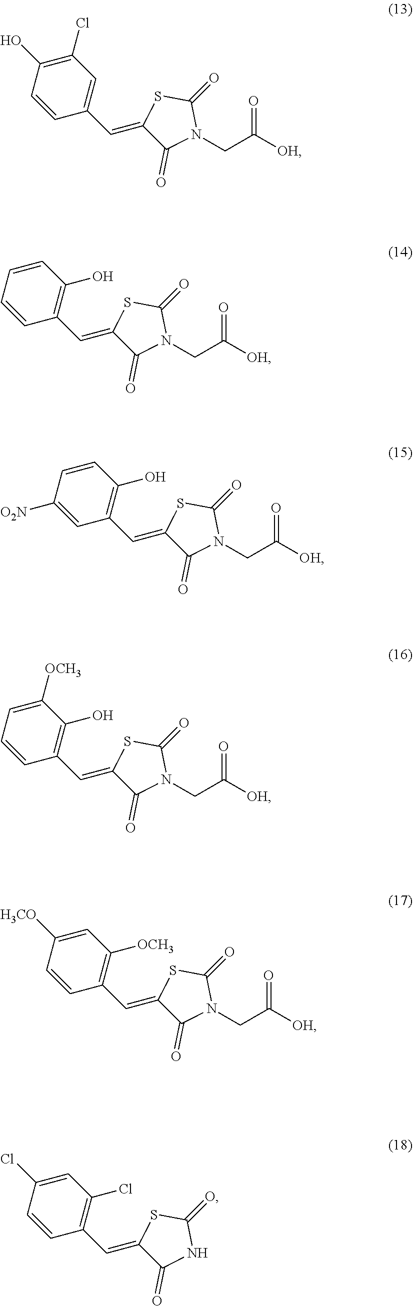 [SMILES: O=C(O)CN1C(=O)S/C(=C\c2ccc(O)c(Cl)c2)C1=O ; O=C(O)CN1C(=O)S/C(=C\c2ccccc2O)C1=O ; O=C(O)CN1C(=O)S/C(=C\c2cc([N+](=O)[O-])ccc2O)C1=O ; COc1cccc(/C=C2\SC(=O)N(CC(=O)O)C2=O)c1O ; COc1ccc(/C=C2\SC(=O)N(CC(=O)O)C2=O)c(OC)c1 ; O=C1NC(=O)/C(=C/c2ccc(Cl)cc2Cl)S1]

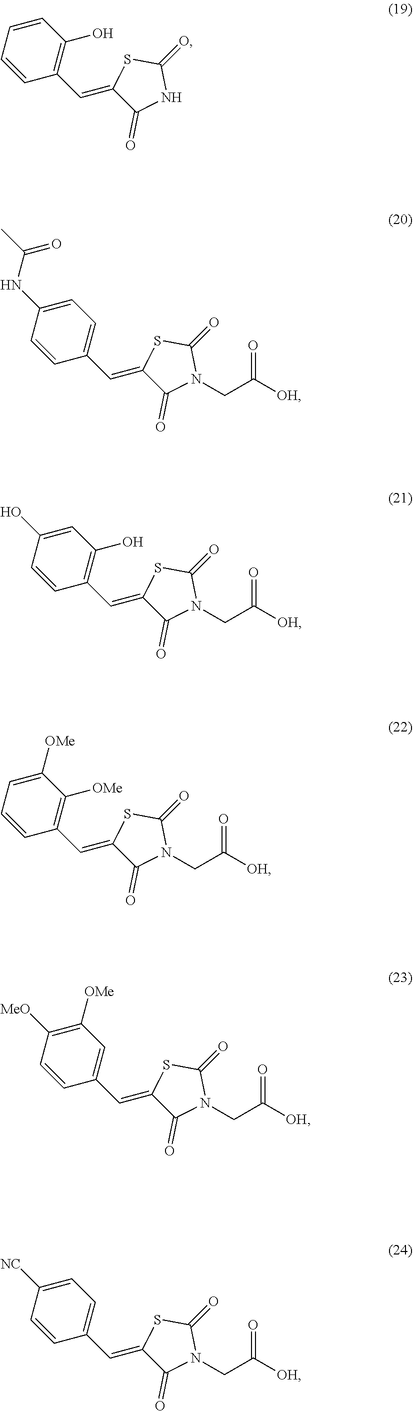 [SMILES: O=C1NC(=O)/C(=C/c2ccccc2O)S1 ; CC(=O)Nc1ccc(/C=C2\SC(=O)N(CC(=O)O)C2=O)cc1 ; O=C(O)CN1C(=O)S/C(=C\c2ccc(O)cc2O)C1=O ; COc1cccc(/C=C2\SC(=O)N(CC(=O)O)C2=O)c1OC ; COc1ccc(/C=C2\SC(=O)N(CC(=O)O)C2=O)cc1OC ; N#Cc1ccc(/C=C2\SC(=O)N(CC(=O)O)C2=O)cc1]

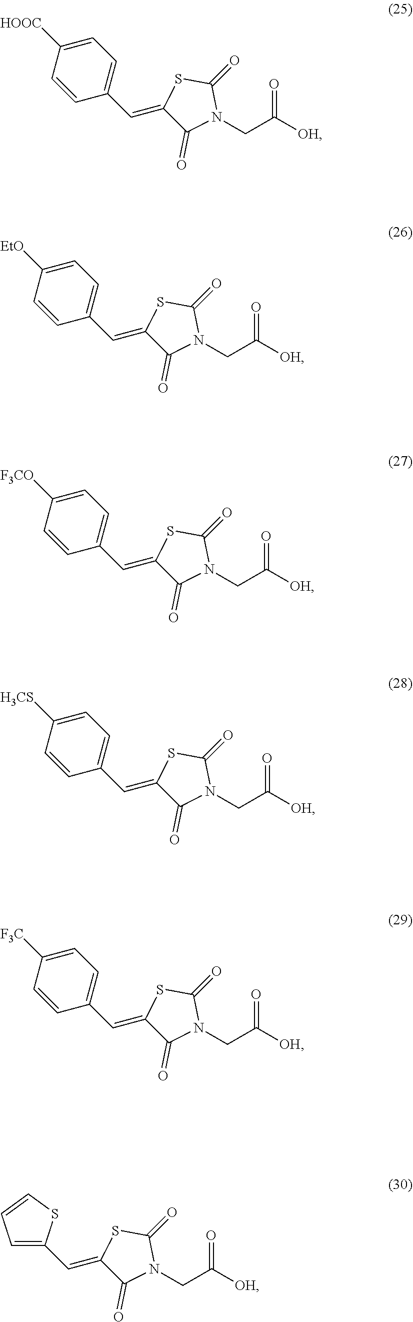

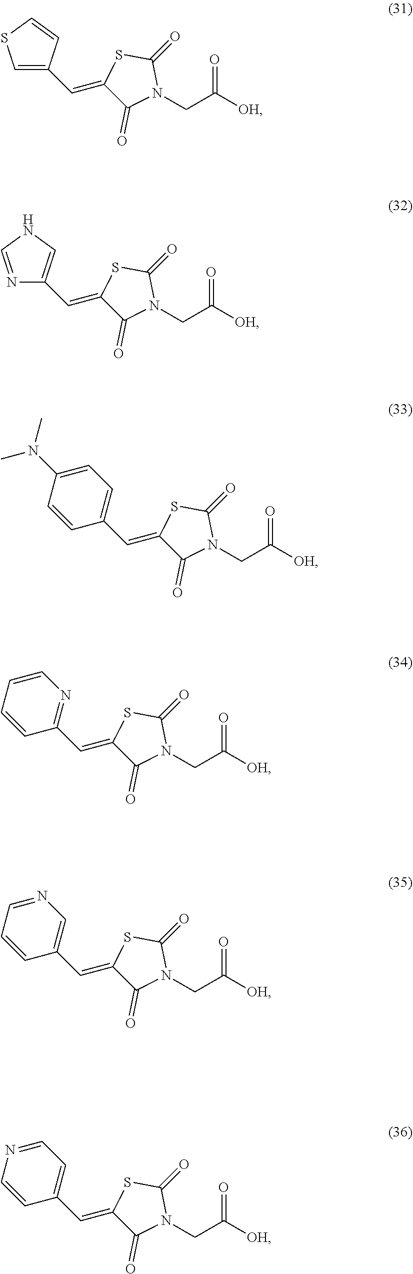 [SMILES: O=C(O)CN1C(=O)S/C(=C\c2ccsc2)C1=O ; O=C(O)CN1C(=O)S/C(=C\c2c[nH]cn2)C1=O ; CN(C)c1ccc(/C=C2\SC(=O)N(CC(=O)O)C2=O)cc1 ; O=C(O)CN1C(=O)S/C(=C\c2ccccn2)C1=O ; O=C(O)CN1C(=O)S/C(=C\c2cccnc2)C1=O ; O=C(O)CN1C(=O)S/C(=C\c2ccncc2)C1=O]

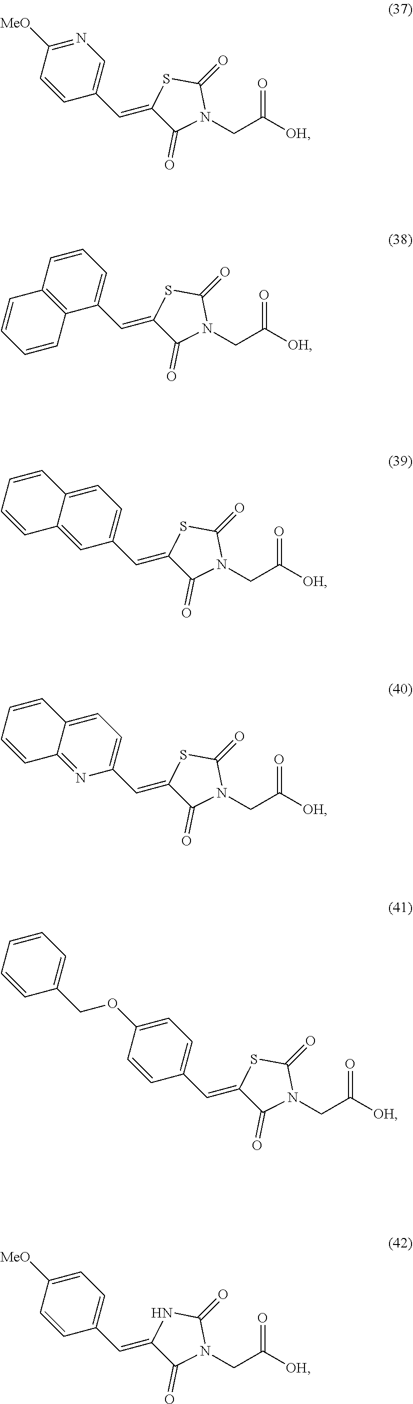 [SMILES: COc1ccc(/C=C2\SC(=O)N(CC(=O)O)C2=O)cn1 ; O=C(O)CN1C(=O)S/C(=C\c2cccc3ccccc23)C1=O ; O=C(O)CN1C(=O)S/C(=C\c2ccc3ccccc3c2)C1=O ; O=C(O)CN1C(=O)S/C(=C\c2ccc3ccccc3n2)C1=O ; O=C(O)CN1C(=O)S/C(=C\c2ccc(OCc3ccccc3)cc2)C1=O ; COc1ccc(/C=C2\NC(=O)N(CC(=O)O)C2=O)cc1]

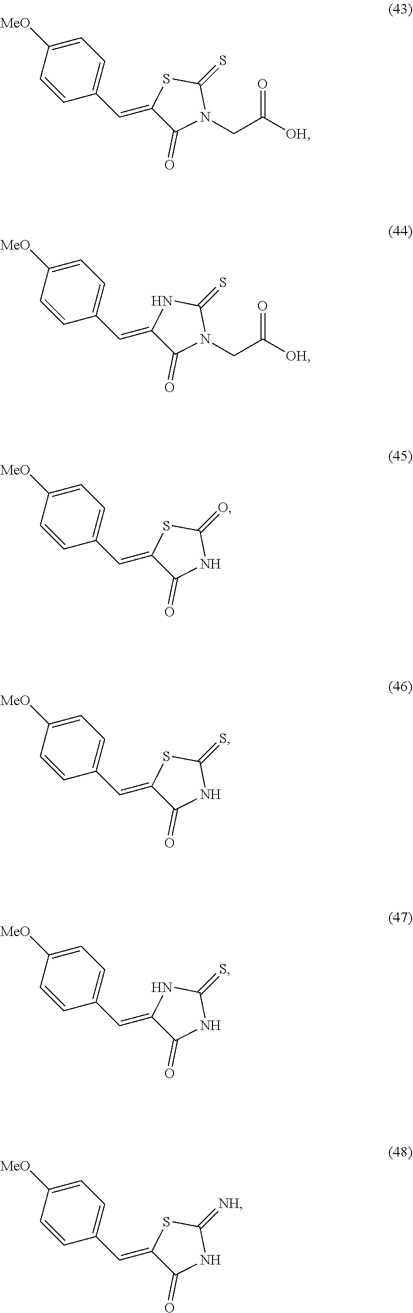 [SMILES: COc1ccc(/C=C2\SC(=S)N(CC(=O)O)C2=O)cc1 ; COc1ccc(/C=C2\NC(=S)N(CC(=O)O)C2=O)cc1 ; COc1ccc(/C=C2\SC(=O)NC2=O)cc1 ; COc1ccc(/C=C2\SC(=S)NC2=O)cc1 ; COc1ccc(/C=C2\NC(=S)NC2=O)cc1 ; COc1ccc(/C=C2\SC(=N)NC2=O)cc1]

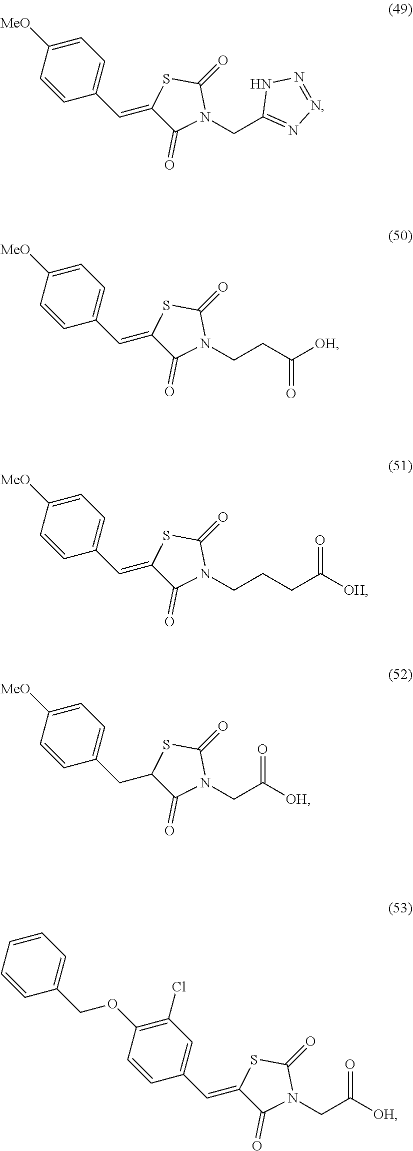 [SMILES: COc1ccc(/C=C2\SC(=O)N(Cc3nnn[nH]3)C2=O)cc1 ; COc1ccc(/C=C2\SC(=O)N(CCC(=O)O)C2=O)cc1 ; COc1ccc(/C=C2\SC(=O)N(CCCC(=O)O)C2=O)cc1 ; COc1ccc(CC2SC(=O)N(CC(=O)O)C2=O)cc1 ; O=C(O)CN1C(=O)S/C(=C\c2ccc(OCc3ccccc3)c(Cl)c2)C1=O]

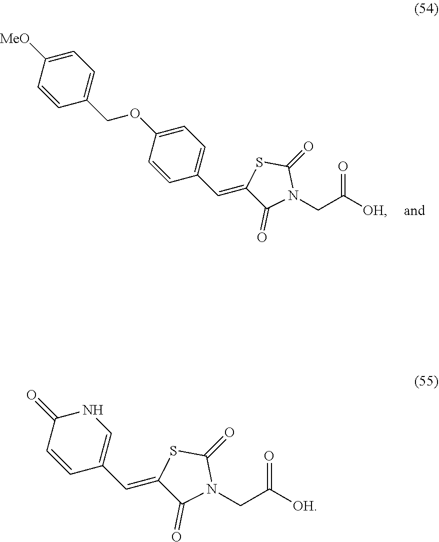 [SMILES: COc1ccc(COc2ccc(/C=C3\SC(=O)N(CC(=O)O)C3=O)cc2)cc1 ; "and" ; O=C(O)CN1C(=O)S/C(=C\c2ccc(=O)[nH]c2)C1=O]

19. A method for controlling undesired plant growth the method comprising contacting the plant with a herbicidal effective amount of a compound of the formula (I): 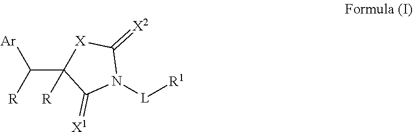
wherein
X, X¹, and X² are each independently selected from the group consisting of O, NH, and S;
Ar is an optionally substituted C₆-C₁₈aryl or an optionally substituted C₁-C₁₈heteroaryl group;
each R is H, or when taken together two R form a double bond between the carbon atoms to which they are attached;
L is selected from the group consisting of a bond, C₁-C₆alkyl, C₂-C₆alkenyl, C₁-C₆alkoxy, C₁-C₆alkoxyC₁-C₆ alkyl, and C₁-C₆heteroalkyl;
R¹ is selected from the group consisting of H, OH, CN, tetrazole, CO₂H, and COR²;
R² is selected from the group consisting of H, Cl, NR³R⁴, O—C₁-C₆alkyl, and O—C₁-C₆heteroalkyl;
each R³ and R⁴ is independently selected from H and C₁-C₆alkyl;
or a salt or N-oxide thereof.

20. (canceled)

21. A method according to claim 19 wherein in the compound of formula I used in the method, X is S.

22. A method according to claim 19 wherein in the compound of formula I used in the method, X¹ is O.

23. A method according to claim 19 wherein in the compound of formula I used in the method, X² is O.

24-25. (canceled)

26. A method according to claim 19 wherein in the compound of formula I used in the method, Ar is selected from the group consisting of: 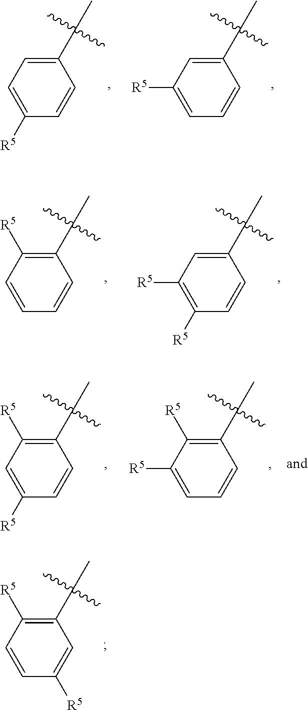
wherein:
each R⁵ is independently selected from the group consisting of H, halogen, OH, NO₂, CN, SH, NH₂, CF₃, OCF₃, C₁-C₁₂alkyl, C₁-C₁₂alkyloxy, C₁-C₁₂haloalkyl, C₂-C₁₂alkenyl, C₂-C₁₂alkynyl, C₂-C₁₂heteroalkyl, SR⁶, SO₃H, SO₂NR⁶R⁶, SO₂R⁶, SONR⁶R⁶, SOR⁶, COR⁶, COOH, COOR⁶, CONR⁶R⁶, NR⁶COR⁶, NR⁶COOR⁶, NR⁶SO₂R⁶, NR⁶CONR⁶R⁶, NR⁶R⁶, and acyl;
or any two R⁵ on adjacent carbon atoms when taken together with the carbon atoms to which they are attached form a 5 or 6 membered cyclic moiety; and
each R⁶ is independently selected from the group consisting of H and C₁-C₁₂alkyl.

27. (canceled)

28. A method according to claim 26 wherein in the compound of formula I used in the method, each R⁵ is independently selected from the group consisting of H, F, Cl, Br, I, CH₃, CH₂CH₃, CH₂NH₂, OH, OCH₃, SH, SCH₃, CO₂H, CONH₂, CF₃, OCF₃, NO₂, NH₂, CN, and NHCOCH

29. (canceled)

30. A method according to claim 19 wherein in the compound of formula I used in the method L is a C₁-C₆ alkyl group of the formula:
—(CH₂)ₐ—;
wherein a is selected from the group consisting of 1, 2, 3, and 4.

31. (canceled)

32. A method according to claim 19 wherein in the compound of formula I used in the method, R¹ is CO₂H.

33. A method according to claim 19 wherein the compound used in the method is selected from the group consisting of:

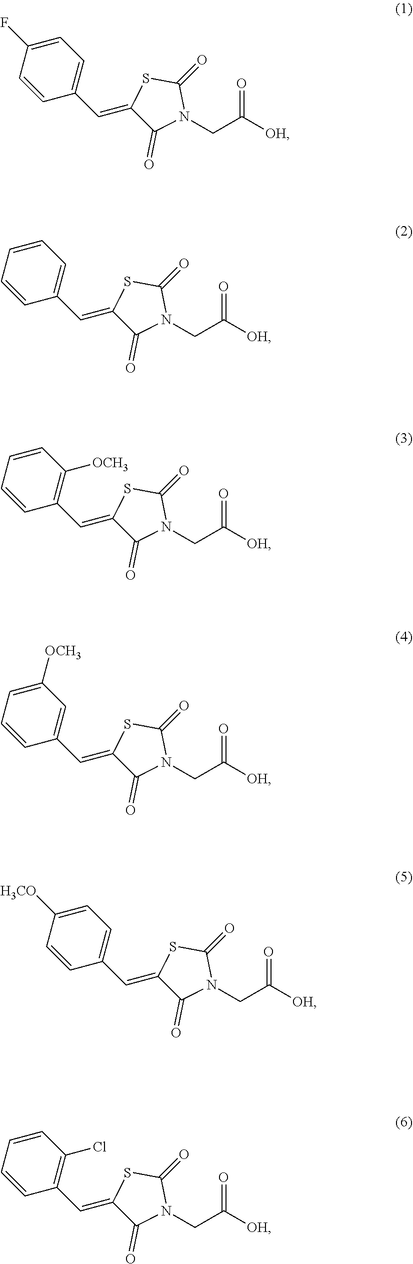 [SMILES: O=C(O)CN1C(=O)S/C(=C\c2ccc(F)cc2)C1=O ; O=C(O)CN1C(=O)S/C(=C\c2ccccc2)C1=O ; COc1ccccc1/C=C1\SC(=O)N(CC(=O)O)C1=O ; COc1cccc(/C=C2\SC(=O)N(CC(=O)O)C2=O)c1 ; COc1ccc(/C=C2\SC(=O)N(CC(=O)O)C2=O)cc1 ; O=C(O)CN1C(=O)S/C(=C\c2ccccc2Cl)C1=O]

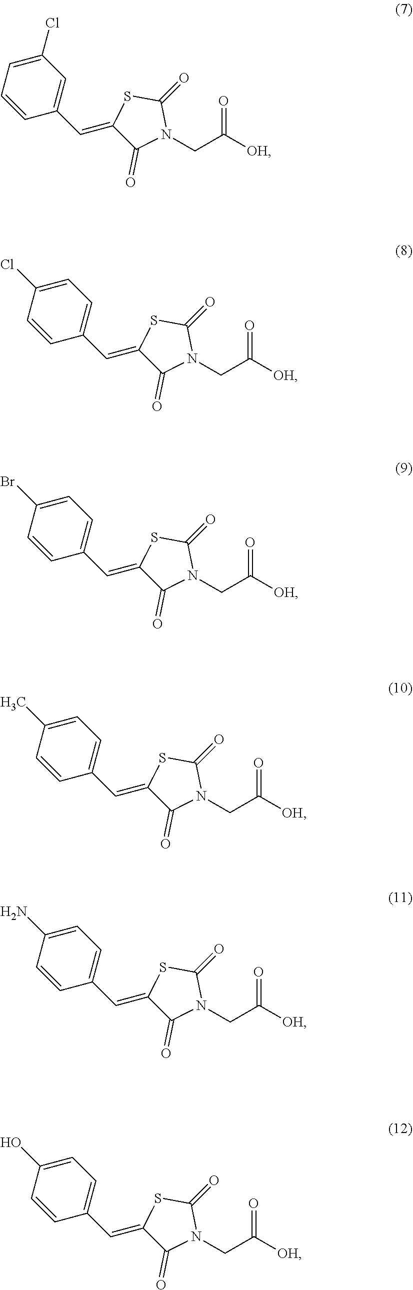 [SMILES: O=C(O)CN1C(=O)S/C(=C\c2cccc(Cl)c2)C1=O ; O=C(O)CN1C(=O)S/C(=C\c2ccc(Cl)cc2)C1=O ; O=C(O)CN1C(=O)S/C(=C\c2ccc(Br)cc2)C1=O ; Cc1ccc(/C=C2\SC(=O)N(CC(=O)O)C2=O)cc1 ; Nc1ccc(/C=C2\SC(=O)N(CC(=O)O)C2=O)cc1 ; O=C(O)CN1C(=O)S/C(=C\c2ccc(O)cc2)C1=O]

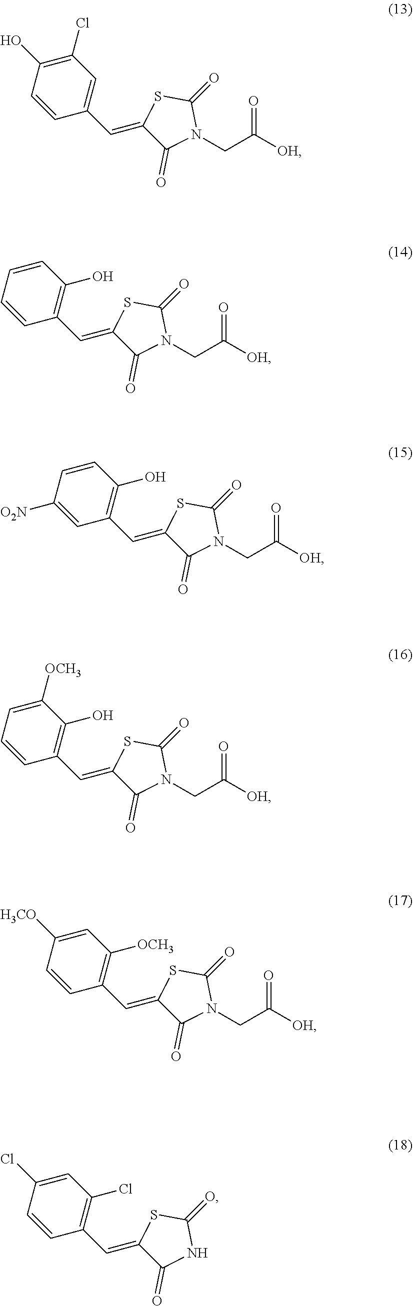 [SMILES: O=C(O)CN1C(=O)S/C(=C\c2ccc(O)c(Cl)c2)C1=O ; O=C(O)CN1C(=O)S/C(=C\c2ccccc2O)C1=O ; O=C(O)CN1C(=O)S/C(=C\c2cc([N+](=O)[O-])ccc2O)C1=O ; COc1cccc(/C=C2\SC(=O)N(CC(=O)O)C2=O)c1O ; COc1ccc(/C=C2\SC(=O)N(CC(=O)O)C2=O)c(OC)c1 ; O=C1NC(=O)/C(=C/c2ccc(Cl)cc2Cl)S1]

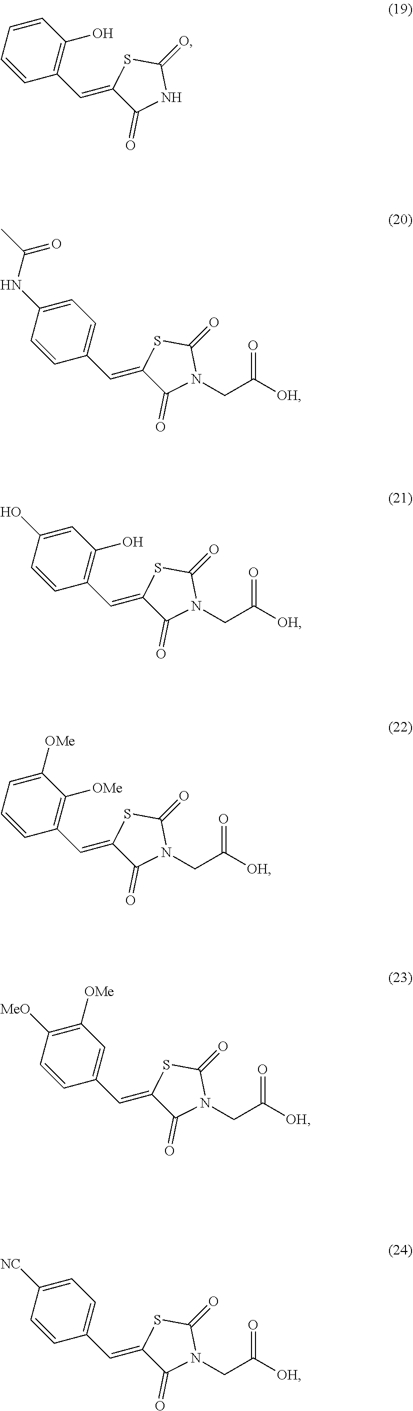 [SMILES: O=C1NC(=O)/C(=C/c2ccccc2O)S1 ; CC(=O)Nc1ccc(/C=C2\SC(=O)N(CC(=O)O)C2=O)cc1 ; O=C(O)CN1C(=O)S/C(=C\c2ccc(O)cc2O)C1=O ; COc1cccc(/C=C2\SC(=O)N(CC(=O)O)C2=O)c1OC ; COc1ccc(/C=C2\SC(=O)N(CC(=O)O)C2=O)cc1OC ; N#Cc1ccc(/C=C2\SC(=O)N(CC(=O)O)C2=O)cc1]

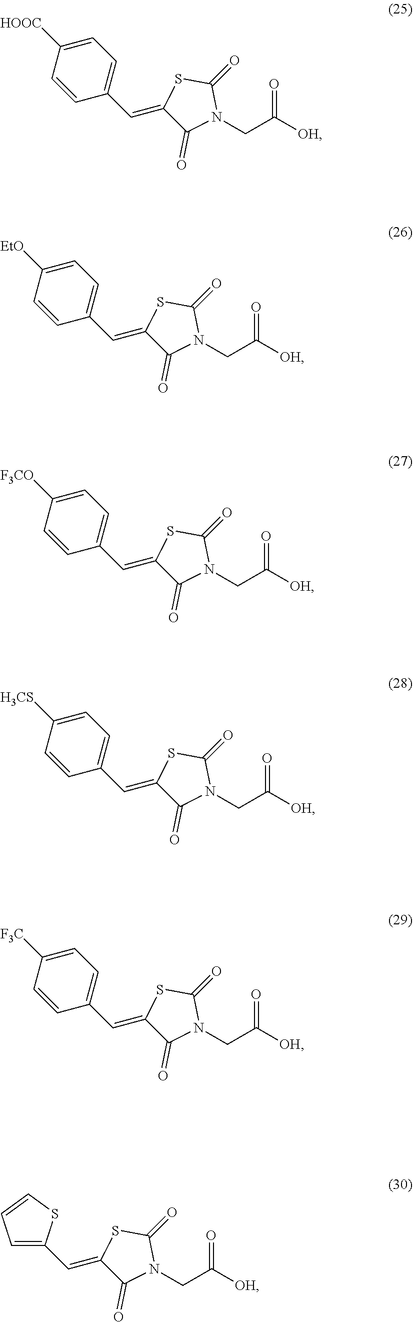

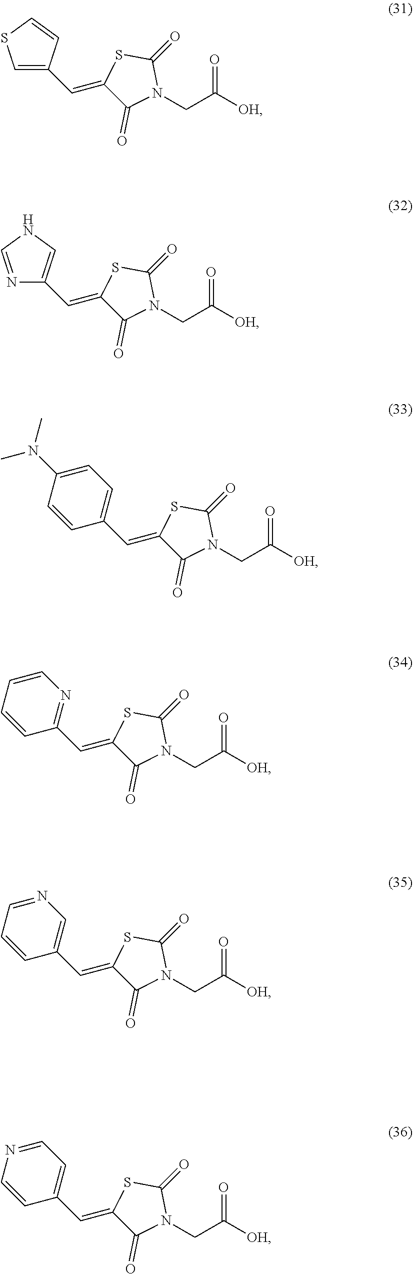 [SMILES: O=C(O)CN1C(=O)S/C(=C\c2ccsc2)C1=O ; O=C(O)CN1C(=O)S/C(=C\c2c[nH]cn2)C1=O ; CN(C)c1ccc(/C=C2\SC(=O)N(CC(=O)O)C2=O)cc1 ; O=C(O)CN1C(=O)S/C(=C\c2ccccn2)C1=O ; O=C(O)CN1C(=O)S/C(=C\c2cccnc2)C1=O ; O=C(O)CN1C(=O)S/C(=C\c2ccncc2)C1=O]

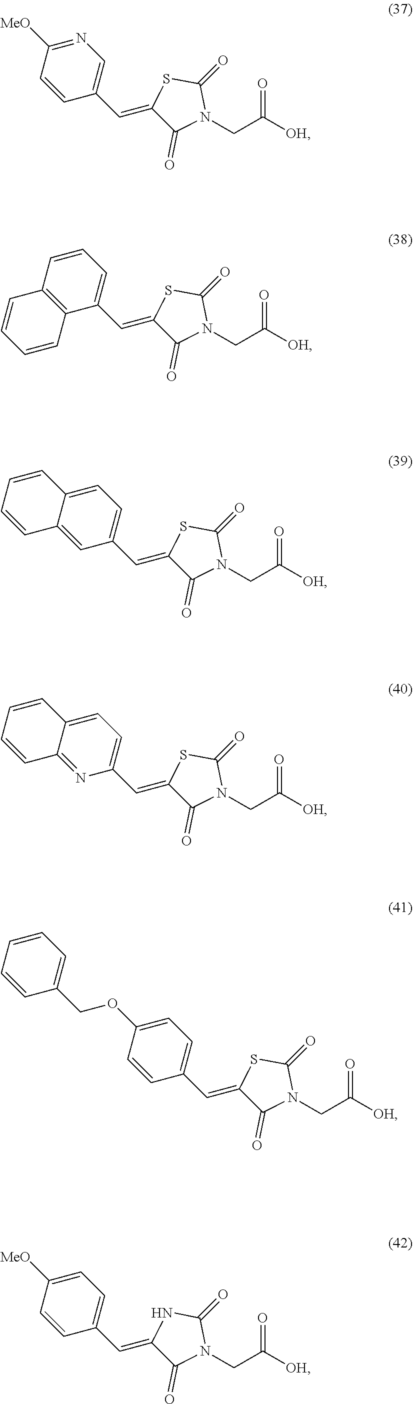 [SMILES: COc1ccc(/C=C2\SC(=O)N(CC(=O)O)C2=O)cn1 ; O=C(O)CN1C(=O)S/C(=C\c2cccc3ccccc23)C1=O ; O=C(O)CN1C(=O)S/C(=C\c2ccc3ccccc3c2)C1=O ; O=C(O)CN1C(=O)S/C(=C\c2ccc3ccccc3n2)C1=O ; O=C(O)CN1C(=O)S/C(=C\c2ccc(OCc3ccccc3)cc2)C1=O ; COc1ccc(/C=C2\NC(=O)N(CC(=O)O)C2=O)cc1]

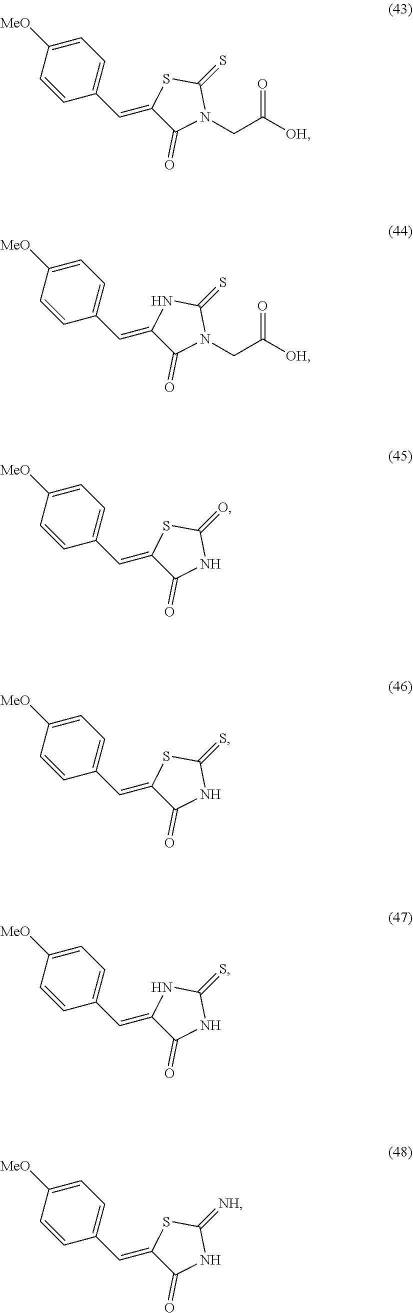 [SMILES: COc1ccc(/C=C2\SC(=S)N(CC(=O)O)C2=O)cc1 ; COc1ccc(/C=C2\NC(=S)N(CC(=O)O)C2=O)cc1 ; COc1ccc(/C=C2\SC(=O)NC2=O)cc1 ; COc1ccc(/C=C2\SC(=S)NC2=O)cc1 ; COc1ccc(/C=C2\NC(=S)NC2=O)cc1 ; COc1ccc(/C=C2\SC(=N)NC2=O)cc1]

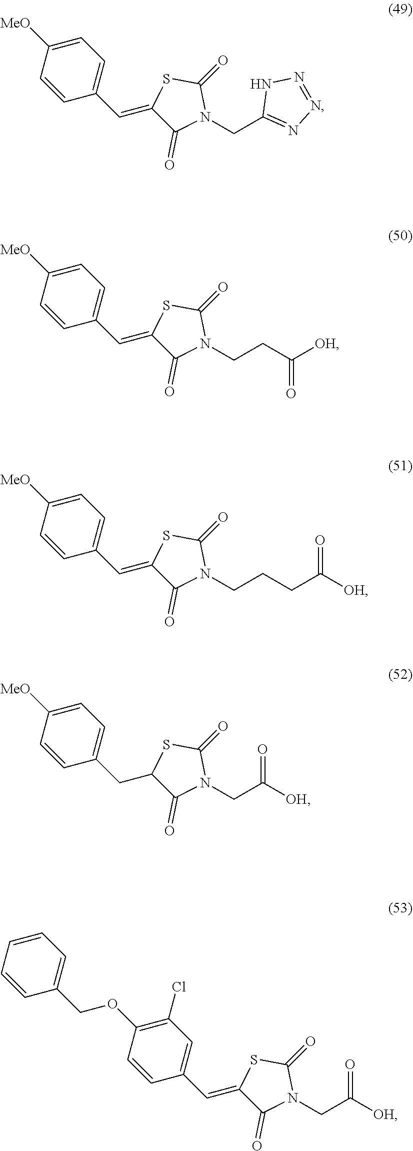 [SMILES: COc1ccc(/C=C2\SC(=O)N(Cc3nnn[nH]3)C2=O)cc1 ; COc1ccc(/C=C2\SC(=O)N(CCC(=O)O)C2=O)cc1 ; COc1ccc(/C=C2\SC(=O)N(CCCC(=O)O)C2=O)cc1 ; COc1ccc(CC2SC(=O)N(CC(=O)O)C2=O)cc1 ; O=C(O)CN1C(=O)S/C(=C\c2ccc(OCc3ccccc3)c(Cl)c2)C1=O]

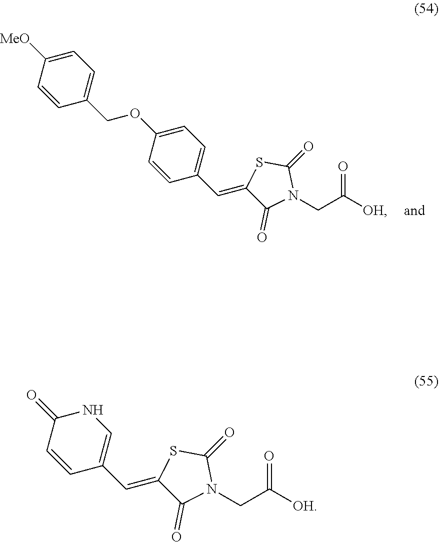 [SMILES: COc1ccc(COc2ccc(/C=C3\SC(=O)N(CC(=O)O)C3=O)cc2)cc1 ; "and" ; O=C(O)CN1C(=O)S/C(=C\c2ccc(=O)[nH]c2)C1=O]

34-35. (canceled)
